(19) United States
(12) Patent Application Publication
(10) Pub. No.: US 2026/0118865 A1
(43) Pub. Date: Apr. 30, 2026

(54) EVALUATION DEVICE, EVALUATION METHOD, AND PROGRAM

(71) Applicant: Panasonic Intellectual Property Management Co., Ltd., Osaka (JP)

(72) Inventors: MIKIO USHIODA, Kanagawa (JP); NOBUO HARA, Osaka (JP)

(21) Appl. No.: 19/430,469

(22) Filed: Dec. 23, 2025

Related U.S. Application Data
(63) Continuation of application No. PCT/JP2024/020584, filed on Jun. 5, 2024.

(30) Foreign Application Priority Data
Jul. 10, 2023 (JP) 2023-113294
Jul. 10, 2023 (JP) 2023-113298
Jul. 10, 2023 (JP) 2023-113317

(51) Int. Cl. G05B 23/02

(52) U.S. Cl. CPC G05B 23/024

(57) ABSTRACT

Evaluation device (100) is a device that evaluates one or more unknown characteristic points corresponding to one or more candidate experimental points by Bayesian optimization based on known characteristic points corresponding to experimented experimental point, and includes reception controller (10) that acquires objective data (212) indicating an optimization objective of each of one or more objective characteristics, evaluation value calculator (12) that calculates an evaluation value of the one or more unknown characteristic points, and evaluation value output unit (13) that outputs the evaluation value.

### TECHNICAL FIELD

The present disclosure relates to a technique for evaluating experimental conditions used for development of general industrial products, development of manufacturing processes, and similar applications.

### BACKGROUND ART

In the development of industrial products or the development of manufacturing processes, it is necessary to control the set control factors under optimal conditions so as to satisfy the requirements of the required objective characteristics. For example, in the development of a battery, the thickness of a positive electrode, the thickness of a negative electrode, the number of separators, the ionic conductivity of an electrolyte solution, and the like are set as control factors, and the capacity, the life, the expense cost, and the like are set as objective characteristics.

It is known that an optimal solution of a control factor can be searched by a mathematical optimization method in a case where a relationship between the control factor and an objective characteristic can be expressed by a physical formula. However, in a case where the relationship is unknown, a combination (i.e., experimental point) of the values of the set control factors is selected as experimental conditions, and an actual experiment is performed. Then, as an experimental result, a combination (i.e., characteristic point) of the values of the objective characteristics corresponding to the experimental point is acquired. By repeating such an experiment, an optimal solution of the control factor can be searched for.

Generally, in the development of complex industrial products or the development of manufacturing processes, large monetary or time costs are incurred in order to execute a single experiment. Therefore, in order to perform development work efficiently, it is important to search for an optimal solution with as few experiments as possible.

Incidentally, heretofore, an approach using an experimental design method and a response surface method has been used for the search for an optimal solution. However, in the approach using these methods, trial and error of an analyst is required at the stage of creating a prediction model or searching for an optimal solution, and thus quantitative evaluation with a consistent procedure is difficult.

In recent years, in the field of machine learning, a data-driven approach using Bayesian optimization has attracted attention (see, for example, NPL 1). The Bayesian optimization is an optimization method in which a Gaussian process is assumed as a mathematical model that represents a correspondence between input and output. In the case of using the Bayesian optimization, each time an experimental result is obtained, a predicted distribution of characteristic points is calculated for each set experimental point. Then, the optimum next experimental condition is selected using the predicted distribution of characteristic points and an evaluation criterion called an acquisition function. This makes it possible to perform quantitative evaluation regardless of the skill of an analyst, and to contribute to automation of the optimal solution search work.

### CITATION LIST

### Non-Patent Literature

NPL 1: M. Emmerich, A. Deutz, J. W. Klinkenberg, “The computation of the expected improvement in dominated hypervolume of Pareto front approximations,” Report Technique, Leiden University, Vol. 34, 2008.

### SUMMARY OF THE INVENTION

However, an evaluation device using the method described in the above NPL 1 has a problem that it is difficult to evaluate experimental conditions with high accuracy.

Therefore, the present disclosure provides an evaluation device capable of evaluating experimental conditions with high accuracy.

An evaluation device according to one aspect of the present disclosure is an evaluation device that evaluates one or more unknown characteristic points corresponding to one or more candidate experimental points by Bayesian optimization based on known characteristic points corresponding to experimented experimental points, the evaluation device including: a first reception controller configured to acquire experimental result data indicating the experimented experimental point and the known characteristic point: a second reception controller configured to acquire, in a case where each of the unknown one or more characteristic points and the known characteristic point is expressed by one or more objective characteristic values, objective data indicating an optimization objective of each of the one or more objective characteristics: a calculator configured to estimate a plurality of error variances that are variances of observation errors of characteristic points and are different from each other, and calculate evaluation values of the one or more unknown characteristic points based on the experimental result data, the objective data, and the plurality of error variances; and an output unit configured to output the evaluation value.

These comprehensive or specific aspects may be implemented by a system, a method, an integrated circuit, a computer program, or a recording medium such as a computer-readable CD-ROM, or may be implemented by any combination of the system, the method, the integrated circuit, the computer program, and the recording medium. Furthermore, the recording medium may be a non-transitory recording medium.

According to the evaluation device of the present disclosure, experimental conditions can be evaluated with high accuracy.

Additional advantages and effects of one aspect of the present disclosure will become apparent from the specification and drawings. Such advantages and/or effects are provided by several exemplary embodiments and features described in the specification and drawings, but not all of them are necessary to obtain one or more identical features.

### BRIEF DESCRIPTION OF THE DRAWINGS

FIG. 1 is a diagram for explaining a schematic operation of an evaluation device according to a first exemplary embodiment.

FIG. 2 is a diagram illustrating an example in which each candidate experimental point and each characteristic point according to the first exemplary embodiment are represented by a graph.

FIG. 3 is a diagram illustrating a configuration of the evaluation device according to the first exemplary embodiment.

FIG. 4 is a block diagram illustrating a functional configuration of an arithmetic circuit according to the first exemplary embodiment.

FIG. 5 is a diagram illustrating an example of a first reception image displayed on a display for receiving an input of setting information according to the first exemplary embodiment.

FIG. 6 is a diagram illustrating an example of control factor data according to the first exemplary embodiment.

FIG. 7 is a diagram illustrating an example of objective data according to the first exemplary embodiment.

FIG. 8 is a flowchart illustrating a processing operation of the evaluation device according to the first exemplary embodiment.

FIG. 9A is a diagram illustrating an example of candidate experimental point data according to the first exemplary embodiment.

FIG. 9B is a diagram illustrating another example of the candidate experimental point data according to the first exemplary embodiment.

FIG. 10 is a diagram illustrating an example of experimental result data according to the first exemplary embodiment.

FIG. 11 is a diagram for explaining processing by an evaluation value calculator according to the first exemplary embodiment.

FIG. 12 is a diagram illustrating an example of predicted distribution data according to the first exemplary embodiment.

FIG. 13 is a diagram illustrating an example of an improvement region according to the first exemplary embodiment.

FIG. 14 is a diagram illustrating an example of evaluation value data according to the first exemplary embodiment.

FIG. 15 is a diagram illustrating an example of variation in characteristic points.

FIG. 16 is a diagram illustrating an example of a weight distribution depending on a level space according to the first exemplary embodiment.

FIG. 17 is a diagram illustrating another example of the weight distribution depending on a level space according to the first exemplary embodiment.

FIG. 18 is a diagram illustrating still another example of the weight distribution depending on a level space according to the first exemplary embodiment.

FIG. 19 is a diagram illustrating still another example of the weight distribution depending on a level space according to the first exemplary embodiment.

FIG. 20 is a diagram illustrating an example of a second reception image displayed on a display for receiving an input of weight distribution data according to the first exemplary embodiment.

FIG. 21 is a diagram illustrating another example of the second reception image displayed on the display for receiving an input of weight distribution data according to the first exemplary embodiment.

FIG. 22 is a diagram illustrating an example of experimental result data in Example 1 of the first exemplary embodiment.

FIG. 23 is a diagram illustrating an example of a weight distribution indicated by weight distribution data in Example 1 of the first exemplary embodiment.

FIG. 24 is a diagram illustrating an example of a weight distribution in Example 1 of the first exemplary embodiment and a weight included in the weight distribution for a level used in an experiment with an experiment number n=1 to 4.

FIG. 25 is a diagram illustrating an example of predicted means of candidate experimental points in Example 1 of the first exemplary embodiment.

FIG. 26 is a diagram illustrating an example of evaluation value data in Example 1 of the first exemplary embodiment.

FIG. 27 is a diagram illustrating an example of a weight for a level used in each experiment with the experiment number n=1 to 5 in Example 1 of the first exemplary embodiment.

FIG. 28 is a diagram illustrating an example of predicted means of candidate experimental points in Example 1 of the first exemplary embodiment.

FIG. 29 is a diagram illustrating an example of evaluation value data in Example 1 of the first exemplary embodiment.

FIG. 30 is a diagram illustrating an example of experimental result data in Example 2 of the first exemplary embodiment.

FIG. 31 is a diagram illustrating an example of predicted means of candidate experimental points in Example 2 of the first exemplary embodiment.

FIG. 32 is a diagram illustrating an example of evaluation value data in Example 2 of the first exemplary embodiment.

FIG. 33 is a diagram illustrating an example of predicted means of candidate experimental points in Example 2 of the first exemplary embodiment.

FIG. 34 is a diagram illustrating an example of evaluation value data in Example 2 of the first exemplary embodiment.

FIG. 35 is a diagram illustrating an example of a weight distribution depending on time according to a second exemplary embodiment.

FIG. 36 is a diagram illustrating another example of the weight distribution depending on time according to the second exemplary embodiment.

FIG. 37 is a diagram illustrating still another example of the weight distribution depending on time according to the second exemplary embodiment.

FIG. 38 is a diagram illustrating still another example of the weight distribution depending on time according to the second exemplary embodiment.

FIG. 39 is a diagram illustrating an example of a second reception image displayed on a display for receiving an input of weight distribution data according to the second exemplary embodiment.

FIG. 40 is a diagram illustrating another example of the second reception image displayed on the display for receiving an input of weight distribution data according to the second exemplary embodiment.

FIG. 41 is a diagram illustrating an example of experimental result data according to Example 1 of the second exemplary embodiment.

FIG. 42 is a diagram illustrating an example of a weight distribution indicated by weight distribution data in Example 1 of the second exemplary embodiment.

FIG. 43 is a diagram illustrating an example of a weight distribution and a weight included in the weight distribution for a time at which each experiment with the experiment number n=1 to 4 is performed in Example 1 of the second exemplary embodiment.

FIG. 44 is a diagram illustrating an example of predicted means of candidate experimental points in Example 1 of the second exemplary embodiment.

FIG. 45 is a diagram illustrating an example of evaluation value data in Example 1 of the second exemplary embodiment.

FIG. 46 is a diagram illustrating an example of a weight distribution and a weight included in the weight distribution for a time at which each experiment with the experiment number n=1 to 5 is performed in Example 1 of the second exemplary embodiment.

FIG. 47 is a diagram illustrating an example of predicted means of candidate experimental points in Example 1 of the second exemplary embodiment.

FIG. 48 is a diagram illustrating an example of evaluation value data in Example 1 of the second exemplary embodiment.

FIG. 49 is a diagram illustrating an example of experimental result data in Example 2 of the second exemplary embodiment.

FIG. 50 is a diagram illustrating an example of a second reception image displayed on a display for receiving an input of weight distribution data according to a third exemplary embodiment.

FIG. 51 is a diagram illustrating another example of the second reception image displayed on the display for receiving an input of weight distribution data according to the third exemplary embodiment.

### DESCRIPTION OF EMBODIMENT

### (Knowledge Underlying Present Invention)

The present inventors have found that the following problems arise in NPL 1 described in the section of “BACKGROUND ART”.

There are several techniques proposed related to multi-objective Bayesian optimization for simultaneously optimizing a plurality of objective characteristics. For example, NPL 1 discloses an optimal solution search principle and a specific calculation method of expected hypervolume improvement (EHVI), which is a type of multi-objective Bayesian optimization. This makes it possible to perform quantitative evaluation of optimal solution search even when there are a plurality of objective characteristics desired to optimize.

However, in the above NPL 1, an observation error has not been sufficiently studied. The observation error is an error of a characteristic point obtained by an experiment using an experimental point, that is, an error of a value of an objective characteristic. In Bayesian optimization, a predicted distribution of characteristic points for each experimental point is calculated, and an error variance that is a variance of this observation error is used to calculate the predicted distribution. Such an error variance is usually set to a fixed value. The fixed value is a variance value observed by repeatedly performing an experiment using a specific experimental point, a value set by the sense of the experimenter, “1”, or the like. That is, the same value is always used as the error variance in the evaluation by Bayesian optimization.

On the other hand, how the characteristic points vary is not universal. Accordingly, the fact that the same error variance is always used for Bayesian optimization is unrealistic, and becomes a factor that reduces the accuracy of the evaluation of the experimental conditions.

Therefore, the present disclosure provides an evaluation device capable of evaluating experimental conditions with high accuracy.

An evaluation device according to a first aspect of the present disclosure is an evaluation device that evaluates one or more unknown characteristic points corresponding to one or more candidate experimental points by Bayesian optimization based on known characteristic points corresponding to experimented experimental points, the evaluation device including: a first reception controller configured to acquire experimental result data indicating the experimented experimental point and the known characteristic point: a second reception controller configured to acquire, in a case where each of the unknown one or more characteristic points and the known characteristic point is expressed by one or more objective characteristic values, objective data indicating an optimization objective of each of the one or more objective characteristics: a calculator configured to estimate a plurality of error variances that are variances of observation errors of characteristic points and are different from each other, and calculate evaluation values of the one or more unknown characteristic points based on the experimental result data, the objective data, and the plurality of error variances; and an output unit configured to output the evaluation value.

As a result, each of the one or more candidate experimental points is evaluated by the evaluation value as the experimental condition using the plurality of error variances different from each other. Therefore, it is possible to increase the possibility of bringing the plurality of error variances close to the variance of the observation error according to the actual experiment. As a result, the experimental conditions can be evaluated with high accuracy.

In the evaluation device according to a second aspect, the calculation means may estimate the plurality of error variances different from each other for the plurality of candidate experimental points. Note that the second aspect may be dependent on the first aspect.

As a result, it is possible to increase the possibility that appropriate error variance according to the candidate experimental point can be used for each of the plurality of candidate experimental points. Therefore, the experimental conditions can be evaluated with higher accuracy than the case of using the same error variance for a plurality of candidate experimental points.

In the evaluation device according to a third aspect, the calculation means may calculate a predicted distribution for each of the plurality of candidate experimental points by using error variance corresponding to each of the plurality of candidate experimental points among the plurality of error variances for the Gaussian process regression, and calculate evaluation values of the plurality of unknown characteristic points by using the calculated predicted distribution. Note that the third aspect may be dependent on the second aspect.

As a result, since error variance corresponding to the candidate experimental point is used for the Gaussian process regression, the accuracy of the predicted distribution of the candidate experimental point can be improved. Therefore, the experimental conditions can be evaluated with higher accuracy.

In the evaluation device according to a fourth aspect, the calculation means may acquire a weight distribution defined depending on a space in which the one or more candidate experimental points and the experimented experimental point are arranged, and when estimating each of the plurality of error variances, estimate the error variance based on a weight associated with a position of the experimented experimental point in the space among a plurality of weights indicated by the weight distribution. Note that the fourth aspect may be dependent on any one of the first to third aspects.

As a result, in the weight distribution, weight associated with the experimented experimental point can be used as a reference degree for the observation error of the known characteristic point obtained by the experiment using the experimented experimental point. Therefore, the error variance for the candidate experimental point can be estimated by using only the weight of such an observation error. That is, error variance for the candidate experimental point can be estimated using the known characteristic point. As a result, the experimental conditions can be evaluated effectively with high accuracy.

In the evaluation device according to a fifth aspect, the weight indicated by the weight distribution may be smaller as a position associated with the weight in the space is farther from a position of any one candidate experimental point of interest among the one or more candidate experimental points. Note that the fifth aspect may be dependent on the fourth aspect.

As a result, when an unknown characteristic point corresponding to a candidate experimental point of interest is evaluated, small weight is used for an experimented experimental point that is distant in the space from the candidate experimental point of interest, and large weight is used for an experimented experimental point that is close to the candidate experimental point of interest. For example, a temperature is used as an experimental point, and an experiment involving adjustment of the temperature is performed. In such a case, the smaller the difference between the two temperatures, that is, the closer the two temperatures are, the more similar the error variance for those temperatures is, and the larger the difference between the two temperatures, that is, the farther the two temperatures are, the less similar the error variance for those temperatures is. Therefore, in the fifth aspect, when the evaluation value is calculated for the temperature of interest, the degree of reference to the observation error obtained by the experiment using the temperature distant from the temperature of interest can be lowered so as to follow the similar tendency of the error variance described above. As a result, the experimental conditions can be evaluated appropriately with high accuracy.

In the evaluation device according to a sixth aspect, the weight indicated by the weight distribution may decrease linearly as the position associated with the weight in the space is farther from the position of the candidate experimental point of interest. Note that the sixth aspect may be dependent on the fifth aspect.

As a result, when the similar tendency of the error variance linearly changes according to the position or distance in the space, the experimental conditions can be evaluated with higher accuracy.

In the evaluation device according to a seventh aspect, the weight indicated by the weight distribution may decrease exponentially as the position associated with the weight in the space is farther from the position of the candidate experimental point of interest. Note that the seventh aspect may be dependent on the fifth aspect.

As a result, when the similar tendency of the error variance changes exponentially according to the position or distance in the space, the experimental conditions can be evaluated with higher accuracy.

In the evaluation device according to an eighth aspect, the weight indicated by the weight distribution may periodically increase or decrease according to a position associated with the weight in the space. Note that the eighth aspect may be dependent on the fourth aspect.

As a result, when the similar tendency of the error variance changes periodically according to the position or distance in the space, the experimental conditions can be evaluated with higher accuracy.

In the evaluation device according to a ninth aspect, the weight indicated by the weight distribution may be set for each section in the space. Note that the ninth aspect may be dependent on the fourth aspect.

As a result, when the similar tendency of the error variance differs for each section in the space, the experimental conditions can be evaluated with higher accuracy.

In the evaluation device according to a 10th aspect, in a case where each of the experimented experimental point and the one or more candidate experimental points is represented by a level of two or more control factors, the calculation means may acquire a control factor weight distribution for each of the two or more control factors as the weight distribution, and when estimating each of the plurality of error variances, estimate the error variance based on a product of weights associated with positions of the experimented experimental points in the space in each of the two or more control factor weight distributions. Note that the 10th aspect may be dependent on any one of the first to ninth aspects.

As a result, in a case where each of the experimented experimental points and the one or more candidate experimental points is expressed by the level of two or more control factors, that is, in a case where each of the experimented experimental points and the one or more candidate experimental points is expressed by two-dimensional or more control factors, error variance is estimated based on the product of weights. Therefore, even in such a case, the experimental conditions can be evaluated with high accuracy.

In the evaluation device according to an 11th aspect, in a case where each of the unknown one or more characteristic points and the known characteristic point is expressed by two or more objective characteristic values, the calculation means may estimate the error variance for each of the two or more objective characteristics by using the objective characteristic value of the known characteristic point. Note that the 11th aspect may be dependent on any one of the first to 10th aspects.

As a result, even when each of the unknown one or more characteristic points and the known characteristic point is expressed by two or more objective characteristic values, that is, even when each of the unknown one or more characteristic points and the known characteristic point is expressed by two-dimensional or more objective characteristic values, error variance is estimated for each objective characteristic. Therefore, even in such a case, the experimental conditions can be evaluated with high accuracy.

Hereinafter, exemplary embodiments will be specifically described with reference to the drawings.

Note that the exemplary embodiments described below illustrate comprehensive or specific examples. Numerical values, shapes, materials, constituent elements, disposition positions and connection modes of the constituent elements, steps, order of the steps, and the like illustrated in the following exemplary embodiments are merely examples, and therefore are not intended to limit the present disclosure. Furthermore, among the constituent elements in the following exemplary embodiments, constituent elements not described in the independent claims are explained as arbitrary constituent elements. Furthermore, each of the drawings is a schematic view, and is not necessarily illustrated precisely. In addition, in the drawings, identical reference marks are given to the same constituent members.

### First Exemplary Embodiment

### [Outline]

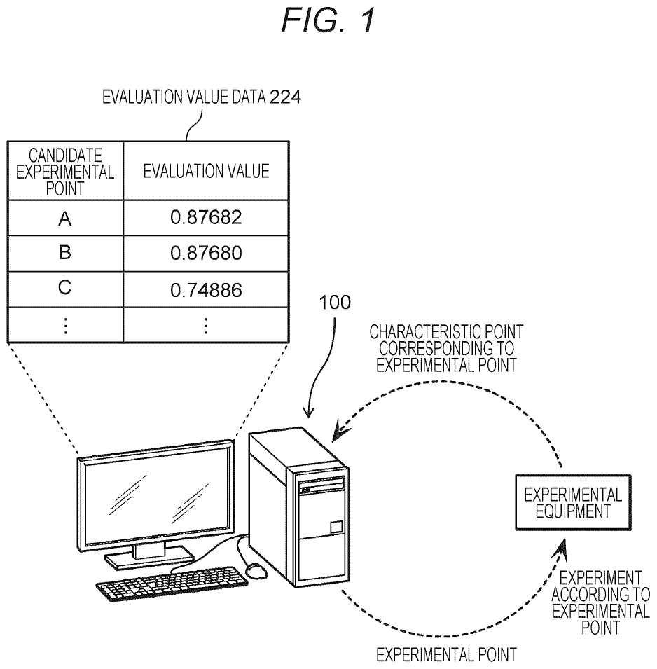

FIG. 1 is a diagram for explaining a schematic operation of an evaluation device according to the present exemplary embodiment.

Evaluation device 100 of the present exemplary embodiment calculates an evaluation value for each of a plurality of candidate experimental points, and displays evaluation value data 224 indicating those evaluation values. The candidate experimental point is a point that is a candidate for an experimental point. The experimental point is a point on an experimental space indicating experimental conditions (combination of values of control factors on experimental space). The evaluation value is a value indicating an evaluation result of an objective characteristic predicted to be obtained by an experiment according to the candidate experimental point. For example, the evaluation value indicates a degree to which the objective characteristic predicted to be obtained by the experiment matches an optimization objective, and the larger the evaluation value is, the larger the degree is.

With reference to the evaluation value of each candidate experimental point indicated by evaluation value data 224, the user selects one of those candidate experimental points as a next experimental point. Using experimental equipment, the user conducts an experiment according to the selected experimental point. Through the experiment, a characteristic point corresponding to the experimental point is obtained. The characteristic point indicates, for example, the value of an objective characteristic, and where there are a plurality of objective characteristics, the characteristic point is indicated as a combination of the values of the plurality of objective characteristics. The user inputs the obtained characteristic point into evaluation device 100 in association with an experimental point. As a result, evaluation device 100 recalculates an evaluation value for each unselected candidate experimental point using the characteristic points obtained by the experiment, and redisplays evaluation value data 224 indicating those evaluation values. That is, evaluation value data 224 is updated. By repeating such update of evaluation value data 224, evaluation device 100 searches for an optimal solution of the objective characteristic.

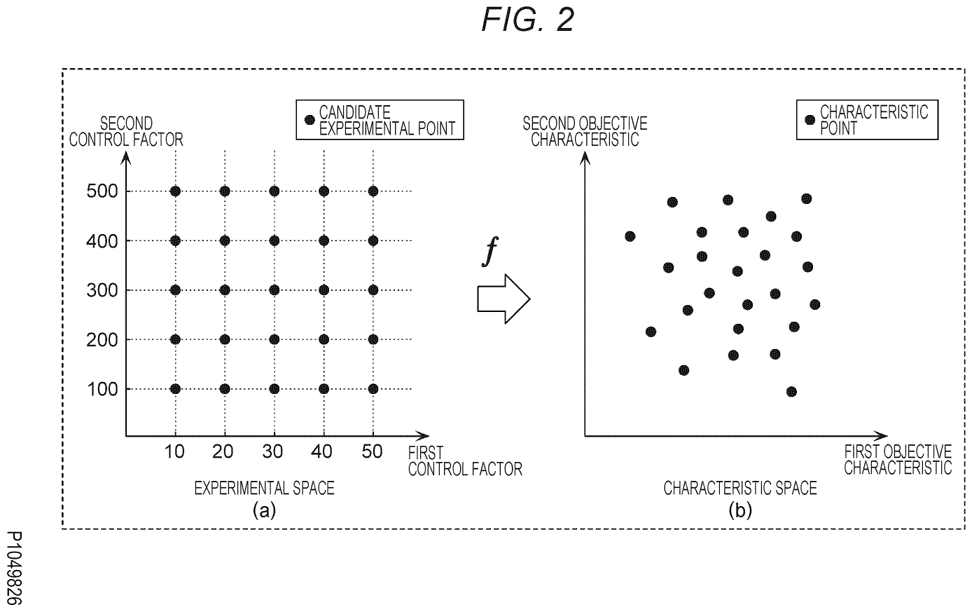

FIG. 2 is a diagram illustrating an example in which each candidate experimental point and each characteristic point are represented by a graph. Specifically, the graph in part (a) of FIG. 2 illustrates candidate experimental points arranged in the experimental space, and the graph in part (b) of FIG. 2 illustrates characteristic points arranged in a characteristic space.

The candidate experimental points in the experimental space are arranged on grid points corresponding to the combination of the values of a first control factor and a second control factor as illustrated in part (a) of FIG. 2. The characteristic points corresponding to the candidate experimental points illustrated in part (a) of FIG. 2 are arranged in the characteristic space as illustrated in part (b) of FIG. 2. Specifically, when a candidate experimental point is selected as an experimental point, and respective values of a first objective characteristic and a second objective characteristic are obtained through an experiment according to the experimental point, a characteristic point corresponding to the experimental point is arranged at a position expressed by a combination of the value of the first objective characteristic and the value of the second objective characteristic. Here, there is a one-to-one correspondence relationship between the candidate experimental points and the characteristic points, but the correspondence relationship (i.e., function f in FIG. 2) is unknown.

Executing an experiment once can be rephrased as selecting one candidate experimental point and acquiring one set of correspondence relationship with a characteristic point corresponding to the selected candidate experimental point.

Note that in the present exemplary embodiment, an example in which the number of control factors is two as in the first control factor and the second control factor and the number of objective characteristics is two as in the first objective characteristic and the second objective characteristic will be mainly explained. However, the number of control factors and the number of objective characteristics are not limited to two. The number of control factors may be one, or three or more, and the number of objective characteristics may be one, or three or more. Furthermore, the number of control factors and the number of objective characteristics may be equal to or different from each other.

### [Hardware Configuration]

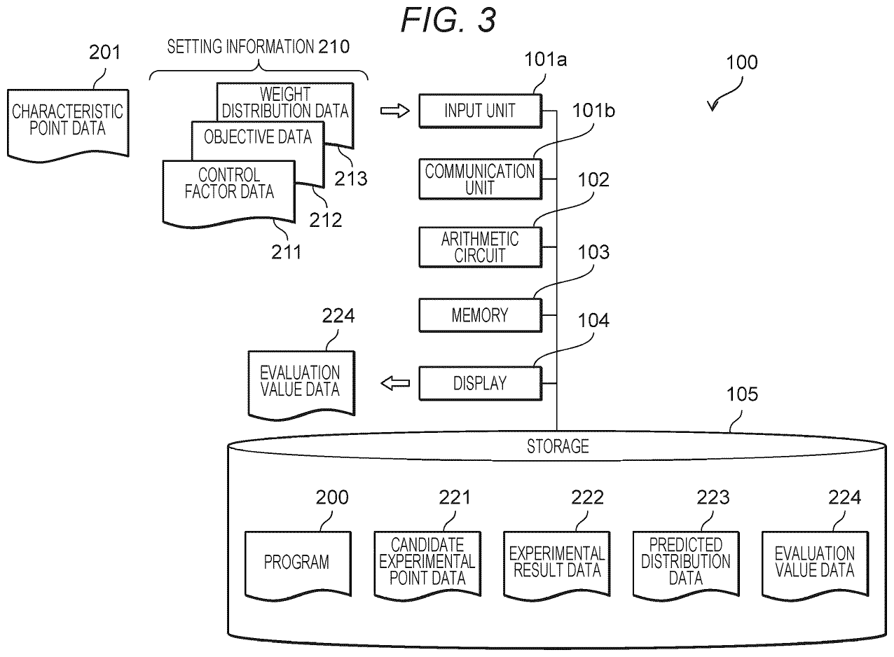

FIG. 3 is a diagram illustrating a configuration of evaluation device 100 according to the present exemplary embodiment.

Evaluation device 100 includes input unit 101a, communication unit 101b, arithmetic circuit 102, memory 103, display 104, and storage 105.

Input unit 101a is a human machine interface (HMI) that receives an input operation by the user. Input unit 101a is, for example, a keyboard, a mouse, a touch sensor, a touchpad, or the like.

For example, input unit 101a receives setting information 210 as an input from the user. Setting information 210 includes control factor data 211, objective data 212, and weight distribution data 213. Control factor data 211 is, for example, data indicating possible values of the control factor as illustrated in part (a) of FIG. 2. The value of the control factor may be a continuous value or a discrete value. Objective data 212 is, for example, data indicating an optimization objective of an objective characteristic such as minimization or maximization. Weight distribution data 213 is, for example, data indicating weights as reference degrees for the control factors and their levels as a weight distribution. Note that the weight distribution is also referred to as an error variance weight distribution.

Communication unit 101b is connected to another device in a wired or wireless manner, and transmits and receives data to and from the other device. For example, communication unit 101b receives characteristic point data 201 indicating the characteristic point described above from another device (e.g., experimental device).

Display 104 displays an image, a character, or the like. Display 104 is, for example, a liquid crystal display, a plasma display, an organic electro-luminescence (EL) display, or the like. Note that display 104 may be a touch panel integrated with input unit 101a.

Storage 105 stores program (i.e., computer program) 200 in which commands to arithmetic circuit 102 are described and various types of data. Storage 105 is a nonvolatile recording medium, and is, for example, a magnetic storage device such as a hard disk, a semiconductor memory such as a solid state drive (SSD), an optical disk, or the like. Note that program 200 and various data may be provided, for example, from the above-described other device to evaluation device 100 via communication unit 101b and stored in storage 105. Storage 105 stores, as various data, candidate experimental point data 221, experimental result data 222, predicted distribution data 223, and evaluation value data 224.

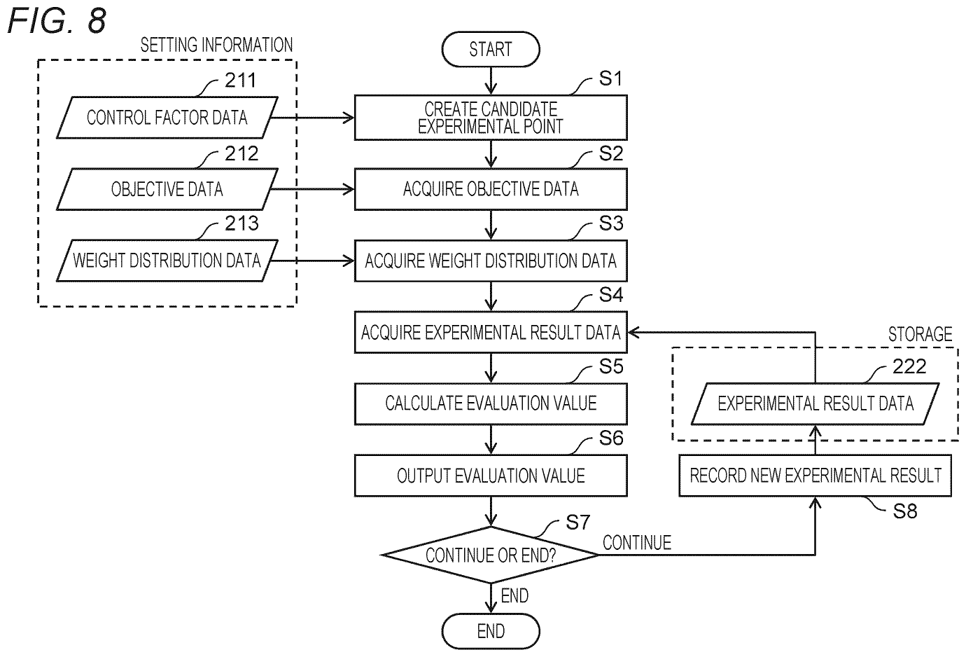

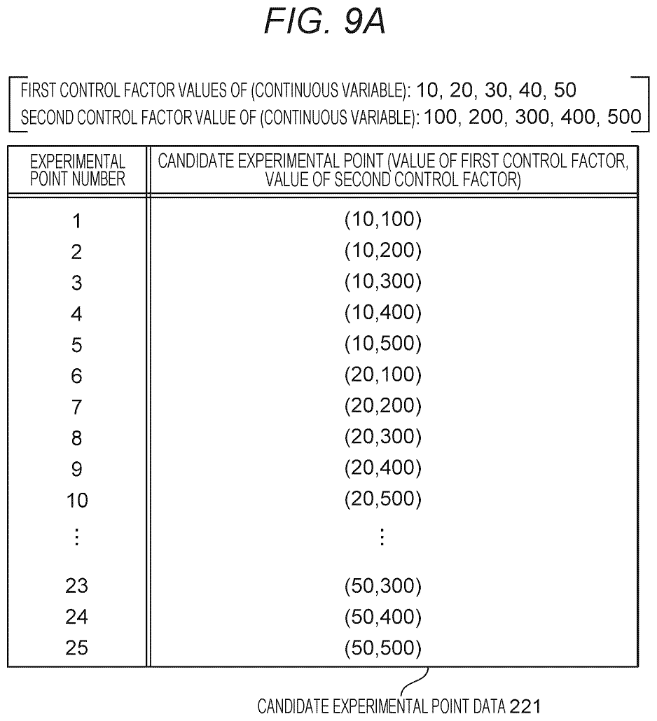

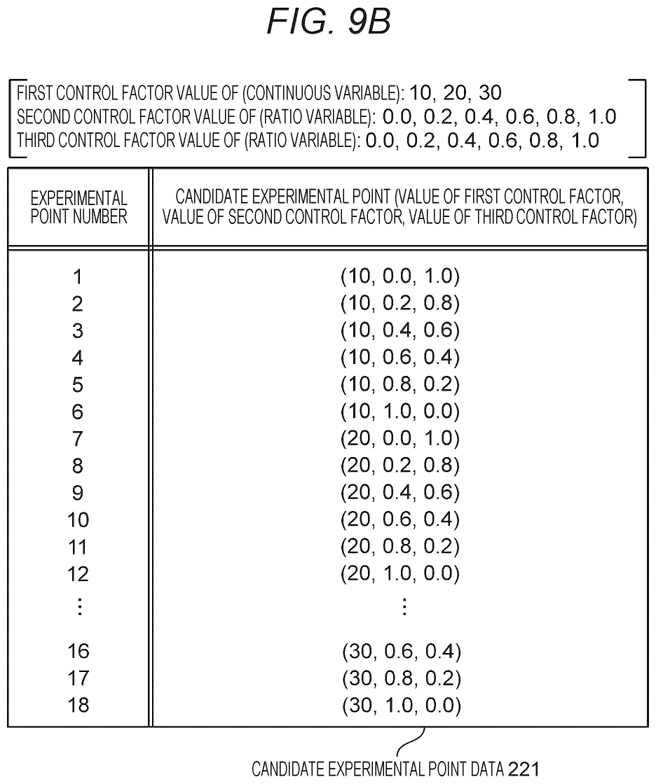

Candidate experimental point data 221 is data indicating each candidate experimental point. In the example of part (a) of FIG. 2, each candidate experimental point is expressed by a combination of values of the first control factor and the second control factor. Candidate experimental point data 221 may be data in a table format in which combinations of values of the first control factor and the second control factor are listed. A specific example of such candidate experimental point data 221 will be described in detail with reference to FIGS. 9A and 9B.

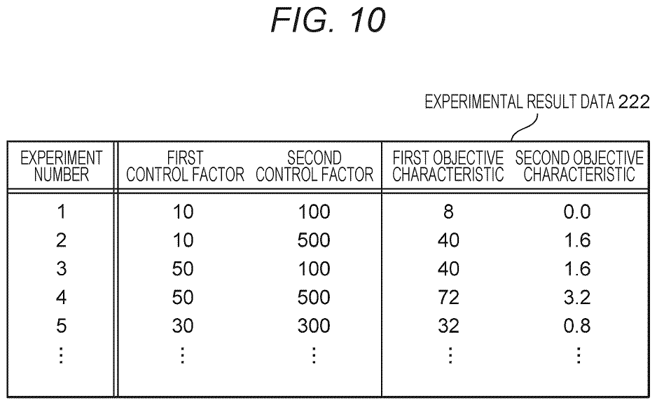

Experimental result data 222 is data indicating one or more experimental points used in an experiment and characteristic points respectively corresponding to the one or more experimental points. For example, experimental result data 222 indicates a combination of an experimental point on the experimental space in part (a) of FIG. 2 and a characteristic point on the characteristic space in part (b) of FIG. 2 obtained by an experiment using the experimental point. The experimental point is expressed by a combination of values of the first control factor and the second control factor, and the characteristic point is expressed by a combination of values of the first objective characteristic and the second objective characteristic. Experimental result data 222 may be data in a table format in which combinations of the experimental point and the characteristic point are listed. A specific example of experimental result data 222 will be described in detail with reference to FIG. 10.

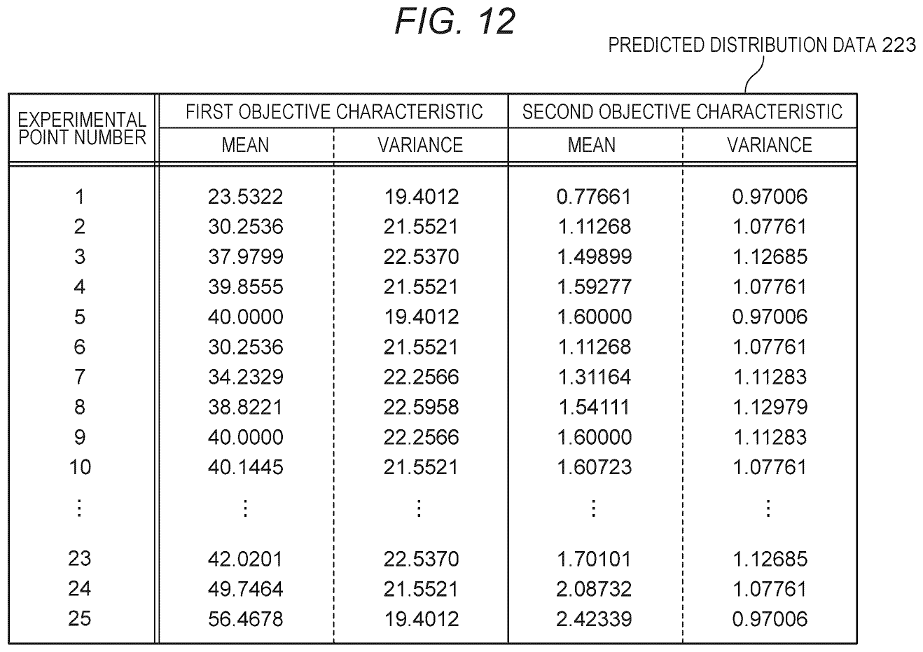

Predicted distribution data 223 is data indicating the predicted distribution of all the candidate experimental points indicated by candidate experimental point data 221. Note that in a case where the result differs (has no reproducibility) by the amount of noise when the experiment is performed at the same experimental point, predicted distribution data 223 may include data indicating the predicted distribution of an already selected experimental point. The predicted distribution is a distribution obtained by Gaussian process regression, and is expressed by a mean and a variance, for example. For example, predicted distribution data 223 may be data in a table format indicating the predicted distribution of the first objective characteristic and the predicted distribution of the second objective characteristic in association with each candidate experimental point. A specific example of predicted distribution data 223 will be described in detail with reference to FIG. 12.

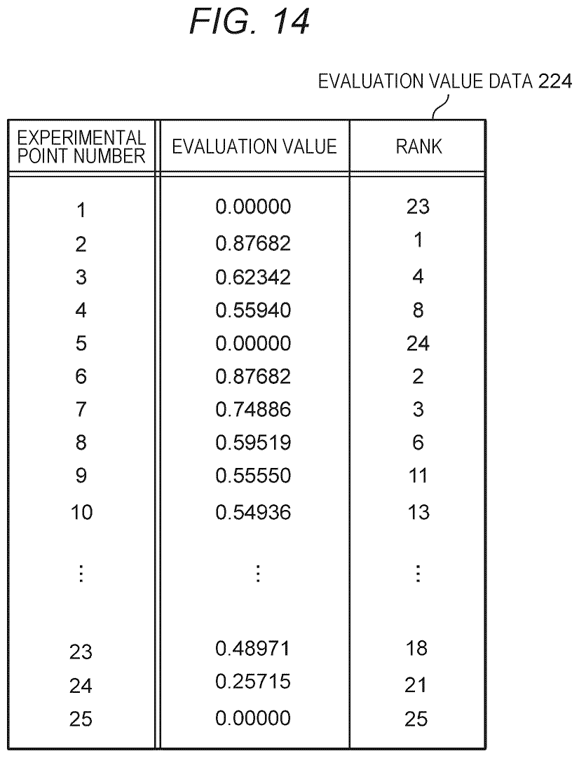

Evaluation value data 224 is data indicating an evaluation value for each of the plurality of candidate experimental points as illustrated in FIG. 1, for example. For example, evaluation value data 224 may be data in a table format indicating the evaluation value in association with each of the plurality of candidate experimental points. Another specific example of evaluation value data 224 will be described in detail with reference to FIG. 14.

In addition, weight distribution data 213 received by input unit 101a may be stored in storage 105.

Arithmetic circuit 102 is a circuit that reads program 200 from storage 105 to memory 103 and executes expanded program 200. Arithmetic circuit 102 is, for example, a central processing unit (CPU), a graphics processing unit (GPU), or the like.

### [Functional Configuration]

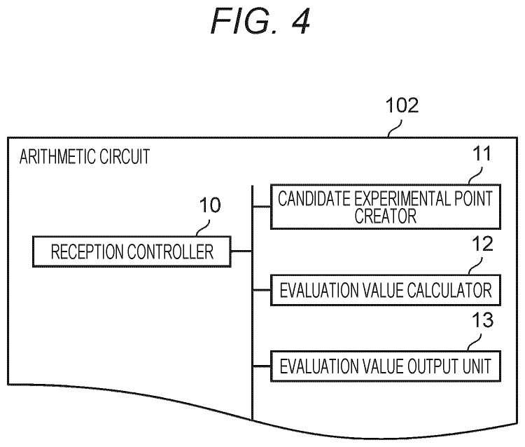

FIG. 4 is a block diagram illustrating a functional configuration of arithmetic circuit 102.

Arithmetic circuit 102 implements a plurality of functions for generating evaluation value data 224 by executing program 200. Specifically, arithmetic circuit 102 includes reception controller (also referred to as first reception means and second reception means) 10, candidate experimental point creator 11, evaluation value calculator (also referred to as calculation means) 12, and evaluation value output unit (also referred to as output means) 13.

Reception controller 10 receives characteristic point data 201, control factor data 211, objective data 212, and weight distribution data 213 via input unit 101a or communication unit 101b. For example, when characteristic point data 201 is input by an input operation to input unit 101a by the user, reception controller 10 writes the characteristic point indicated in characteristic point data 201 into experimental result data 222 of storage 105 in association with an experimental point. As a result, experimental result data 222 is updated. When experimental result data 222 is updated, reception controller 10 causes evaluation value calculator 12 to execute processing using experimental result data 222 having been updated. That is, reception controller 10 causes evaluation value calculator 12 to execute calculation of the evaluation value. Note that at this time, evaluation value calculator 12 executes calculation of the evaluation value using candidate experimental point data 221 already stored in storage 105. In this manner, reception controller 10 causes evaluation value calculator 12 to start the calculation of the evaluation value with the input of characteristic point data 201 as a trigger.

Furthermore, reception controller 10 may cause evaluation value calculator 12 to start calculation of the evaluation value in response to another trigger. For example, when experimental result data 222 is already stored in storage 105, reception controller 10 may cause evaluation value calculator 12 to start calculation of the evaluation value with the input of the level of the experimental point by the user as a trigger. Note that the level of the experimental point may be, for example, a minimum value, a maximum value, a discrete width, or the like of possible values of the control factor, or may be a possible value of the control factor. That is, when the level of the experimental point is input by the user and candidate experimental point data 221 is generated based on the level, reception controller 10 causes evaluation value calculator 12 to start calculation of the evaluation value based on candidate experimental point data 221 and experimental result data 222.

Alternatively, when candidate experimental point data 221 is already stored in storage 105, reception controller 10 may cause evaluation value calculator 12 to start calculation of the evaluation value with the input of experimental result data 222 by the user as a trigger. When experimental result data 222 is input by the user, reception controller 10 causes evaluation value calculator 12 to start calculation of the evaluation value based on experimental result data 222 and candidate experimental point data 221.

Alternatively, when candidate experimental point data 221 is already stored in storage 105, reception controller 10 may cause evaluation value calculator 12 to start calculation of the evaluation value with the reception of experimental result data 222 by communication unit 101b as a trigger. For example, experimental equipment, an experimental device, a manufacturing device, or the like transmits experimental result data 222 to evaluation device 100, and communication unit 101b receives experimental result data 222. When experimental result data 222 is received by communication unit 101b, reception controller 10 causes evaluation value calculator 12 to start calculation of the evaluation value based on experimental result data 222 and candidate experimental point data 221.

Thus, when there are candidate experimental point data 221 and experimental result data 222, reception controller 10 causes evaluation value calculator 12 to start calculation of the evaluation value based on them. Note that when experimental result data 222 is already stored in storage 105, reception controller 10 may cause evaluation value calculator 12 to start calculation of the evaluation value with the input of candidate experimental point data 221 by the user as a trigger. Furthermore, when candidate experimental point data 221 and experimental result data 222 are already stored in storage 105, reception controller 10 may cause evaluation value calculator 12 to start calculation of the evaluation value with the input of a start instruction by the user as a trigger.

Candidate experimental point creator 11 generates candidate experimental point data 221 based on control factor data 211 acquired by reception controller 10. That is, candidate experimental point creator 11 creates each of a plurality of candidate experimental points using the value of one or more control factors. Then, candidate experimental point creator 11 stores, in storage 105, candidate experimental point data 221 having been generated.

Evaluation value calculator 12 reads candidate experimental point data 221 and experimental result data 222 from storage 105, and generates predicted distribution data 223 based on these data and the weight distribution data 213 acquired by reception controller 10. Then, evaluation value calculator 12 stores predicted distribution data 223 in storage 105. Moreover, evaluation value calculator 12 generates evaluation value data 224 based on predicted distribution data 223, and objective data 212 acquired by reception controller 10, and stores evaluation value data 224 into storage 105.

Evaluation value output unit 13 reads evaluation value data 224 from storage 105 and outputs evaluation value data 224 to display 104. Alternatively, evaluation value output unit 13 may output evaluation value data 224 to an external device via communication unit 101b. That is, evaluation value output unit 13 outputs the evaluation value of each candidate experimental point. Note that evaluation value output unit 13 may directly acquire evaluation value data 224 from evaluation value calculator 12 and output evaluation value data 224 to display 104. Similarly, evaluation value output unit 13 reads predicted distribution data 223 from storage 105 and outputs predicted distribution data 223 to display 104. Note that evaluation value output unit 13 may directly acquire predicted distribution data 223 from evaluation value calculator 12 and output predicted distribution data 223 to display 104.

### [Input]

FIG. 5 is a diagram illustrating an example of a first reception image displayed on display 104 to receive the input of setting information 210.

First reception image 300 includes control factor region 310 and objective characteristic region 320. Control factor region 310 is a region for receiving an input of control factor data 211. Objective characteristic region 320 is a region for receiving an input of objective data 212.

Control factor region 310 has input fields 311 to 314. Input field 311 is a field for inputting the name of the first control factor. For example, in input field 311, “X1” is input as the name of the first control factor. Input field 312 is a field for inputting the value of the first control factor. For example, in input field 312, “−5, −4, −3, −2, −1, 0, 1, 2, 3, 4, 5” is input as the value of the first control factor. Similarly, input field 313 is a field for inputting the name of the second control factor. For example, in input field 313, “X2” is input as the name of the second control factor. Input field 314 is a field for inputting the value of the second control factor. For example, in input field 314, “−5, −4, −3, −2, −1, 0, 1, 2, 3, 4, 5” is input as the value of the second control factor.

By such input to input fields 311 to 314, control factor data 211 corresponding to the input result is input to evaluation device 100.

Objective characteristic region 320 has input fields 321 to 324. Input fields 321 and 323 are fields for inputting the name of the first objective characteristic and the name of the second objective characteristic. For example, “Y1” is input as the name of the first objective characteristic into input field 321, and “Y2” is input as the name of the second objective characteristic into input field 323. Input fields 322 and 324 are fields for selecting optimization objectives of the first objective characteristic and the second objective characteristic. Specifically, each of input fields 322 and 324 has two radio buttons for selecting any one of “maximization” and “minimization” as an objective. The objective “maximization” aims at maximizing the value of the first objective characteristic or the second objective characteristic, and the objective “minimization” aims at minimizing the value of the first objective characteristic or the second objective characteristic.

By such input to input fields 321 to 324, objective data 212 corresponding to the input result is input to evaluation device 100. That is, reception controller 10 acquires objective data 212 according to the input to input fields 322 and 324. In the example of FIG. 5, objective data 212 indicates the maximization of the value of the first objective characteristic as the optimization objective of the first objective characteristic, and indicates the minimization of the value of the second objective characteristic as the optimization objective of the second objective characteristic.

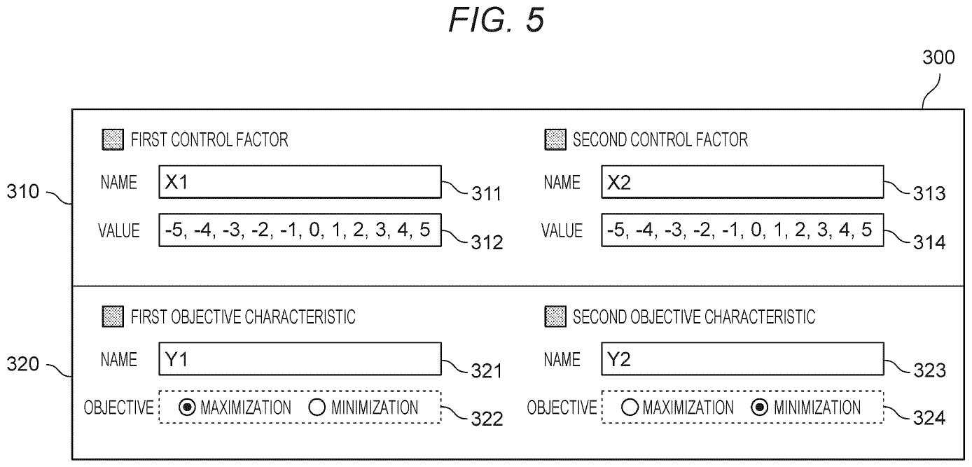

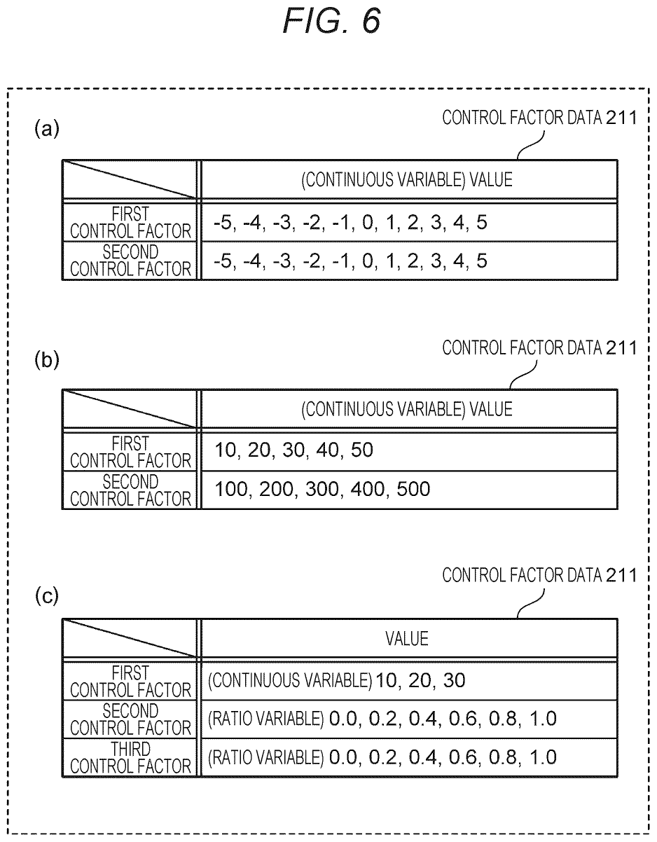

FIG. 6 is a diagram illustrating an example of control factor data 211.

For example, in the example of control factor data 211 illustrated in part (a) of FIG. 6, the first control factor and the second control factor can take values discrete by 1 from −5 to 5. In the example illustrated in part (a) of FIG. 6, the first control factor and the second control factor are continuous variables. The continuous variable can take a continuous value, but it is difficult to perform arithmetic processing with the continuous value. Therefore, it is preferable to discretize the value of each control factor and set a finite number of candidate experimental points. Therefore, when the control factor is a continuous variable, the user inputs a condition (minimum value, maximum value, and discrete width) of the control factor, and evaluation device 100 determines a possible value of the control factor based on the condition. Note that the discrete width need not be constant, and for example, may be set irregularly so as to be at a level, such as “1, 3, 7, 15”. That is, reception controller 10 receives the condition of the control factor according to the input operation to input unit 101a by the user, and determines the possible value of the control factor based on the condition. Then, reception controller 10 generates control factor data 211 indicating the determined possible value of the control factor, and displays the possible value of the control factor in input field 312 or 314 included in control factor region 310 of first reception image 300 in FIG. 5, for example.

Note that the variable includes a discrete variable different from a continuous variable. When the control factor is a discrete variable, the discrete variable does not have a magnitude relationship and a numerical magnitude such as “apple, orange, and banana” or “with catalyst, and without catalyst”.

In the example in part (a) of FIG. 6, the first control factor and the second control factor can take the same value, but the present disclosure is not limited to this. For example, as illustrated in part (b) of FIG. 6, possible values of the first control factor and the second control factor may be different from each other. In the example of control factor data 211 illustrated in part (b) of FIG. 6, the first control factor can take a value discrete by 10 from 10 to 50. On the other hand, the second control factor can take a value discrete by 100 from 100 to 500.

In the examples illustrated in parts (a) and (b) of FIG. 6, the value of the control factor is an absolute value, but the present disclosure is not limited to this. The value of the control factor may be a relative value such as a ratio to the value of another control factor or to the sum of the values of all control factors. In the example illustrated in part (c) of FIG. 6, control factor data 211 indicates the value of a ratio variable different from the value of a continuous variable. The ratio variable can take a relative value such as the ratio described above. For example, as illustrated in part (c) of FIG. 6, control factor data 211 may indicate the value of the continuous variable of the first control factor, the value of the ratio variable of the second control factor, and the value of the ratio variable of the third control factor. Specifically, the value of the continuous variable of the first control factor can be a value discrete by 10 from 10 to 30, for example. The value of the ratio variable of the second control factor is, for example, “0.0, 0.2, 0.4, 0.6, 0.8, 1.0”, and the value of the ratio variable of the third control factor is, for example, “0.0, 0.2, 0.4, 0.6, 0.8, 1.0”. The ratio variable indicates a compound ratio of a material of the second control factor or the third control factor in a synthetic material generated by compounding the material of the second control factor and the material of the third control factor, for example.

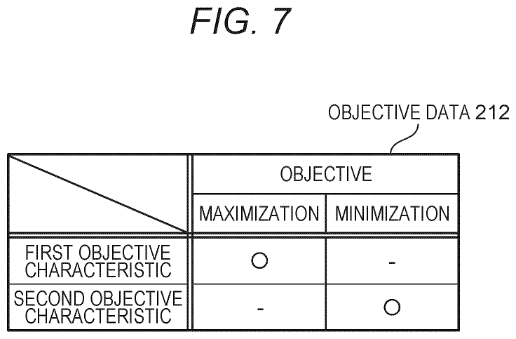

FIG. 7 is a diagram illustrating an example of objective data 212.

Objective data 212 input by objective characteristic region 320 of first reception image 300 of FIG. 5 indicates the optimization objective of the first objective characteristic and the optimization objective of the second objective characteristic as illustrated in FIG. 7, for example. Specifically, objective data 212 indicates “maximization” as the optimization objective of the first objective characteristic, and indicates “minimization” as the optimization objective of the second objective characteristic.

### [Processing Operation]

Evaluation device 100 performs processing related to calculation and output of the evaluation value using each piece of data having been input as described above.

FIG. 8 is a flowchart illustrating a processing operation of evaluation device 100 according to the present exemplary embodiment.

First, candidate experimental point creator 11 generates candidate experimental point data 221 using control factor data 211 (step S1).

Next, reception controller 10 acquires objective data 212 (step S2). That is, reception controller 10 executes a second reception step of acquiring the objective data indicating the optimization objective. Furthermore, reception controller 10 acquires weight distribution data 213 (step S3). Furthermore, reception controller 10 reads experimental result data 222 from storage 105 (step S4). That is, reception controller 10 executes a first reception step of acquiring experimental result data 222 indicating an experimented experimental point and a known characteristic point. Note that in a case where none of the characteristic points is indicated in experimental result data 222, the processing of steps S4 to S6 is skipped.

Then, evaluation value calculator 12 calculates the evaluation value of each candidate experimental point based on objective data 212, weight distribution data 213, candidate experimental point data 221, and experimental result data 222 (step S5). That is, evaluation value calculator 12 executes a calculation step of the evaluation value of an unknown characteristic point based on those data. Specifically, evaluation value calculator 12 calculates the evaluation value of each candidate experimental point not yet used in experiment among the plurality of candidate experimental points indicated in candidate experimental point data 221. Then, evaluation value calculator 12 generates evaluation value data 224 indicating the calculated evaluation value of each candidate experimental point.

Next, evaluation value output unit 13 outputs, to display 104, the evaluation value calculated in step S5, that is, evaluation value data 224 (step S6). That is, evaluation value output unit 13 executes an output step of outputting the evaluation value. As a result, evaluation value data 224 is displayed on display 104, for example.

Then, reception controller 10 acquires an operation signal from input unit 101a in response to an input operation to input unit 101a by the user. The operation signal indicates end of search for an optimal solution or continuation of the search for an optimal solution. Note that the search for an optimal solution is processing of performing calculation and output of the evaluation value of each candidate experimental point based on a new experimental result. Reception controller 10 determines whether the operation signal indicates end of search for an optimal solution or indicates continuation thereof (step S7).

When determining that the operation signal indicates end of the search for an optimal solution (“end” in step S7), reception controller 10 ends all the processing. On the other hand, when determining that the operation signal indicates continuation of the search for an optimal solution (“continue” in step S7), reception controller 10 writes, into experimental result data 222 of storage 105, the candidate experimental point selected as the next experimental point. For example, when the user performs an input operation on input unit 101a, reception controller 10 selects the candidate experimental point as the next experimental point from evaluation value data 224. Reception controller 10 writes the thus selected candidate experimental point into experimental result data 222. Then, when the characteristic point corresponding to the next experimental point is obtained by experiment, the user performs an input operation on input unit 101a, thereby inputting, into evaluation device 100, characteristic point data 201 indicating the characteristic point. Reception controller 10 acquires characteristic point data 201 having been input, and writes the characteristic point indicated by characteristic point data 201 into experimental result data 222 of storage 105. At this time, the characteristic point is associated with the most recently selected and written experimental point. As a result, a new experimental result is recorded in experimental result data 222 (step S8). That is, experimental result data 222 is updated. When experimental result data 222 is updated, evaluation value calculator 12 repeatedly executes the processing from step S4.

In a process through the above flow, the optimal experimental conditions (i.e., candidate experimental point) to be performed next can be quantitatively analyzed from a past experimental result. As a result, the development cycle can be expected to be shortened regardless of the ability of the analyst such as the user.

FIG. 9A is a diagram illustrating an example of candidate experimental point data 221.

Candidate experimental point creator 11 generates candidate experimental point data 221 illustrated in FIG. 9A based on control factor data 211 illustrated in part (b) of FIG. 6, for example. For example, in a case where each value of all the control factors indicated by control factor data 211 is a value of a continuous variable and there is no constraint regarding the value, candidate experimental point creator 11 creates, as a candidate experimental point, each of all combinations of the values of the control factors. In the case of control factor data 211 illustrated in part (b) of FIG. 6, control factor data 211 indicates the value “10, 20, 30, 40, 50” of the continuous variable of the first control factor and the value “100, 200, 300, 400, 500” of the continuous variable of the second control factor. Therefore, candidate experimental point creator 11 creates, as a candidate experimental point, each of all combinations such as a combination of the value “10” of the first control factor and the value “100” of the second control factor and a combination of the value “10” of the first control factor and the value “200” of the second control factor. Candidate experimental point creator 11 associates an experimental point number with the created candidate experimental point, and generates candidate experimental point data 221 indicating the candidate experimental point with which the experimental point number is associated.

In a specific example, as illustrated in FIG. 9A, candidate experimental point data 221 indicates a candidate experimental point (10, 100) associated with the experimental point number “1”, a candidate experimental point (10, 200) associated with the experimental point number “2”, a candidate experimental point (10, 300) associated with the experimental point number “3”, and the like. Note that the first component of these candidate experimental points indicates the value of the first control factor, and the second component indicates the value of the second control factor.

Here, it is also possible to create, as a candidate experimental point, only a combination of values satisfying a certain constraint among all combinations of values. For example, in material development, in a case where a first compound and a second compound are set as the first control factor and the second control factor, respectively, and the compound ratio of them is set as a value, candidate experimental point creator 11 adopts, as the candidate experimental point, only a combination of values whose sum satisfies 1. Candidate experimental point data 221 in FIG. 9B illustrates an example of this case.

FIG. 9B is a diagram illustrating another example of candidate experimental point data 221.

Candidate experimental point creator 11 generates candidate experimental point data 221 illustrated in FIG. 9B based on control factor data 211 illustrated in part (c) of FIG. 6, for example. In this case, control factor data 211 indicates “0.0, 0.2, 0.4, 0.6, 0.8, 1.0” as the value of the ratio variable of the second control factor, and indicates “0.0, 0.2, 0.4, 0.6, 0.8, 1.0” as the value of the ratio variable of the third control factor. The combination of the values of these ratio variables corresponds to the compound ratio of the first compound and the second compound described above. Therefore, candidate experimental point creator 11 generates, as the candidate experimental point, a combination of the value of the first control factor, the value of the second control factor, and the value of the third control factor so that the sum of the value of the ratio variable of the second control factor and the value of the ratio variable of the third control factor satisfies 1. For example, candidate experimental point creator 11 creates, as the candidate experimental point, a combination of values in which the sum of the values of the ratio variables satisfies 1, such as a combination of the value “10” of the first control factor, the value “0.2” of the second control factor, and the value “0.8” of the third control factor. Candidate experimental point creator 11 associates an experimental point number with the created candidate experimental point, and generates candidate experimental point data 221 indicating the candidate experimental point with which the experimental point number is associated.

In a specific example, as illustrated in FIG. 9B, candidate experimental point data 221 indicates a candidate experimental point (10, 0.0, 1.0) associated with the experimental point number “1”, a candidate experimental point (10, 0.2, 0.8) associated with the experimental point number “2”, a candidate experimental point (10, 0.4, 0.6) associated with the experimental point number “3”, and the like. Note that the first component of these candidate experimental points indicates the value of the first control factor, the second component indicates the value of the second control factor, and the third component indicates the value of the third control factor.

Thus, in the present exemplary embodiment, in a case where there are a plurality of control factors, when creating each of the plurality of candidate experimental points, candidate experimental point creator 11 creates the candidate experimental point by combining values that satisfy a predetermined condition of each of the plurality of control factors. For example, as illustrated in FIG. 9B, the predetermined condition is a condition that the sum of the values of the ratio variables of the plurality of control factors is 1. In a more specific example, the ratio variable is a compound ratio of materials such as compounds corresponding to the control factors. Therefore, for each combination of compound ratios of a plurality of types of compounds, an evaluation value for the combination can be calculated. As a result, it is possible to appropriately search for an optimal solution for one or more objective characteristics of the synthetic material obtained by compounding these compounds.

FIG. 10 is a diagram illustrating an example of experimental result data 222.

Evaluation value calculator 12 reads experimental result data 222 stored in storage 105 in order to calculate the evaluation value. As illustrated in FIG. 10, experimental result data 222 indicates, for each experiment number, the experimental point used in the experiment identified by the experiment number and the characteristic point that is an experimental result obtained by the experiment. The experimental point is represented by a combination of values of control factors. For example, the experimental point is expressed by a combination of values that is a combination of the value “10” of the first control factor and the value “100” of the second control factor. The characteristic point is expressed by a combination of values of the objective characteristics obtained in the experiment. Note that the value of the objective characteristic is hereinafter also referred to as objective characteristic value. For example, the characteristic point is expressed by a combination of the value “8” of the first objective characteristic and the value “0.0” of the second objective characteristic.

In a specific example, as illustrated in FIG. 10, experimental result data 222 indicates an experimental point (10, 100) and a characteristic point (8, 0.0) associated with the experiment number “1”, an experimental point (10, 500) and a characteristic point (40, 1.6) associated with the experiment number “2”, an experimental point (50, 100) and a characteristic point (40, 1.6) associated with the experiment number “3”, and the like.

### [Evaluation Value Calculation Processing]

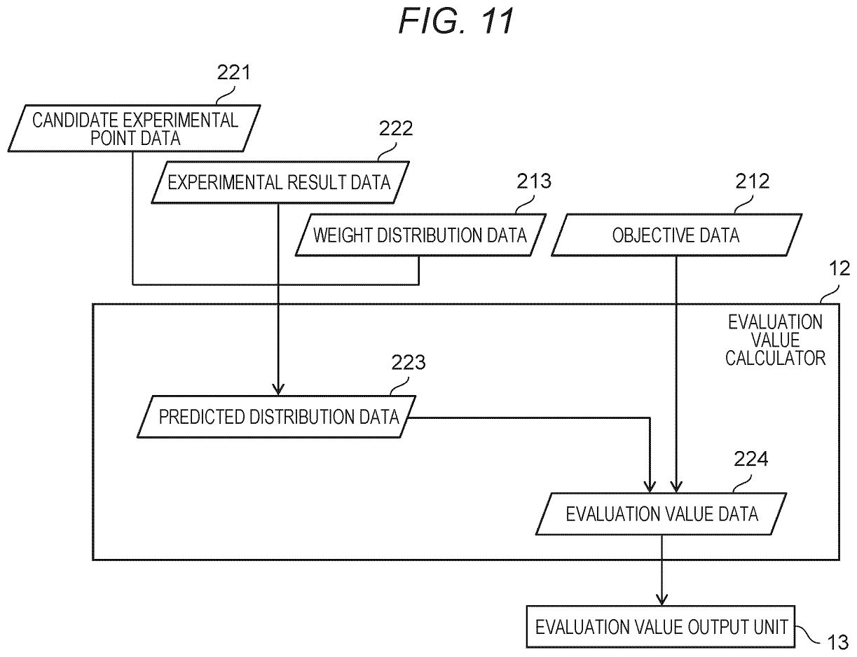

FIG. 11 is a diagram for explaining processing by evaluation value calculator 12. Evaluation value calculator 12 generates predicted distribution data 223 based on candidate experimental point data 221 generated by candidate experimental point creator 11, experimental result data 222 present in storage 105, and weight distribution data 213 received by reception controller 10. Then, evaluation value calculator 12 generates evaluation value data 224 based on objective data 212 indicating the optimization objective of each objective characteristic and predicted distribution data 223.

Here, experimental result data 222 indicates one or more experimental points that are one or more candidate experimental points already used in experiment among the plurality of candidate experimental points, and the characteristic points corresponding to respective one or more experimental points, the characteristic points being an experimental result of one or more objective characteristics using the experimental points. Therefore, evaluation value calculator 12 according to the present exemplary embodiment calculates, based on Bayesian optimization, the evaluation value of each of the candidate experimental points based on (a) the optimization objective of each of one or more objective characteristics, (b) weight distribution data, (c) one or more experimental points that are one or more candidate experimental points already used in experiment among the plurality of candidate experimental points, and (d) characteristic points corresponding to respective one or more experimental points, the characteristic points indicating experimental results of one or more objective characteristics using the experimental points.

Evaluation value calculator 12 outputs generated evaluation value data 224 to evaluation value output unit 13. Note that evaluation value calculator 12 may also output predicted distribution data 223 to evaluation value output unit 13. Alternatively, evaluation value calculator 12 may store predicted distribution data 223 in storage 105, and evaluation value output unit 13 may read predicted distribution data 223 from storage 105 in response to an input operation to input unit 101a by the user.

Evaluation value calculator 12 describes the correspondence relationship between the candidate experimental point and the characteristic point in Gaussian process. The Gaussian process is a probability process in which output values corresponding to a plurality of inputs follow a Gaussian distribution (normal distribution). In the present exemplary embodiment, the Gaussian process is a probability process in which a vector f(x^{N}) of a characteristic point corresponding to a vector x^{N} of a finite number of candidate experimental points is assumed to follow an N-dimensional normal distribution. The distance between experimental point x and experimental point x′ is determined by positive definite kernel k (x, x′), and a covariance matrix is represented using this kernel. Note that N is an integer of 1 or more, and is the number of executed experimental results.

Furthermore, normality of the multidimensional normal distribution is preserved even if the multidimensional normal distribution is conditioned with some elements. In the present exemplary embodiment, by using this property, a simultaneous distribution of an executed experimental result having a known correspondence relationship with a candidate experimental point and a next experimental result having an unknown correspondence relationship with the candidate experimental point is considered, and a distribution conditioned with the known correspondence relationship is defined as a predicted distribution. The mean of the predicted distribution is calculated by the following (Formula 1) for each dimension (i.e., each dimension of objective characteristic), and the variance of the predicted distribution is calculated by the following (Formula 2) for each dimension.

$$\begin{matrix}[ Math . 1 ] & \\ \hat{m} ( {x}_{( N + 1 )} ) = m ( {x}_{( N + 1 )} ) + {( {k}_{N + 1} )}^{T} {( {K}_{N , N} + {\hat{σ}}_{x}^{2} ( {x}_{( N + 1 )} ) I )}^{- 1} ( {y}^{N} - m ( {x}^{N} ) ) \hat{v} ( {x}_{( N + 1 )} , {x}_{( N + 1 )} ) & ( Formula 1 )\end{matrix}$$

$$= k ( {x}_{( N + 1 )} , {x}_{( N + 1 )} ) - {( {k}_{N + 1} )}^{T} {( {K}_{N , N} + {\hat{σ}}_{x}^{2} ( {x}_{( N + 1 )} ) I )}^{- 1} {k}_{N + 1} + {\hat{σ}}_{x}^{2} ( {x}_{( N + 1 )} ) \qquad ( Formula 2 )$$

In (Formula 1) and (Formula 2), x^{N}=(x₍₁₎, . . . x_{(N)})^{T} represents a matrix summarizing past experimental points, and x_{(N+1)} represents a new candidate experimental point. y^{N}=(y₍₁₎, . . . , y_{(N)})^{T} represents a matrix in which characteristic points corresponding to past experimental points are collected. K_{N+1} represents an N-dimensional vector having k(x₍ᵢ₎, x_{(N+1)}) as an i-th component, and K_{N,N} represents an N×N Gram matrix having k(x₍ᵢ₎, x₍ⱼ₎) as an (i, j) component.

$${\hat{σ}}_{x}^{2} ( {x}_{( N + 1 )} ) \qquad [ Math . 2 ]$$

The above represents an estimated amount of the error variance based on the observation error, and hereinafter, may be simplified as an error variance σ². The error variance σ² is estimated using weight distribution data 213 described above. The error variance will be described later in detail. I represents an N-order identity matrix. Kernel k(⋅,⋅) and its hyperparameters are appropriately set by the analyst such as a user, for example. Note that each of i and j is an integer from 1 to N inclusive. Furthermore, m is called a mean function, and is set to an appropriate function when the behavior of y_{(N+1)} with respect to x_{(N+1)} is known to some extent. In a case where the behavior is unknown, m may be set to a constant such as 0.

Evaluation value calculator 12 generates predicted distribution data 223 by performing calculation using the above (Formula 1) and (Formula 2) on the known experimental result indicated in experimental result data 222 read from storage 105 in step S4.

FIG. 12 is a diagram illustrating an example of predicted distribution data 223. Predicted distribution data 223 indicates the mean and variance of the predicted distribution at each candidate experimental point. This predicted distribution is a distribution calculated by (Formula 1) and (Formula 2) as a conditional distribution by Gaussian process for each objective characteristic. For example, as illustrated in FIG. 12, predicted distribution data 223 indicates, for each experimental point number, the mean and variance of the predicted distribution of the first objective characteristic and the mean and variance of the predicted distribution of the second objective characteristic corresponding to the experimental point number.

In a specific example, as illustrated in FIG. 12, predicted distribution data 223 indicates a mean “23.5322” and a variance “19.4012” of the first objective characteristic and a mean “0.77661” and a variance “0.97006” of the second objective characteristic corresponding to the experimental point number “1”. Predicted distribution data 223 indicates a mean “30.2536” and a variance “21.5521” of the first objective characteristic and a mean “1.11268” and a variance “1.07761” of the second objective characteristic corresponding to the experimental point number “2”. Note that the experimental point number is associated with the candidate experimental point as illustrated in FIG. 9A or 9B.

Evaluation value calculator 12 calculates an evaluation value based on an evaluation criterion called acquisition function in Bayesian optimization. The above-described predicted distribution is used to calculate the evaluation value.

Hereinafter, the acquisition function of the Bayesian optimization (i.e., EHVI of NPL 1) will be described. However, regarding maximization and minimization, since reversing the sign of one makes it equivalent to the other, minimization will be described as a representative of the two. In EHVI, it is considered that the larger the volume of the improvement region (also referred to as improvement amount), the more improved characteristic point was obtained from the provisional experimental result. The improvement region is a region surrounded by a Pareto boundary determined from the coordinates of a Pareto point (i.e., non-inferior solution) among at least one characteristic point already obtained from the performed experiment and a Pareto boundary newly determined by a new characteristic point when the new characteristic point is observed. Note that the Pareto point is a characteristic point that is provisionally a Pareto solution at the present time. For example, in a case where the optimization objective of each of the first objective characteristic and the second objective characteristic is minimization, there is no other characteristic point at which both the values of the first objective characteristic and the second objective characteristic are smaller than the Pareto point. The Pareto boundary is a boundary line determined by connecting the coordinates of the Pareto point along the directions of the first objective characteristic and the second objective characteristic. Furthermore, in the following description, of the entire characteristic space divided by the Pareto boundary, the region where each objective characteristic takes smaller value is referred to as an active region, and the region where the each objective characteristic takes larger value is referred to as an inactive region. The amount of improvement when a new characteristic point enters the inactive region is set to 0.

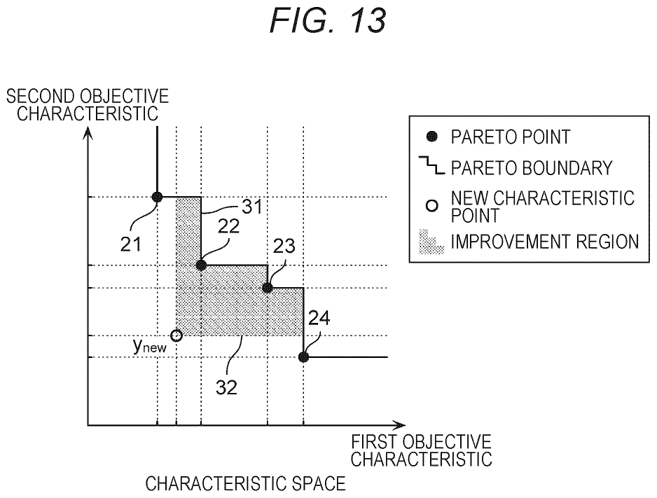

FIG. 13 is a diagram illustrating an example of an improvement region.

For example, as illustrated in FIG. 13, a region surrounded by Pareto boundary 31 determined by four Pareto points 21 to 24 and Pareto boundary 32 newly determined when one new characteristic point y_{new} is obtained is identified as the improvement region.

Here, the behavior of each objective characteristic value in a case where each candidate experimental point is selected by Gaussian process regression is expressed in the form of normal distribution, and the improvement amount also varies depending on the position of the observed characteristic point. EHVI is defined as an amount in which an expectation value of an improvement amount in a predicted distribution is taken for each candidate experimental point as in the following (Formula 3). A candidate experimental point having a larger value obtained by EHVI has a larger expectation value of the improvement amount, and represents an experimental point to be executed next.

$$\begin{matrix}[ Math . 3 ] & \\ EHVI ( {x}_{new} ) = {\int }_{{ℝ}^{D}}^{} I ( {y}_{new} ) p ( {y}_{new} \vert {x}_{new} ) {dy}_{new} & ( Formula 3 )\end{matrix}$$

In (Formula 3), D represents the number of objective characteristics (i.e., number of dimensions).

$${\overline{y}}_{( n )} \qquad [ Math . 6 ]$$

The above represents a D-dimensional Euclidean space, and I (y_{new}) represents an improvement amount. Furthermore, p(y_{new}|x_{new}) represents a predicted distribution of the characteristic point y_{new} corresponding to a new experimental point x_{new} when one candidate experimental point is selected from at least one candidate experimental point as the new experimental point x_{new}. The predicted distribution of each dimension of the characteristic point y_{new}, that is, the mean and the variance are obtained by the above (Formula 1) and (Formula 2). Evaluation value calculator 12 calculates EHVI (x_{new}) as an evaluation value by such (Formula 3).

### [Output]

Evaluation value output unit 13 acquires evaluation value data 224 indicating the evaluation value of each candidate experimental point calculated as described above by evaluation value calculator 12, and causes display 104 to display evaluation value data 224. Note that evaluation value output unit 13 may directly acquire evaluation value data 224 from evaluation value calculator 12, or may acquire evaluation value data 224 by reading evaluation value data 224 stored in storage 105 by evaluation value calculator 12.

FIG. 14 is a diagram illustrating an example of evaluation value data 224. For example, as illustrated in FIG. 14, evaluation value data 224 indicates the evaluation value and its rank at each candidate experimental point. Specifically, evaluation value data 224 indicates, for each experimental point number, the evaluation value corresponding to the experimental point number and the rank of the evaluation value. As illustrated in FIGS. 9A and 9B, each experimental point number is associated with a candidate experimental point. Therefore, it can be said that evaluation value data 224 indicates, for each candidate experimental point, the evaluation value corresponding to the candidate experimental point and the rank of the evaluation value. In addition, the rank indicates a smaller numerical value as the evaluation value is larger, and conversely, the rank indicates a larger numerical value as the evaluation value is smaller.

In a specific example, as illustrated in FIG. 14, evaluation value data 224 indicates an evaluation value “0.00000” and a rank “23” corresponding to the experimental point number “1”, an evaluation value “0.87682” and a rank “1” corresponding to the experimental point number “2”, an evaluation value “0.62342” and a rank “4” corresponding to the experimental point number “3”, and the like.

Displaying of such evaluation value data 224 on display 104 allows the user to judge whether to continue or end the search for an optimal solution. Moreover, when continuing the search for an optimal solution, the user can select a candidate experimental point to be the next experimental point from all the displayed experimental point numbers, that is, all the candidate experimental points, based on each displayed evaluation value and each rank. For example, the user selects the candidate experimental point corresponding to the largest evaluation value (i.e., evaluation value whose rank is 1). At this time, the user may perform an input operation on input unit 101a to sort the evaluation values of evaluation value data 224 in descending order. That is, evaluation value output unit 13 sorts the evaluation values in evaluation value data 224 such that the evaluation values are in descending order and the ranks are in ascending order. This makes it easy to find the largest evaluation value.

### [Observation Error and Weight Distribution Data]

Here, the observation error and weight distribution data 213 will be described in detail.

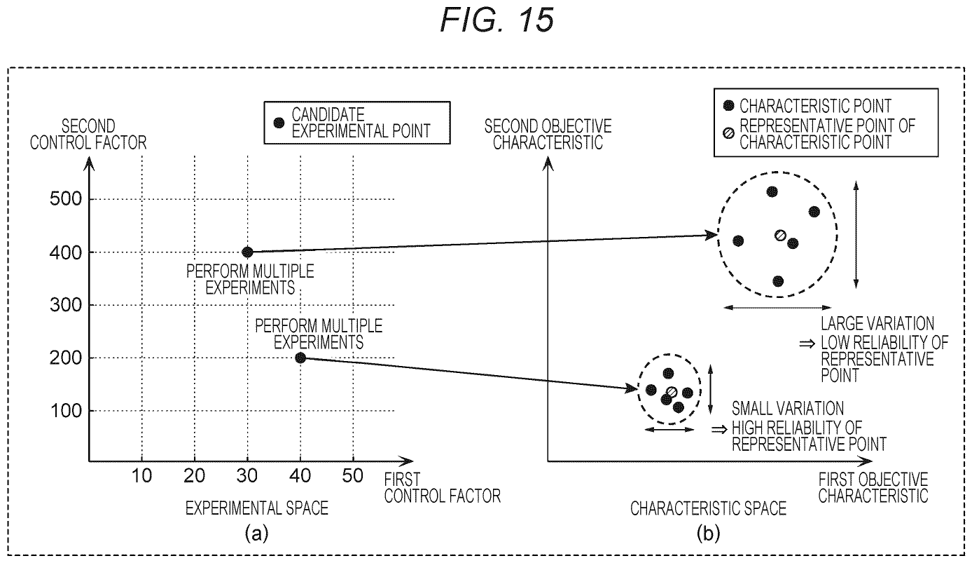

FIG. 15 is a diagram illustrating an example of variation in characteristic points. Specifically, the graph in part (a) of FIG. 15 illustrates candidate experimental points arranged in the experimental space, and the graph in part (b) of FIG. 15 illustrates characteristic points arranged in the characteristic space.

Experiments are subject to observation errors. That is, even if the same experimental condition is selected and the experiment is performed a plurality of times, variation occurs in the objective characteristic values (i.e., characteristic points) obtained by the experiments. For example, as shown in part (a) of FIG. 15, a candidate experimental point indicated by the level “40” of the first control factor and the level “200” of the second control factor is selected as a first experimental condition, and a plurality of experiments are performed under the first experimental condition. As illustrated in part (b) of FIG. 15, the characteristic points obtained by these experiments are dispersed in the characteristic space and show variation. Similarly, as shown in part (a) of FIG. 15, a candidate experimental point indicated by the level “30” of the first control factor and the level “400” of the second control factor is selected as a second experimental condition, and a plurality of experiments are performed under the second experimental condition. As illustrated in part (b) of FIG. 15, the characteristic points obtained by these experiments are dispersed widely in the characteristic space and show significant variation.

Here, it becomes difficult to handle when a plurality of objective characteristic values exist for the same experimental condition. Therefore, in general, analysis is performed using a mean value or the like of the plurality of objective characteristic values as a representative value. However, the accuracy of analysis depends on how the representative value is determined. As in the experiments performed under the first experimental condition, when the variation of the plurality of characteristic points obtained is small, that is, when the observation error is small, the deviation of the representative value from the true characteristic point is small. That is, the reliability of the representative value is high. On the other hand, as in the experiments performed under the second experimental condition, when the variation of the plurality of characteristic points obtained is large, that is, when the observation error is large, the deviation of the representative value from the true characteristic point is large. That is, the reliability of the representative value is low.

Examples of the factor that causes the observation error include an adjustment error of an experimental instrument, a feeling or a tone of an experimenter, a quality of a material, a surrounding environment such as a temperature or humidity, and an observation error by a sensor.

In addition, the observation error is not universal. That is, universal variability (i.e., error variance) is rare, no matter when, who, where, or what laboratory instrument is used. For example, how the observation errors vary depends on the level space of the control factor. Note that “space” means “space” as a mathematical term. That is, “level space” means a set of combinations of levels determined from the set levels of the control factors, and may be synonymous with the above-described experimental space. Note that the space we use in our daily life is a set of coordinates consisting of three-dimensional real values (i.e., three-dimensional Euclidean space), which means a special example of a “space” in mathematical terms.

As a specific example, an experiment is performed in which the temperature of a material A is sequentially set to 0° C., 100° C., 200° C. . . . , and 1000° C. as the levels of control factors, and the characteristics of a material B are observed as objective characteristics. At this time, it is easy to control the temperature to 0° C. close to normal temperature, and even in a case where the experiment is performed a plurality of times, an adjustment error of the temperature is small. That is, the observation error of the objective characteristic value is small. However, it is difficult to control the temperature to 1000° C., and when the experiment is performed a plurality of times, an adjustment error of the temperature becomes large. That is, the observation error of the objective characteristic value increases. As a result, variation in characteristic points also increases.

Therefore, in order to search for an optimal solution with higher accuracy, it is necessary to perform analysis in consideration of a non-universal error variance, that is, a changing error variance. In a simple idea, the error variance can be estimated to some extent by performing experiments on each candidate experimental point a plurality of times under the same condition. However, the number of necessary experiments becomes enormous, and it is not possible to achieve the original objective of searching for an optimal solution with the smallest number of experiments for cost reduction. Therefore, it is necessary to efficiently estimate the error variance from a small number of experimental results.

The error variance included in (Formula 1) and (Formula 2) described above in the present exemplary embodiment depends on the level space, and is an amount efficiently estimated from a small number of experimental results. Such an error variance is calculated or estimated by the following (Formula 4).

$${ℝ}^{D} \qquad [ Math . 4 ]$$

Here, W_{x(N+1)} (x₍ₙ₎) is a weight distribution determined by the user for a candidate experimental point x_{(N+1)}, and represents a weight at an experimental point x₍ₙ₎. The weight distribution is indicated by weight distribution data 213 described above. Note that n is an integer of 1 to N.

$$\begin{matrix}[ Math . 5 ] & \\ {\hat{σ}}_{x}^{2} ( {x}_{( N + 1 )} ) = \frac{{\sum }_{n = 1}^{N} \{ {W}_{{x}_{( n )}} ( {x}_{( n )} ) ( {y}_{( n )} - {\overline{y}}_{( n )} ) \}}{{\sum }_{n = 1}^{N} {W}_{{x}_{( N + 1 )}}^{2} ( {x}_{( n )} )} & ( Formula 4 )\end{matrix}$$

The above is a reference point (or representative point) set by the user. For example, the reference point is set to a characteristic point or the like defined as a mean of a predicted distribution (i.e., predicted distribution calculated most recently) before one iteration processing at the experimental point x₍ₙ₎. In addition, (Formula 4) is a mathematical expression when the dimension of the objective characteristic is 1. When there are a plurality of dimensions of the objective characteristic, error variance σ² is estimated for each dimension. In this case, a value corresponding to the dimension of each objective characteristic is used for y(n) and W_{x(N+1)} (x₍ₙ₎). As a result, (Formula 4) can be naturally applied to multi-dimensions.

In a case where all the weights are 1 and the reference point is the sample mean, (Formula 4) corresponds to a commonly used formula of sample variance. Therefore, (Formula 4) can be interpreted as an extension of the general sample variance.

Furthermore, when there are a plurality of dimensions of the control factor, for each objective characteristic, a weight distribution W_{dy,dx;xdx} (x′_{dx}) is set for each dimension of the control factor. Then, for each objective characteristic, the product of the weight distributions of the dimensions of the control factors, that is, the product of the weights included in each of the weight distributions of the dimensions is defined as the weight distribution W_{dy;x} (x′) for the objective characteristic. Furthermore, the weight distribution W_{dy,dx;xdx} (x′_{dx}) is indicated by weight distribution data 213 described above.

$$\begin{matrix}[ Math . 7 ] & \\ {W}_{dy ; x} ( {x}^{′} ) = {\prod }_{{d}_{x} = 1}^{{D}_{x}} {W}_{dy , dx ; {x}_{dx}} ( {{x}^{′}}_{dx} ) & ( Formula 5 )\end{matrix}$$

Here, Dₓ represents the number of dimensions of the control factor, and x′_{dx} represents a dx-th component of x of the Dₓ-dimensional vector. Alternatively, the weight distribution W_{dy;x} (x′) may be directly defined by weight distribution data 213.

The weight distribution indicated by weight distribution data 213 includes a distribution depending on a level space, a distribution depending on time, and a distribution depending on time and space. In the present exemplary embodiment, a weight distribution depending on the level space is used.

### [Weight Distribution Depending on Level Space]

The weight distribution depending on the level space will be specifically described below.

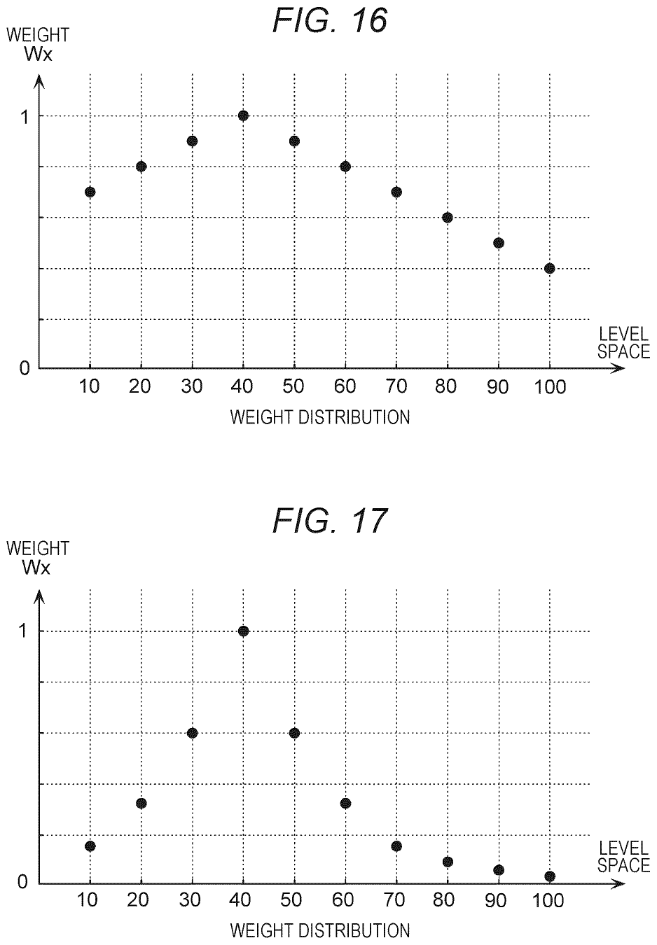

FIGS. 16 to 19 are diagrams illustrating examples of the weight distribution depending on the level space. Note that each of FIGS. 16 to 19 illustrates a graph, and the graph has a horizontal axis indicating the level space and a vertical axis indicating weight Wx.

For example, as considered from the fact that the difficulty level of temperature control of a material continuously changes with temperature, in general, as the comparison objective level, which is the level of comparison, is closer to an attention level, which is the level of interest, the error variance at the comparison objective level is similar to the error variance at the attention level. Conversely, as the comparison objective level is farther from the attention level, the error variance at the attention level is often not useful as a reference for the error variance at the comparison objective level.

In a case where such a situation is assumed, a weight that takes the maximum value at the attention level and decreases as the distance from the attention level increases in the level space may be set as the weight included in (Formula 4) or (Formula 5) above. Note that the weight included in the above (Formula 4) or (Formula 5) may be simplified as weight Wx.

More specifically, weight Wx may be set to a maximum value “1” with respect to a certain level (i.e., attention level) of a certain control factor, and may be set to decrease as the distance from the level increases in the level space. At this time, the lower limit value of weight Wx is 0. Note that when the minimum value is a negative value, an offset may be added to all the weights so that the minimum value becomes 0, and when the maximum value is larger than 1, all weights Wx may be adjusted to a value of 0 to 1 by dividing all the weights by the maximum value.

For example, in the weight distribution illustrated in FIG. 16, weight Wx becomes the maximum value “1” at the attention level “40”, and decreases linearly as the distance from the attention level “40” increases in the level space. Furthermore, as in the weight distribution illustrated in FIG. 17, weight Wx may decrease exponentially. Here, weight Wx represents a reference degree of data at a level corresponding to weight Wx. Therefore, in the weight distribution illustrated in FIG. 17, the level at which the tendency of error variance σ² is similar to the attention level is closer to the attention level in the level space than in the weight distribution illustrated in FIG. 16. That is, the weight distribution illustrated in FIG. 17 indicates that the degree of reference to a level closer to the attention level is large. In addition, in a situation where the change in the level space of error variance σ² is severe, a weight distribution indicating weight Wx that rapidly decreases according to the increase or decrease of the level may be set. Conversely, in a situation where there is little change in the level space of error variance σ², a weight distribution indicating weight Wx that gradually decreases according to the increase or decrease of the level may be set. In addition, weight Wx does not need to monotonically decrease as the distance from the reference level increases in the level space.

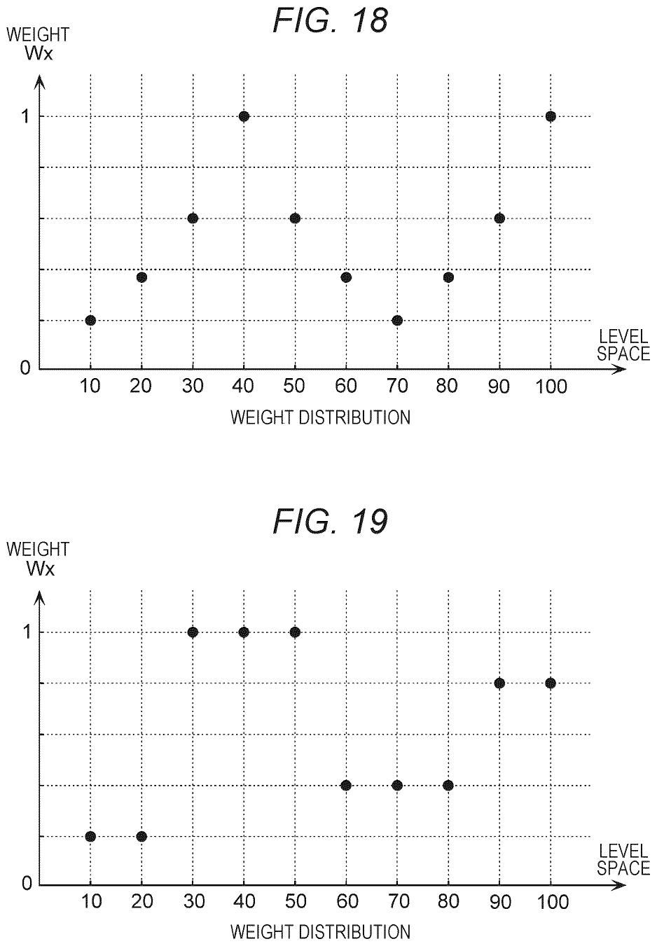

For example, as in the weight distribution illustrated in FIG. 18, weight Wx may periodically change according to the increase and decrease of the level. That is, in a case where the similar tendency of error variance σ² changes periodically on the level space and the cycle is known to some extent, as illustrated in FIG. 18, weight Wx may be applied in accordance with the cycle. Furthermore, as in the weight distribution illustrated in FIG. 19, weight Wx may be set to a constant value in each section in the level space. That is, in a case where the similar tendency of error variance σ² discontinuously changes on the level space and the change point is known to some extent, as illustrated in FIG. 19, weight Wx may be applied according to a section set by the change point.

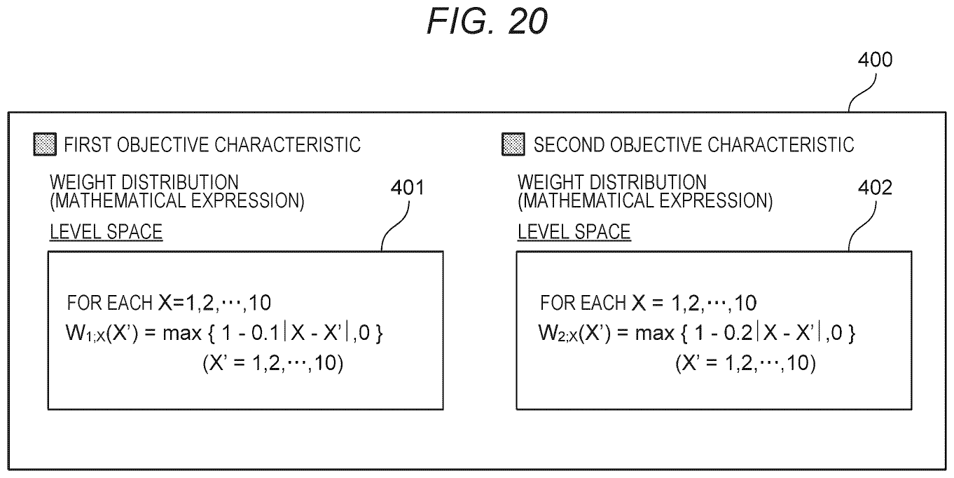

FIG. 20 is a diagram illustrating an example of a second reception image displayed on display 104 to receive an input of weight distribution data 213.

For example, arithmetic circuit 102 displays second reception image 400 illustrated in FIG. 20 on display 104.

Second reception image 400 includes first weight distribution setting region 401 and second weight distribution setting region 402. First weight distribution setting region 401 is a region for receiving the weight distribution for the first objective characteristic as a mathematical expression. For example, the user operates input unit 101a to write the weight distribution in first weight distribution setting region 401. As a result, reception controller 10 of arithmetic circuit 102 acquires weight distribution data 213 indicating the weight distribution written with respect to the first objective characteristic.

For example, the weight distribution is expressed as W_{1;x} (X)=max {1−0.1|X−X′|, 0} for each of X=1, 2 . . . , 10. Note that X is the attention level. X′ is a level corresponding to the above-described comparison objective level, and is expressed as X′=1, 2 . . . 10.

In addition, second weight distribution setting region 402 is a region for receiving the weight distribution for the second objective characteristic as a mathematical expression. For example, the user operates input unit 101a to write the weight distribution in second weight distribution setting region 402. As a result, reception controller 10 of arithmetic circuit 102 acquires weight distribution data 213 indicating the weight distribution written with respect to the second objective characteristic.

For example, the weight distribution is expressed as W_{2;x} (X′)=max {1−0.2|X−X′|, 0} for each of X=1, 2, . . . , 10. Note that X is the attention level as in the aforementioned case. X′ is a level corresponding to the above-described comparison objective level, and is expressed as X′=1, 2, . . . , 10.

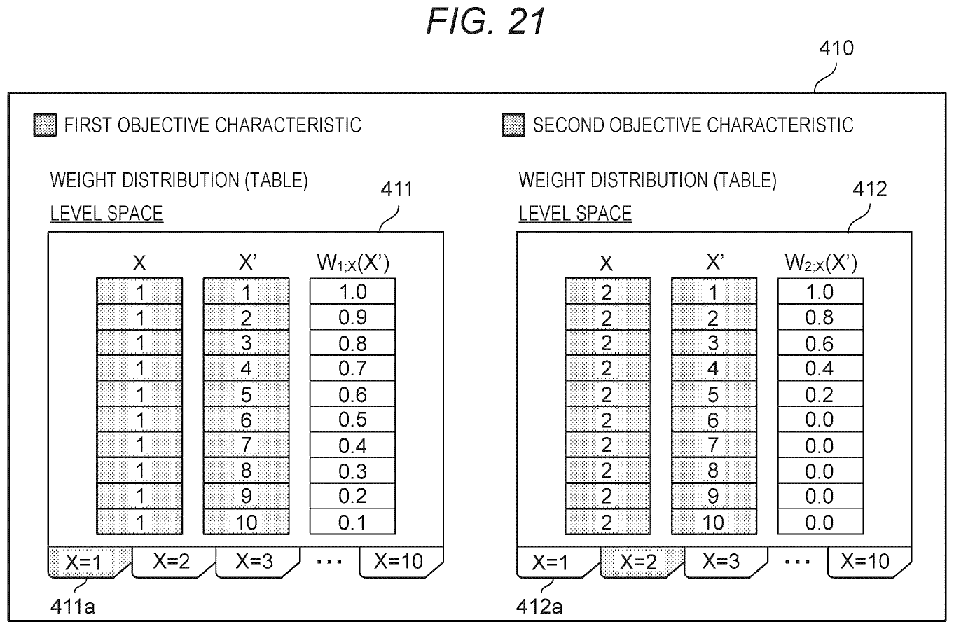

FIG. 21 is a diagram illustrating another example of the second reception image displayed on display 104 to receive an input of weight distribution data 213.

For example, arithmetic circuit 102 displays second reception image 410 illustrated in FIG. 21 on display 104.

Second reception image 410 is a tabular reception image and includes first weight distribution setting region 411 and second weight distribution setting region 412. First weight distribution setting region 411 is a region for receiving, for each combination of attention level X and level X′ for the first objective characteristic, weight Wx for the combination as W_{1;x} (X′). For example, the user operates input unit 101a to write weight Wx for each of the combinations as W_{1;x} (X′).

Specifically, arithmetic circuit 102 derives a combination of attention level X and each level X′ for each attention level X based on control factor data 211 or candidate experimental point data 221, and displays the combination in first weight distribution setting region 411. Note that when tab 411a of first weight distribution setting region 411 is selected according to an input operation of the user to input unit 101a, the combination of attention level X and each level X′ associated with tab 411 a is displayed in first weight distribution setting region 411. Then, the user operates input unit 101a to write weight W_{1;x} (X′) for each of the combinations. As a result, reception controller 10 of arithmetic circuit 102 acquires weight distribution data 213 indicating the weight distribution including a plurality of weights W_{1;x} (X′) written with respect to the first objective characteristic.

Second weight distribution setting region 412 is a region for receiving, for each combination of attention level X and level X′ for the second objective characteristic, weight Wx for the combination as weight W_{2;x} (X′). For example, the user operates input unit 101a to write weight Wx for each of the combinations as weight W_{2;x} (X′). Similarly to first weight distribution setting region 411, while selecting tab 412a of second weight distribution setting region 412, the user writes weight W_{2;x} (X′) for the combination. As a result, reception controller 10 of arithmetic circuit 102 acquires weight distribution data 213 indicating the weight distribution including a plurality of weights W_{2;x} (X′) written with respect to the second objective characteristic.

Hereinafter, an example of processing for searching for an optimal solution of the objective characteristic while estimating error variance σ² depending on the level space will be described as an example. Example 1 is an example of a case including one each of the control factor and the objective characteristic, that is, the number of dimensions thereof is one. Example 2 is an example of a case including two each of the control factor and the objective characteristic, that is, the number of dimensions thereof is two. An example including three or more each of the control factor and the objective characteristic can be naturally applied from Example 2.

### Example 1 of First Exemplary Embodiment

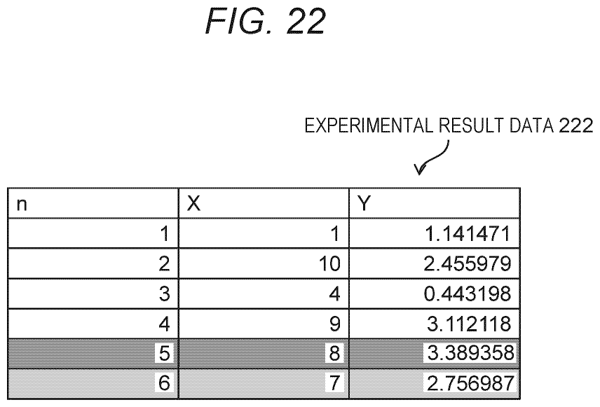

FIG. 22 is a diagram illustrating an example of experimental result data 222 in Example 1 of the present exemplary embodiment.

Experimental result data 222 indicates, for each experiment number n, an experimental point that is the level of the control factor used in the experiment identified by the experiment number n and an objective characteristic value obtained by the experiment. Note that the level of the control factor or experimental point is denoted as X, and the objective characteristic value is denoted as Y. Level X may take an integer of 1 to 10. The optimization objective of Y is, for example, maximization. Here, n is an integer of 1 or more.

For example, experimental result data 222 indicates that “1” was used as level X and “1.141471” was obtained as objective characteristic value Y in the experiment with the experiment number n=1. Furthermore, experimental result data 222 indicates that “10” was used as level X and “2.455979” was obtained as objective characteristic value Y in the experiment with the experiment number n=2.

Furthermore, the weight distribution is defined by, for example, W_{X} (X′)=max {1−0.1|X−X′|, 0}, (X=1, 2, . . . , 10, X′=1, 2, . . . , 10). Note that the weight distribution is received as weight distribution data 213 by second reception image 400 or 410. Note that X represents an attention level, and X′ represents a level.

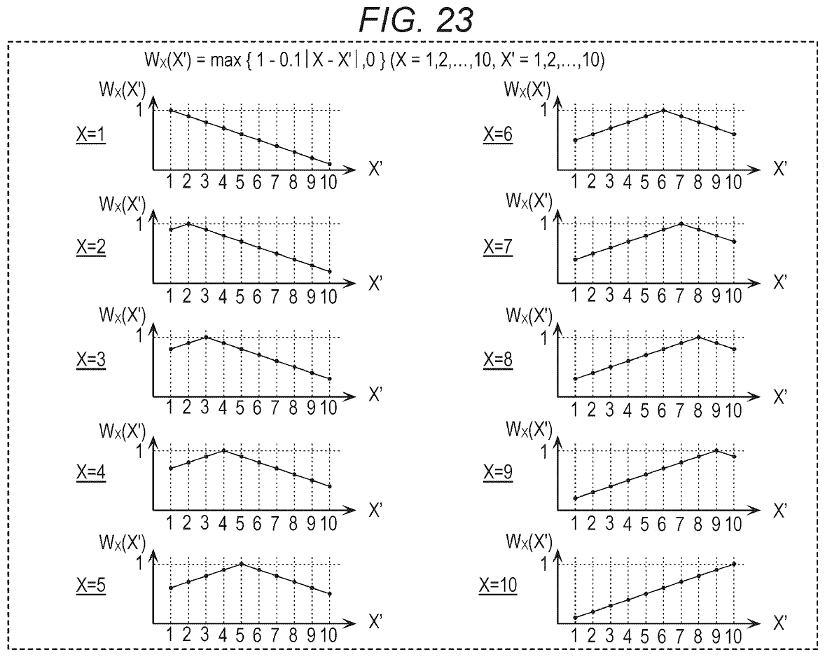

FIG. 23 is a diagram illustrating an example of a weight distribution indicated by weight distribution data 213.

As illustrated in FIG. 23, the weight distribution indicates weight W_{X} (X′) of each level X′ for each attention level X. Specifically, when level X′ is equal to attention level X, weight W_{X} (X′) for level X′ becomes the maximum value “1”. In addition, as level X′ is farther from attention level X in the level space, weight W_{X} (X′) for level X′ becomes smaller. That is, every time level X′ increases or decreases by “1” from attention level X, weight W_{X} (X′) for level X′ decreases by 0.1.

For example, in the case of the attention level X=1, weight W_{X} (X′) for level X′=1 is the maximum value “1”, and weight W_{X} (X′) for level X′=2 is “0.9” smaller than “1” by 0.1. In addition, weight W_{X} (X′) for level X′=3 is “0.8” smaller than “0.9” by 0.1. Similarly, in the case of the attention level X=2, weight W_{X} (X′) for level X′=2 is the maximum value “1”, and weight W_{X} (X′) for level X′=3 or level X′=1 is “0.9” smaller than “1” by 0.1. In addition, weight W_{X} (X′) for level X′=4 is “0.8” smaller than “0.9” by 0.1.

Note that in the weight distribution illustrated in FIG. 23, weight W_{X} (X′) is 0.1 or more. However, when level X′ is separated from attention level X and weight W_{X} (X′) for level X′ becomes 0 from 0.1, weight W_{X} (X′) for all levels X′ farther from attention level X than that level X′ also becomes 0.

Here, a flow of processing when searching for an optimal solution of an objective characteristic by sequentially repeating experiments according to experiment number n of experimental result data 222 illustrated in FIG. 22 will be described.

For example, it is assumed that at the present time, each experiment with the experiment number n=1 to 4 illustrated in FIG. 22 is performed, and the experimental results (i.e., objective characteristic values Y) have already been obtained by the experiments. In this case, evaluation device 100 estimates error variance σ² used for searching for the level of the control factor (i.e., experimental point) used in the experiment with the experiment number n=5 based on the experimental result of each experiment with the experiment number n=1 to 4. Note that error variance σ² is an error variance represented by (Formula 4).

Specifically, first, evaluation value calculator 12 derives weight Wx for level X′ used in each experiment with the experiment number n=1 to 4 for each candidate experimental point (i.e., attention level X) based on the weight distribution indicated by weight distribution data 213.

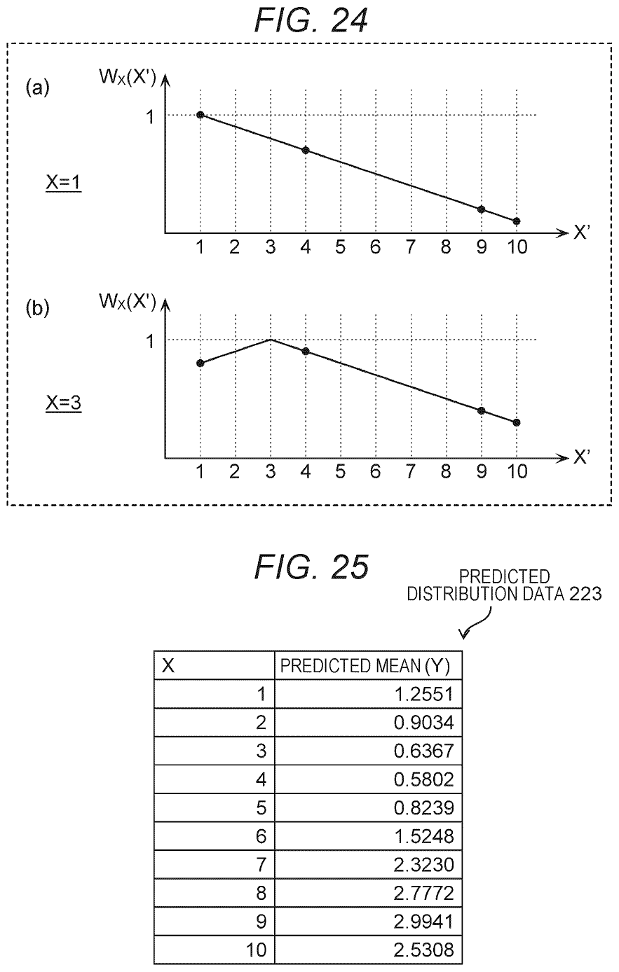

FIG. 24 is a diagram illustrating an example of weight distribution W_{X} (X′) and weight Wx for level X′ used in each experiment with the experiment number n=1 to 4 included in weight distribution W_{X} (X′). Note that part (a) of FIG. 24 illustrates weight distribution W_{X} (X′) for the candidate experimental point at which the attention level X=1 among all the candidate experimental points, and part (b) of FIG. 24 illustrates weight distribution W_{X} (X′) for the candidate experimental point at which the attention level X=3 among all the candidate experimental points.

Evaluation value calculator 12 derives weight Wx for level X′ used in each experiment with the experiment number n=1 to 4 at the attention level X=1 based on weight distribution W_{X} (X′) illustrated in part (a) of FIG. 24. Level X′ (i.e., corresponding to level X shown in FIG. 22) used in each experiment with the experiment number n=1 to 4 is “1, 10, 4, 9”. Therefore, evaluation value calculator 12 derives weights Wx=1.0, 0.1, 0.7, 0.2 for levels X′=1, 10, 4, 9, respectively.

In addition, evaluation value calculator 12 derives weight Wx for level X′ used in each experiment with the experiment number n=1 to 4 at the attention level X=3 based on weight distribution W_{X} (X′) illustrated in part (b) of FIG. 24. That is, evaluation value calculator 12 derives weights Wx=0.8, 0.3, 0.9, 0.4 for levels X′=1, 10, 4, 9, respectively.

FIG. 25 is a diagram illustrating an example of a predicted mean of each candidate experimental point.

When the experimental point (i.e., level X) used in the experiment with the experiment number n=4 is selected, evaluation value calculator 12 has already calculated the mean of the predicted distribution at each candidate experimental point based on (Formula 1) as illustrated in FIG. 25. Note that the mean of the predicted distribution is also referred to as a predicted mean. These predicted means are shown, for example, in predicted distribution data 223. Evaluation value calculator 12 calculates error variance σ² included in (Formula 1) and (Formula 2) using the predicted means as the above-described reference points. Note that the predicted mean illustrated in FIG. 25 is the mean of the predicted distribution before one iteration processing at experimental point x₍ₙ₎.

Specifically, evaluation value calculator 12 calculates error variance σ² for each of the attention level X=1 and the attention level X=3, for example, as in the following (Formula 6) based on (Formula 4). In other words, evaluation value calculator 12 calculates error variance σ² for each of the candidate experimental point of the attention level X=1 and the candidate experimental point of the attention level X=3.

$$\begin{matrix}[ Math . 8 ] & \\ {\hat{σ}}_{x}^{2} ( 1 ) = \frac{( 1 )}{{1.}^{2} + {0.1}^{2} + {0.7}^{2} + {0.2}^{2} \times \{ {1.}^{2} \cdot {( 1.141471 - 1.2551 )}^{2} + {0.1}^{2} \cdot {( 2.455979 - 2.5308 )}^{2} + {0.7}^{2} \cdot {( 0.443198 - 0.5802 )}^{2} + {0.2}^{2} \cdot {( 3.112118 - 2.9941 )}^{2} \} = 0.020181} & ( Formula 6 )\end{matrix}$$

$${\hat{σ}}_{x}^{2} ( 3 ) = \frac{1}{{0.8}^{2} + {0.3}^{2} + {0.9}^{2} + {0.4}^{2} \times \{ {0.8}^{2} \cdot {( 1.141471 - 1.2551 )}^{2} + {0.3}^{2} \cdot {( 2.455979 - 2.5308 )}^{2} + {0.9}^{2} \cdot {( 0.443198 - 0.5802 )}^{2} + {0.4}^{2} \cdot {( 3.112118 - 2.9941 )}^{2} \} = 0.015411}$$

Evaluation value calculator 12 also calculates error variance σ² for the other candidate experimental points except the candidate experimental point of the attention level X=1 and the candidate experimental point of the attention level X=3 in the same manner as described above. Then, evaluation value calculator 12 uses error variance σ² calculated for the candidate experimental points for (Formula 1) and (Formula 2) to calculate the mean and variance of the predicted distribution for each candidate experimental point that is a candidate for the experimental point used in the experiment with the experiment number n=5. That is, evaluation value calculator 12 updates predicted distribution data 223. Then, evaluation value calculator 12 calculates the evaluation value based on the EHVI of each candidate experimental point by applying the mean and variance of the predicted distribution indicated by predicted distribution data 223 to (Formula 3) described above. As a result, evaluation value calculator 12 updates evaluation value data 224.

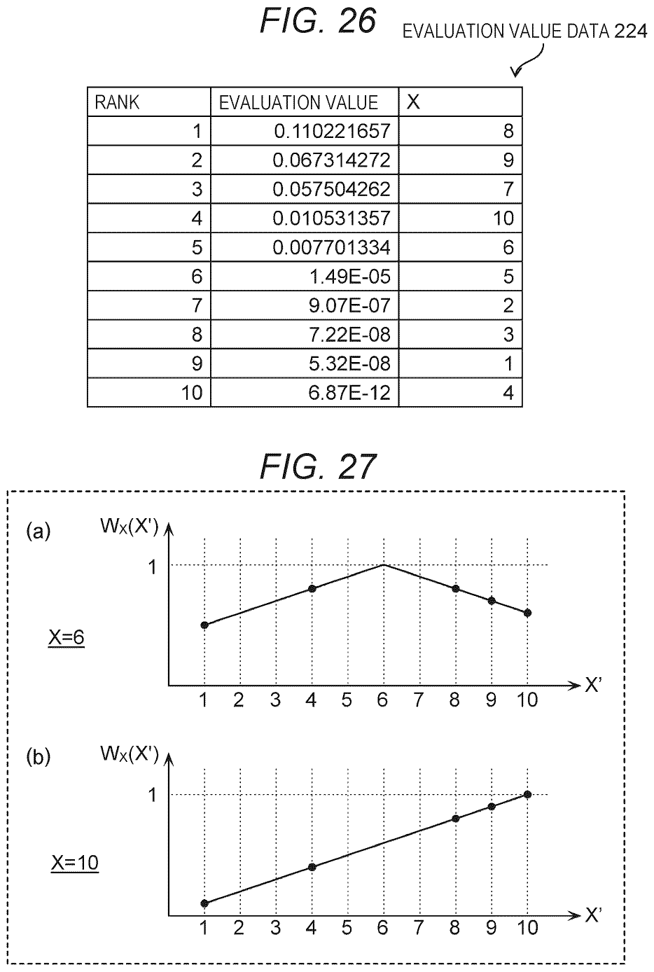

FIG. 26 is a diagram illustrating an example of evaluation value data 224.

Evaluation value data 224 illustrated in FIG. 26 shows evaluation values of the candidate experimental points arranged in descending order. Furthermore, evaluation value data 224 indicates, for each evaluation value, the level (i.e., level X) of the candidate experimental point corresponding to the evaluation value and a rank of the evaluation value. The rank is an integer of 1 or more, and a smaller rank indicates a larger evaluation value corresponding to the rank.

Arithmetic circuit 102 adopts the candidate experimental point of the level X=8 associated with the rank “1” indicated in evaluation value data 224, that is, the level X=8 associated with the maximum evaluation value as the experimental point used for the next experiment. The next experiment is the experiment identified by experiment number n=5. Then, arithmetic circuit 102 writes the level X=8 in experimental result data 222 illustrated in FIG. 22 in association with the experiment number n=5. When objective characteristic value Y “3.389358” that is the experimental result is obtained by the experiment with the experiment number n=5, arithmetic circuit 102 acquires characteristic point data 201 indicating objective characteristic value Y “3.389358” as the characteristic point, and writes objective characteristic value Y “3.389358” in experimental result data 222. That is, arithmetic circuit 102 writes objective characteristic value Y “3.389358” in experimental result data 222 illustrated in FIG. 22 in association with the experiment number n=5 and the level X=8. As a result, experimental result data 222 indicates level X used in each experiment with the experiment number n=1 to 5 and objective characteristic value Y obtained by these experiments.

Next, evaluation device 100 estimates error variance σ² used for searching for the level of the control factor (i.e., experimental point) used in the experiment with the experiment number n=6 based on the experimental result of each experiment with the experiment number n=1 to 5. The specific description is as follows:

FIG. 27 is a diagram illustrating an example of weight Wx for level X′ used in each experiment with the experiment number n=1 to 5. Note that part (a) of FIG. 27 illustrates weight distribution W_{X} (X′) for the candidate experimental point at which the attention level X=6 among all the candidate experimental points, and part (b) of FIG. 27 illustrates weight distribution W_{X} (X′) for the candidate experimental point at which the attention level X=10 among all the candidate experimental points.

Evaluation value calculator 12 derives weight Wx for level X′ used in each experiment with the experiment number n=1 to 5 at the attention level X=6 based on weight distribution W_{X} (X′) illustrated in part (a) of FIG. 27. Level X′ used in each experiment with the experiment number n=1 to 5 is “1, 10, 4, 9, 8”. Therefore, evaluation value calculator 12 derives weights W_{X} (X′)=0.5, 0.6, 0.8, 0.7, 0.8 for levels X′=1, 10, 4, 9, 8, respectively.

In addition, evaluation value calculator 12 derives weight Wx for level X′ used in each experiment with the experiment number n=1 to 5 at the attention level X=10 based on weight distribution W_{X} (X′) illustrated in part (b) of FIG. 27. That is, evaluation value calculator 12 derives weights W_{X} (X′)=0.1, 1.0, 0.4, 0.9, 0.8 for levels X′=1, 10, 4, 9, 8, respectively.

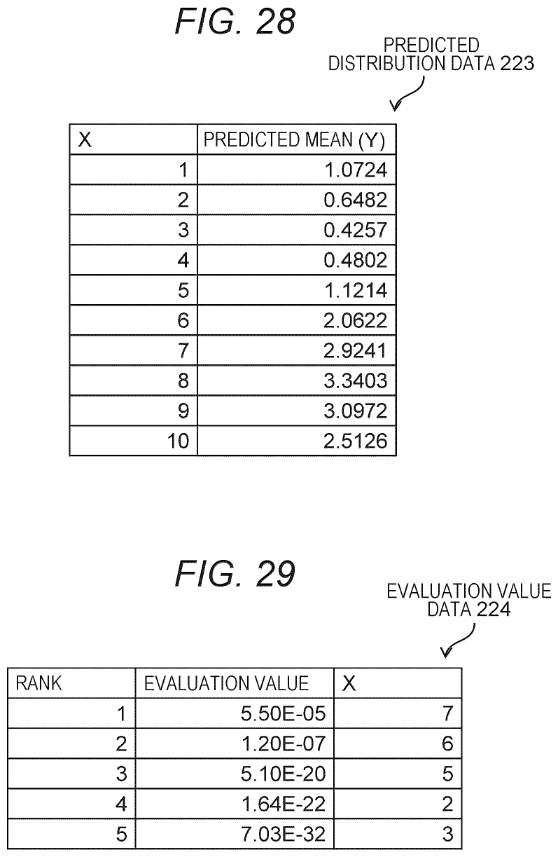

FIG. 28 is a diagram illustrating an example of a predicted mean of each candidate experimental point.

When the experimental point (i.e., level X) used in the experiment with the experiment number n=5 is selected, evaluation value calculator 12 has already calculated the predicted mean at each candidate experimental point based on (Formula 1) as illustrated in FIG. 28. These predicted means are shown, for example, in predicted distribution data 223. Evaluation value calculator 12 calculates error variance σ² included in (Formula 1) and (Formula 2) using the predicted means as the above-described reference points. Specifically, evaluation value calculator 12 calculates error variance σ² for each of the attention level X=6 and the attention level X=10, for example, as in the following (Formula 7) based on (Formula 4). In other words, evaluation value calculator 12 calculates error variance σ² for each of the candidate experimental point of the attention level X=6 and the candidate experimental point of the attention level X=10.

$$\begin{matrix}[ Math . 9 ] & \\ {\hat{σ}}_{x}^{2} ( 6 ) = \frac{1}{{0.5}^{2} + {0.6}^{2} + {0.8}^{2} + {0.7}^{2} + {0.8}^{2} \times \{ {0.5}^{2} \cdot {( 1.141471 - 1.0724 )}^{2} + {0.6}^{2} \cdot {( 2.455979 - 2.5126 )}^{2} + {0.8}^{2} \cdot {( 0.443198 - 0.4802 )}^{2} + {0.7}^{2} \cdot {( 3.112118 - 3.0972 )}^{2} + {0.8}^{2} \cdot {( 3.389358 - 3.3403 )}^{2} = 0.010765 \}} & ( Formula 7 )\end{matrix}$$

$${\hat{σ}}_{x}^{2} ( 10 ) = \frac{1}{{0.1}^{2} + {1.}^{2} + {0.4}^{2} + {0.9}^{2} + {0.8}^{2} \times \{ {0.1}^{2} \cdot {( 1.141471 - 1.0724 )}^{2} + {1.}^{2} \cdot {( 2.455979 - 2.5126 )}^{2} + {0.4}^{2} \cdot {( 0.443198 - 0.4802 )}^{2} + {0.9}^{2} \cdot {( 3.112118 - 3.0972 )}^{2} + {0.8}^{2} \cdot {( 3.389358 - 3.3403 )}^{2} = 0.008226 \}}$$

Evaluation value calculator 12 also calculates error variance σ² for the other candidate experimental points except the candidate experimental point of the attention level X=6 and the candidate experimental point of the attention level X=10 in the same manner as described above. Then, evaluation value calculator 12 uses error variance σ² calculated for the candidate experimental points for (Formula 1) and (Formula 2) to calculate the mean and variance of the predicted distribution for each candidate experimental point that is a candidate for the experimental point used in the experiment with the experiment number n=6. That is, evaluation value calculator 12 updates predicted distribution data 223. Then, evaluation value calculator 12 calculates the evaluation value based on the EHVI of each candidate experimental point by applying the mean and variance of the predicted distribution indicated by predicted distribution data 223 to (Formula 3) described above. As a result, evaluation value calculator 12 updates evaluation value data 224.

FIG. 29 is a diagram illustrating an example of evaluation value data 224.

As in the example of FIG. 26, evaluation value data 224 illustrated in FIG. 29 shows evaluation values of the candidate experimental points arranged in descending order. Furthermore, evaluation value data 224 indicates, for each evaluation value, the level (i.e., level X) of the candidate experimental point corresponding to the evaluation value and a rank of the evaluation value.

Arithmetic circuit 102 adopts the candidate experimental point of the level X=7 associated with the rank “1” indicated in evaluation value data 224, that is, the level X=7 associated with the maximum evaluation value as the experimental point used for the next experiment. The next experiment is the experiment identified by experiment number n=6. Then, arithmetic circuit 102 writes the level X=7 in experimental result data 222 illustrated in FIG. 22 in association with the experiment number n=6. When objective characteristic value Y “2.756987” that is the experimental result is obtained by the experiment with the experiment number n=6, arithmetic circuit 102 acquires characteristic point data 201 indicating objective characteristic value Y “2.756987” as the characteristic point, and writes objective characteristic value Y “2.756987” in experimental result data 222. That is, arithmetic circuit 102 writes objective characteristic value Y “2.756987” in experimental result data 222 illustrated in FIG. 22 in association with the experiment number n=6 and the level X=7. As a result, experimental result data 222 indicates level X used in each experiment with the experiment number n=1 to 6 and objective characteristic value Y obtained by these experiments.

By repeating the processing as described above, every time experiment number n is incremented, evaluation device 100 writes level X′ and objective characteristic value Y in experimental result data 222 in association with experiment number n. As a result, it is possible to perform an advanced optimization search in consideration of error variance σ² depending on the level space.

### Example 2 of First Exemplary Embodiment

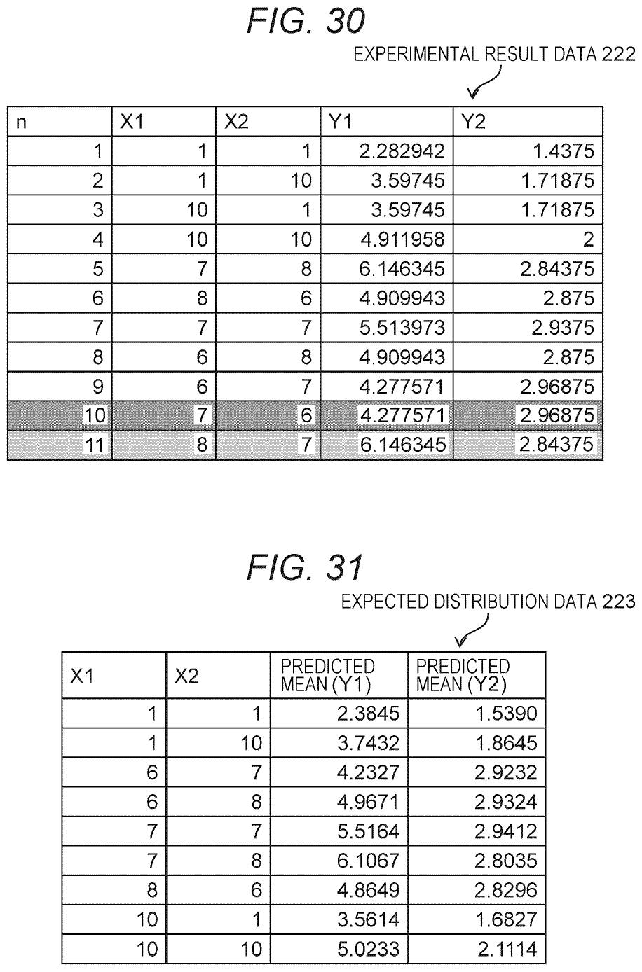

FIG. 30 is a diagram illustrating an example of experimental result data 222 in Example 2 of the present exemplary embodiment.

experimental result data 222 indicates, for each experiment number n, experimental points used in the experiment identified by the experiment number n and characteristic points obtained by the experiment. Note that in Example 2, the experimental point is expressed by level X1 of the first control factor and level X2 of the second control factor, and the characteristic point is expressed by objective characteristic value Y1 of the first objective characteristic and objective characteristic value Y2 of the second objective characteristic. That is, in Example 2, the number of dimensions of the control factor is two, and the number of dimensions of the objective characteristic is also two. Level X1 and level X2 may each take an integer of 1 to 10. The optimization objective of each of objective characteristic value Y1 and objective characteristic value Y2 is, for example, maximization.

For example, experimental result data 222 illustrated in FIG. 30 indicates that in the experiment with the experiment number n=1, “1” and “1” were used as level X1 and level X2, respectively, and “2.282942” and “1.4375” were obtained as objective characteristic value Y1 and objective characteristic value Y2, respectively. Furthermore, experimental result data 222 indicates that in the experiment with the experiment number n=2, “1” and “10” were used as level X1 and level X2, respectively, and “3.59745” and “1.71875” were obtained as objective characteristic value Y1 and objective characteristic value Y2, respectively.

Furthermore, the weight distribution for each dimension of the objective characteristic is defined by, for example, the following (Formula 8) and (Formula 9). Note that these weight distributions are received as weight distribution data 213 by second reception image 400 or 410, for example.

$$\begin{matrix}[ Math . 10 ] & \\ {W}_{1 ; X} ( {X}^{′} ) = {\prod }_{{d}_{x} = 1}^{2} {W}_{1 , dx ; {X}_{dx}} ( {{X}^{′}}_{dx} ) = {\prod }_{{d}_{x} = 1}^{2} max \{ 1 - 0.1 \vert {X}_{dx} - {{X}^{′}}_{dx} \vert , 0 \} & ( Formula 8 )\end{matrix}$$

$${W}_{2 ; X} ( {X}^{′} ) = \frac{1}{{L}_{1} ( X , {X}^{′} ) + 1} \qquad ( Formula 9 )$$

Here, (Formula 8) is a specific example of (Formula 5), and indicates the weight distribution of the first objective characteristic, and (Formula 9) indicates the weight distribution of the second objective characteristic. A subscript “1” for W in (Formula 8) indicates that the weight distribution corresponds to the first objective characteristic, and a subscript “2” for W in (Formula 9) indicates that the weight distribution corresponds to the second objective characteristic. The weight included in the weight distribution indicated by (Formula 8) is expressed as a product of the weights included in the weight distribution defined for each of the two-dimensional control factors. On the other hand, the weight distribution indicated by (Formula 9) is directly defined for the second objective characteristic without defining the weight distribution for each of the two-dimensional control factors. For example, L1(X, X′) in (Formula 9) represents the L1 norm.

The L1 norm is an example of the Lp distance, and the Lp distance is expressed as, for example, the following (Formula 10).

$$\begin{matrix}[ Math . 11 ] & \\ Lp ( X , {X}^{′} ) = \{ \begin{matrix}= \sqrt[p]{{\sum }_{dx = 1}^{Dx} {\vert {X}_{dx} - {{X}^{′}}_{dx} \vert}^{p}} & ( p > 0 ) \\ = Number of non - zero elements of ( x - {x}^{′} ) & ( p = 0 )\end{matrix} & ( Formula 10 )\end{matrix}$$

In (Formula 10), when p=2, Lp(X, X′) indicates a Euclidean distance (i.e., a straight line distance), and when p=1, Lp(X, X′) indicates a Manhattan distance (i.e., a road distance). Furthermore, when p=0, Lp(X, X′) indicates the number of different level factors, and when p=∞, Lp(X, X′) indicates the maximum level difference.

Here, a flow of processing when searching for an optimal solution of an objective characteristic by sequentially repeating experiments according to experiment number n of experimental result data 222 illustrated in FIG. 30 will be described.

For example, it is assumed that at the present time, each experiment with the experiment number n=1 to 9 illustrated in FIG. 30 is performed, and the experimental results (i.e., objective characteristic values Y1 and Y2) have already been obtained by the experiments. In this case, evaluation device 100 estimates error variance σ² used for searching for the level of the control factor (i.e., experimental point) used in the experiment with the experiment number n=10 based on the experimental result of each experiment with the experiment number n=1 to 9. Note that error variance σ² is an error variance represented by (Formula 4).

Specifically, first, evaluation value calculator 12 calculates the weight for each experimental point of the experiment number n=1 to 9 based on the weight distribution for the first objective characteristic indicated by (Formula 8) and the weight distribution for the second objective characteristic indicated by (Formula 9). For example, as weight W_{1;X} for each experimental point in candidate experimental point (X1, X2)=(1, 1), which is a weight for the first objective characteristic, evaluation value calculator 12 calculates “1.0, 0.1, 0.1, 0.01, 0.12, 0.15, 0.16, 0.15, 0.2” based on (Formula 8). In addition, for example, as weight W_{2;X} for each experimental point in candidate experimental point (X1, X2)=(1, 1), which is a weight for the second objective characteristic, evaluation value calculator 12 calculates “1.0, 0.1, 0.1, 0.05263, 0.07143, 0.07692, 0.07692, 0.07692, 0.08333” based on (Formula 9).

FIG. 31 is a diagram illustrating an example of a predicted mean of each candidate experimental point.

When the experimental point (i.e., level X1 and level X2) used in the experiment with the experiment number n=9 is selected, evaluation value calculator 12 has already calculated the predicted mean at each candidate experimental point based on (Formula 1) as illustrated in FIG. 31. Note that in FIG. 31, the predicted mean at each candidate experimental point treated as the experimental point with the experiment number n=1 to 9 among all the candidate experimental points is shown. These predicted means are shown, for example, in predicted distribution data 223. Evaluation value calculator 12 calculates error variance σ² included in (Formula 1) and (Formula 2) using the predicted means as the above-described reference points. Note that the predicted mean illustrated in FIG. 31 is the mean of the predicted distribution before one iteration processing at experimental point x₍ₙ₎.

Specifically, evaluation value calculator 12 calculates error variance σ² of each of the first objective characteristic and the second objective characteristic for the candidate experimental point expressed by, for example, a set of attention levels (X1, X2)=(1, 1) as in the following (Formula 11a) and (Formula 11b) based on (Formula 4). Note that (Formula 11a) represents error variance σ² of the first objective characteristic, and (Formula 11b) represents error variance σ² of the second objective characteristic.

$$\begin{matrix}[ Math . 12 ] & \\ {\hat{σ}}_{1 ; X}^{2} ( 1 , 1 ) = \frac{1}{{1.}^{2} + {0.1}^{2} + {0.1}^{2} + {0.01}^{2} + {0.12}^{2} + {0.15}^{2} + {0.16}^{2} + {0.15}^{2} + {0.2}^{2} \times \{ {1.}^{2} \cdot {( 2.282942 - 2.3845 )}^{2} + {0.1}^{2} \cdot {( 3.59745 - 3.7432 )}^{2} + {0.1}^{2} {( 3.59745 - 3.5614 )}^{2} + {0.01}^{2} \cdot {( 4911958 - 5.0233 )}^{2} + {0.12}^{2} \cdot {( 6.146345 - 6.1067 )}^{2} + {0.15}^{2} \cdot {( 4.909943 - 4.8649 )}^{2} + {0.16}^{2} \cdot {( 5.513973 - 5.5164 )}^{2} + {0.15}^{2} \cdot {( 4.909943 - 4.9671 )}^{2} + {0.2}^{2} \cdot {( 4.277571 - 4.2327 )}^{2} \} = 0.007987} & ( Formula 11 a )\end{matrix}$$

$${\hat{σ}}_{2 ; X}^{2} ( 1 , 1 ) = \frac{1}{{1.}^{2} + {0.1}^{2} + {0.1}^{2} + {0.05263}^{2} + {0.07692}^{2} + {0.07692}^{2} + {0.07692}^{2} + {0.07692}^{2} + {0.08333}^{2} \times \{ {1.}^{2} \cdot {( 1.4375 - 1.539 )}^{2} + {0.1}^{2} \cdot {( 1.71875 - 1.8645 )}^{2} + {0.1}^{2} \cdot {( 1.71875 - 1.6827 )}^{2} + {0.05263}^{2} \cdot {( 2 - 2.1114 )}^{2} + {0.07143}^{2} \cdot {( 2.84375 - 2.8035 )}^{2} + {0.07692}^{2} \cdot {( 2.875 - 2.8296 )}^{2} + {0.07692}^{2} \cdot {( 2.9375 - 2.9412 )}^{2} + {0.07692}^{2} \cdot {( 2.875 - 2.9324 )}^{2} + {0.08333}^{2} \cdot {( 2.96875 - 2.9232 )}^{2} \} = 0.01009} \qquad ( Formula 11 b )$$

Evaluation value calculator 12 also calculates error variance σ² for the other candidate experimental points except the candidate experimental point of the attention level set (X1, X2)=(1, 1) in the same manner as described above. Then, evaluation value calculator 12 uses error variance σ² calculated for the candidate experimental points for (Formula 1) and (Formula 2) to calculate the mean and variance of the predicted distribution for each candidate experimental point that is a candidate for the experimental point used in the experiment with the experiment number n=10 for each dimension of the objective characteristic. That is, evaluation value calculator 12 updates predicted distribution data 223. Then, evaluation value calculator 12 calculates the evaluation value based on the EHVI of each candidate experimental point by applying the mean and variance of the predicted distribution indicated by predicted distribution data 223 to (Formula 3) described above. As a result, evaluation value calculator 12 updates evaluation value data 224.

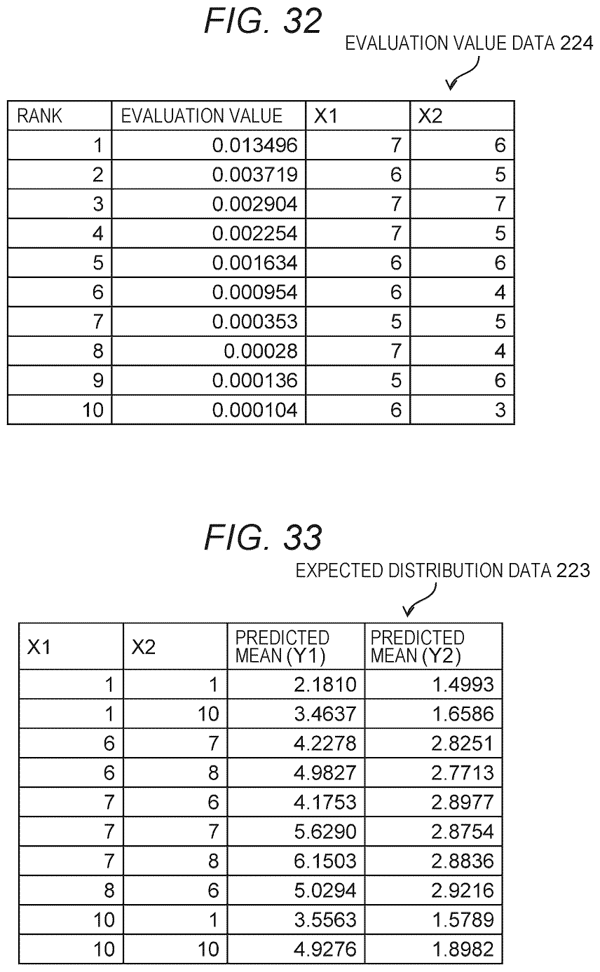

FIG. 32 is a diagram illustrating an example of evaluation value data 224.

Evaluation value data 224 illustrated in FIG. 32 shows evaluation values of the candidate experimental points arranged in descending order. Furthermore, evaluation value data 224 indicates, for each evaluation value, the level (i.e., levels X1 and X2) of the candidate experimental point corresponding to the evaluation value and a rank of the evaluation value.

Arithmetic circuit 102 adopts the candidate experimental point of the set of levels (X1, X2)=(7, 6) associated with the rank “1” indicated in evaluation value data 224, that is, the set of levels (X1, X2)=(7, 6) associated with the maximum evaluation value as the experimental point used for the next experiment. The next experiment is the experiment identified by experiment number n=10. Then, arithmetic circuit 102 writes the set of levels (X1, X2)=(7, 6) in experimental result data 222 illustrated in FIG. 30 in association with the experiment number n=10. When a set of objective characteristic values (Y1, Y2)=(4.277571, 2.96875) that is the experimental result is obtained by the experiment with the experiment number n=10, arithmetic circuit 102 acquires characteristic point data 201 indicating the set of objective characteristic values (Y1, Y2)=(4.277571, 2.96875) as the characteristic point. Then, arithmetic circuit 102 writes the set of objective characteristic values (Y1, Y2)=(4.277571, 2.96875) in experimental result data 222. That is, arithmetic circuit 102 writes the set of objective characteristic values (Y1, Y2)=(4.277571, 2.96875) in experimental result data 222 illustrated in FIG. 30 in association with the experiment number n=10 and the set of levels (X1, X2)=(7,6). As a result, experimental result data 222 indicates the set of levels (X1, X2) used in each experiment of the experiment number n=1 to 10 and the set of objective characteristic values (Y1, Y2) obtained by these experiments.

Next, evaluation device 100 estimates error variance σ² used for searching for the level of the control factor (i.e., experimental point) used in the experiment with the experiment number n=11 based on the experimental result of each experiment with the experiment number n=1 to 10. The specific description is as follows:

First, evaluation value calculator 12 calculates the weight for each experimental point of the experiment number n=1 to 10 based on the weight distribution for the first objective characteristic indicated by (Formula 8) and the weight distribution for the second objective characteristic indicated by (Formula 9). For example, as weight W_{1;X} for each experimental point in candidate experimental point (X1, X2)=(5, 8), which is a weight for the first objective characteristic, evaluation value calculator 12 calculates “0.18, 0.48, 0.15, 0.4, 0.8, 0.56, 0.72, 0.9, 0.81, 0.64” based on (Formula 8). In addition, as weight W_{2;X} for each experimental point in candidate experimental point (X1, X2)=(5, 8), which is a weight for the second objective characteristic, evaluation value calculator 12 calculates “0.08333, 0.14286, 0.76923, 0.125, 0.33333, 0.16667, 0.25, 0.5, 0.33333, 0.2” based on (Formula 9).

FIG. 33 is a diagram illustrating an example of a predicted mean of each candidate experimental point.

When the experimental point (i.e., level X1 and level X2) used in the experiment with the experiment number n=10 is selected, evaluation value calculator 12 has already calculated the predicted mean at each candidate experimental point based on (Formula 1) as illustrated in FIG. 33. Note that in FIG. 33, the predicted mean at each candidate experimental point treated as the experimental point with the experiment number n=1 to 10 among all the candidate experimental points is shown. These predicted means are shown, for example, in predicted distribution data 223. Evaluation value calculator 12 calculates error variance σ² included in (Formula 1) and (Formula 2) using the predicted means as the above-described reference points.

Specifically, evaluation value calculator 12 calculates error variance σ² of each of the first objective characteristic and the second objective characteristic for the candidate experimental point expressed by, for example, a set of attention levels (X1, X2)=(5, 8) as in the following (Formula 12a) and (Formula 12b) based on (Formula 4). Note that (Formula 12a) represents error variance σ² of the first objective characteristic, and (Formula 12b) represents error variance σ² of the second objective characteristic.

$$\begin{matrix}[ Math . 13 ] & \\ {\hat{σ}}_{1 ; X}^{2} ( 5 , 8 ) = \frac{1}{{0.18}^{2} + {0.48}^{2} + {0.15}^{2} + {0.4}^{2} + {0.8}^{2} + {0.56}^{2} + {0.72}^{2} + {0.9}^{2} + {0.81}^{2} + {0.64}^{2} \times \{ {0.18}^{2} \cdot {( 2.282942 - 2.181 )}^{2} + {0.48}^{2} \cdot {( 3.59745 - 3.4637 )}^{2} + {0.15}^{2} \cdot {( 3.59745 - 3.5563 )}^{2} + {0.4}^{2} \cdot {( 4.911958 - 4.9276 )}^{2} + {0.8}^{2} \cdot {( 6.146345 - 6.1503 )}^{2} + {0.56}^{2} \cdot {( 4.909943 - 4.9827 )}^{2} + {0.81}^{2} \cdot {( 4.277571 - 4.2278 )}^{2} + {0.64}^{2} \cdot {( 4.277571 - 4.1753 )}^{2} \} = 0.00687} & ( Formula 12 a )\end{matrix}$$

$${\hat{σ}}_{2 ; X}^{2} ( 5 , 8 ) = \frac{1}{{0.08333}^{2} + {0.14286}^{2} + {0.76923}^{2} + {0.125}^{2} + {0.33333}^{2} + {0.16667}^{2} + {0.25}^{2} + {0.5}^{2} + {0.33333}^{2} + {0.2}^{2} \times \{ {0.8333}^{2} \cdot {( 1.4375 - 1.4993 )}^{2} + {0.14286}^{2} \cdot {( 1.71875 - 1.6586 )}^{2} + {0.76923}^{2} \cdot {( 1.71875 - 1.5789 )}^{2} + {0.125}^{2} \cdot {( 2 - 1.8982 )}^{2} + {0.33333}^{2} \cdot {( 2.84375 - 2.8836 )}^{2} + {0.16667}^{2} \cdot {( 2.875 - 2.9216 )}^{2} + {0.25}^{2} \cdot {( 2.9375 - 2.8754 )}^{2} + {0.5}^{2} \cdot {( 2.875 - 2.7713 )}^{2} + {0.33333}^{2} \cdot {( 2.96875 - 2.8251 )}^{2} + {0.2}^{2} \cdot {( 2.96875 - 2.8977 )}^{2} \} = 0.1021} \qquad ( Formula 12 b )$$

Evaluation value calculator 12 also calculates error variance σ² for the other candidate experimental points except the candidate experimental point of the attention level set (X1, X2)=(5, 8) in the same manner as described above. Then, evaluation value calculator 12 uses error variance σ² calculated for the candidate experimental points for (Formula 1) and (Formula 2) to calculate the mean and variance of the predicted distribution for each candidate experimental point that is a candidate for the experimental point used in the experiment with the experiment number n=11 for each dimension of the objective characteristic. That is, evaluation value calculator 12 updates predicted distribution data 223. Then, evaluation value calculator 12 calculates the evaluation value based on the EHVI of each candidate experimental point by applying the mean and variance of the predicted distribution indicated by predicted distribution data 223 to (Formula 3) described above. As a result, evaluation value calculator 12 updates evaluation value data 224.

FIG. 34 is a diagram illustrating an example of evaluation value data 224.

Evaluation value data 224 illustrated in FIG. 34 shows evaluation values of the candidate experimental points arranged in descending order. Furthermore, evaluation value data 224 indicates, for each evaluation value, the level (i.e., levels X1 and X2) of the candidate experimental point corresponding to the evaluation value and a rank of the evaluation value.

Arithmetic circuit 102 adopts the candidate experimental point of the set of levels (X1, X2)=(8, 7) associated with the rank “1” indicated in evaluation value data 224, that is, the candidate experimental point (X1, X2)=(8, 7) associated with the maximum evaluation value as the experimental point used for the next experiment. The next experiment is the experiment identified by experiment number n=11. Then, arithmetic circuit 102 writes the set of levels (X1, X2)=(8, 7) in experimental result data 222 illustrated in FIG. 30 in association with the experiment number n=11. When a set of objective characteristic values (Y1, Y2)=(6.146345, 2.84375) that is the experimental result is obtained by the experiment with the experiment number n=11, arithmetic circuit 102 acquires characteristic point data 201 indicating the set of objective characteristic values (Y1, Y2)=(6.146345, 2.84375) as the characteristic point. Then, arithmetic circuit 102 writes the set of objective characteristic values (Y1, Y2)=(6.146345, 2.84375) in experimental result data 222. That is, arithmetic circuit 102 writes the set of objective characteristic values (Y1, Y2)=(6.146345, 2.84375) in experimental result data 222 illustrated in FIG. 30 in association with the experiment number n=11 and the set of levels (X1, X2)=(8, 7). As a result, experimental result data 222 indicates the set of levels (X1, X2) used in each experiment of the experiment number n=1 to 11 and the set of objective characteristic values (Y1, Y2) obtained by these experiments.

By repeating the processing as described above, every time experiment number n is incremented, evaluation device 100 writes the set of levels (X1, X2) and the set of objective characteristic values (Y1, Y2) in experimental result data 222 in association with experiment number n. As a result, it is possible to perform an advanced optimization search in consideration of error variance σ² depending on the level space.

As described above, in the present exemplary embodiment, error variance σ² that changes depending on the level space is estimated, and the experimental condition is evaluated by Bayesian optimization using error variance σ². Therefore, even in an environment where error variance σ² changes, the experimental conditions can be quantitatively evaluated with high accuracy. That is, conventionally, a quantitative determination method for error variance σ² is not shown, and a fixed value such as “1” is generally used for error variance σ². Therefore, error variance σ² is universally handled, and there is a possibility that the actual phenomenon is not fully reflected in error variance σ². However, in the present exemplary embodiment, since a plurality of non-universal error variances σ² different from each other are estimated in the level space and used for Bayesian optimization, highly accurate evaluation can be performed. As a result, in the present exemplary embodiment, it is possible to provide evaluation device 100 to which the Bayesian optimization capable of quantitatively responding to a change is applied while estimating error variance σ².

### (Summary of First Exemplary Embodiment)

As described above, evaluation device 100 according to the present exemplary embodiment is a device that evaluates one or more unknown characteristic points corresponding to one or more candidate experimental points by Bayesian optimization based on known characteristic points corresponding to experimented experimental points. Such evaluation device 100 includes a first reception means that acquires experimental result data 222 indicating experimented experimental points and known characteristic points, and a second reception means that acquires, in a case where each of the one or more unknown characteristic points and the known characteristic points is expressed by one or more values of objective characteristics, objective data 212 indicating an optimization objective of each of the one or more objective characteristics. The first reception means and the second reception means are included in reception controller 10 in FIG. 4. In addition, evaluation device 100 includes a calculation means that estimates a plurality of error variances σ² that are variances of observation errors of characteristic points and are different from each other, and calculates evaluation values of one or more unknown characteristic points based on experimental result data 222, objective data 212, and the plurality of error variances σ², and an output means that outputs the evaluation values. The calculation means and the output means correspond to evaluation value calculator 12 and evaluation value output unit 13 in FIG. 4, respectively.

As a result, each of the one or more candidate experimental points is evaluated by the evaluation value as the experimental condition using the plurality of error variances σ² different from each other. Therefore, it is possible to increase the possibility of bringing the plurality of error variances σ² close to the variance of the observation error according to the actual experiment. As a result, the experimental conditions can be evaluated with high accuracy.

In addition, the calculation means in the present exemplary embodiment estimates a plurality of error variances σ² different from each other for a plurality of candidate experimental points.

As a result, it is possible to increase the possibility that appropriate error variance σ² according to the candidate experimental point can be used for each of the plurality of candidate experimental points. Therefore, the experimental conditions can be evaluated with higher accuracy than the case of using the same error variance σ² for a plurality of candidate experimental points.

In addition, the calculation means in the present exemplary embodiment calculates a predicted distribution for each of the plurality of candidate experimental points by using error variance σ² corresponding to each of the plurality of candidate experimental points among the plurality of error variances σ² for the Gaussian process regression, and calculates evaluation values of the plurality of unknown characteristic points by using the calculated predicted distribution.

As a result, since error variance σ² corresponding to the candidate experimental point is used for the Gaussian process regression, the accuracy of the predicted distribution of the candidate experimental point can be improved. Therefore, the experimental conditions can be evaluated with higher accuracy.

In addition, the calculation means in the present exemplary embodiment acquires a weight distribution defined depending on a space in which one or more candidate experimental points and experimented experimental points are arranged, and when each of the plurality of error variances σ² is estimated, error variance σ² is estimated based on weight Wx associated with the position of the experimental point in a space among the plurality of weights Wx indicated by the weight distribution. The space is the above-described level space, and weight distributions illustrated in, for example, FIGS. 23, 24, 27, and the like are acquired.

As a result, in the weight distribution, weight Wx associated with the experimented experimental point can be used as a reference degree for the observation error of the known characteristic point obtained by the experiment using the experimented experimental point. Therefore, error variance σ² for the candidate experimental point can be estimated by using only weight Wx of such an observation error. That is, error variance σ² for the candidate experimental point can be estimated using the known characteristic point. As a result, the experimental conditions can be evaluated effectively with high accuracy.

Furthermore, in the present exemplary embodiment, as illustrated in FIGS. 16 and 17, for example, the weight indicated by the weight distribution is smaller as the position associated with the weight in the level space is farther from the position of any one candidate experimental point of interest among the one or more candidate experimental points.

As a result, when an unknown characteristic point corresponding to a candidate experimental point of interest is evaluated, small weight Wx is used for an experimented experimental point that is distant in the level space from the candidate experimental point of interest, and large weight Wx is used for an experimented experimental point that is close to the candidate experimental point of interest. For example, a temperature is used as an experimental point, and an experiment involving adjustment of the temperature is performed. In such a case, the smaller the difference between the two temperatures, that is, the closer the two temperatures are, the more similar the error variance σ² for those temperatures is, and the larger the difference between the two temperatures, that is, the farther the two temperatures are, the less similar the error variance σ² for those temperatures is. Therefore, in the examples of FIGS. 16 and 17, when the evaluation value is calculated for the temperature of interest, the degree of reference to the observation error obtained by the experiment using the temperature distant from the temperature of interest can be lowered so as to follow the similar tendency of the actual error variance σ² described above. As a result, the experimental conditions can be evaluated appropriately with high accuracy.

Furthermore, in the present exemplary embodiment, weight Wx indicated by the weight distribution linearly decreases as the position associated with weight Wx in the level space is farther from the position of the candidate experimental point of interest, for example, as illustrated in FIG. 16.

As a result, when the similar tendency of the actual error variance σ² linearly changes according to the position or distance in the level space, the experimental conditions can be evaluated with higher accuracy.

Furthermore, in the present exemplary embodiment, weight Wx indicated by the weight distribution decreases exponentially as the position associated with weight Wx in the level space is farther from the position of the candidate experimental point of interest, for example, as illustrated in FIG. 17.

As a result, when the similar tendency of the actual error variance σ² changes exponentially according to the position or distance in the level space, the experimental conditions can be evaluated with higher accuracy.

Furthermore, in the present exemplary embodiment, weight Wx indicated by the weight distribution periodically increases or decreases according to the position associated with weight Wx in the level space, for example, as illustrated in FIG. 18.

As a result, when the similar tendency of the actual error variance σ² changes periodically according to the position or distance in the level space, the experimental conditions can be evaluated with higher accuracy.

Furthermore, in the present exemplary embodiment, weight Wx indicated by the weight distribution is set for each section in the level space, for example, as illustrated in FIG. 19.

As a result, when the similar tendency of the actual error variance σ² differs for each section in the level space, the experimental conditions can be evaluated with higher accuracy.

In addition, in the present exemplary embodiment, when each of the experimented experimental point and the one or more candidate experimental points is expressed by the level of two or more control factors, the calculation means acquires a weight distribution for the control factor of each of the two or more control factors as the weight distribution. Then, when estimating each of the plurality of error variances σ², the calculation means estimates error variance σ² based on the product of weights Wx associated with the positions in the level space of the experimented experimental points in each of the two or more control factor weight distributions. For example, a weight distribution for the first control factor and a weight distribution for the second control factor are acquired. Then, the product of weights Wx is calculated as in (Formula 5) and (Formula 8). For example, the product of weight Wx of the first control factor and weight Wx of the second control factor is used to estimate error variance σ².

As a result, in a case where each of the experimented experimental points and the one or more candidate experimental points is expressed by the level of two or more control factors, that is, in a case where each of the experimented experimental points and the one or more candidate experimental points is expressed by two-dimensional or more control factors, error variance σ² is estimated based on the product of weights Wx. Therefore, even in such a case, the experimental conditions can be evaluated with high accuracy.

In addition, in the present exemplary embodiment, when each of the unknown one or more characteristic points and the known characteristic point is expressed by two or more objective characteristic values, the calculation means estimates error variance σ² for each of the two or more objective characteristics by using the objective characteristic value of the known characteristic point.

As a result, even when each of the unknown one or more characteristic points and the known characteristic point is expressed by two or more objective characteristic values, that is, even when each of the unknown one or more characteristic points and the known characteristic point is expressed by two-dimensional or more objective characteristic values, error variance σ² is estimated for each objective characteristic. Therefore, even in such a case, the experimental conditions can be evaluated with high accuracy.

### Second Exemplary Embodiment

Evaluation device 100 according to the first exemplary embodiment estimates error variance σ² using the weight distribution depending on the level space. On the other hand, evaluation device 100 according to the present exemplary embodiment estimates error variance σ² using the weight distribution depending on time. Then, evaluation device 100 calculates a predicted distribution of each candidate experimental point using error variance σ². Note that in the present exemplary embodiment, the processing of estimating error variance σ² is different from that in the first exemplary embodiment, and the rest of the processing is performed in the same manner as in the first exemplary embodiment. Note that, constituent elements of the present exemplary embodiment identical to constituent elements of the first exemplary embodiment are denoted by numerals or symbols identical to numerals or symbols used in the first exemplary embodiment, and detailed descriptions of the constituent elements are omitted.

Specifically, evaluation device 100 according to the present exemplary embodiment calculates the mean and variance of the predicted distribution according to the following (Formula 1-1) and (Formula 2-1).

$$\begin{matrix}[ Math . 14 ] & \\ \hat{m} ( {x}_{( N + 1 )} ) = m ( {x}_{( N + 1 )} ) + {( {k}_{N + 1} )}^{T} {( {K}_{N , N} + {\hat{σ}}_{x}^{2} ( {t}_{N + 1} ) I )}^{- 1} ( {y}^{N} - m ( {x}^{N} ) ) \hat{v} ( {x}_{( N + 1 )} , {x}_{( N + 1 )} ) & ( Formula 1 - 1 )\end{matrix}$$

$$= k ( {x}_{( N + 1 )} , {x}_{( N + 1 )} ) - {( {k}_{N + 1} )}^{T} {( {K}_{N , N} + {\hat{σ}}_{t}^{2} ( {t}_{N + 1} ) I )}^{- 1} {k}_{N + 1} + {\hat{σ}}_{t}^{2} ( {t}_{N + 1} ) \qquad ( Formula 2 - 1 )$$

In (Formula 1-1) and (Formula 2-1),

$${\hat{σ}}_{t}^{2} ( {t}_{N + 1} ) \qquad [ Math . 15 ]$$

the above represents error variance σ² based on the observation error in the present exemplary embodiment. Error variance σ² is estimated using a weight distribution depending on time indicated by weight distribution data 213. Note that in (Formula 1-1) and (Formula 2-1), error variance σ² is different from (Formula 1) and (Formula 2) of the first exemplary embodiment, and variables and the like other than error variance σ² are the same as (Formula 1) and (Formula 2).

### [Weight Distribution Depending on Time]

The weight distribution depending on time will be specifically described below.

Weight distribution data 213 in the present exemplary embodiment is data indicating a weight as a reference degree for each past time as a weight distribution.

Error variance σ² included in (Formula 1-1) and (Formula 2-1) described above in the present exemplary embodiment depends on time and is an amount efficiently estimated from a small number of experimental results. Such error variance σ² is calculated or estimated by the following (Formula 13).

$$\begin{matrix}[ Math . 16 ] & \\ {\hat{σ}}_{t}^{2} ( {t}_{N + 1} ) = \frac{{\sum }_{n = 1}^{N} {\{ {W}_{t} ( {t}_{n} ) ( {y}_{( n )} - {\overline{y}}_{( n )} ) \}}^{2}}{{\sum }_{n = 1}^{N} {W}_{t}^{2} ( {t}_{n} )} & ( Formula 13 )\end{matrix}$$

Here, Wₜ (tₙ) is a weight distribution determined by the user, and represents a weight at time tₙ at which a past experiment was performed. The weight distribution is indicated by weight distribution data 213 described above.

$$\begin{matrix}[ Math . 17 ] & \\ {\overline{y}}_{( n )} & \end{matrix}$$

Similarly to (Formula 4), the above is a reference point (or representative point) set by the user. In addition, (Formula 13) is a mathematical expression when the dimension of the objective characteristic is 1. When there are a plurality of dimensions of the objective characteristic, error variance σ² is estimated for each dimension. In this case, a value corresponding to the dimension of each objective characteristic is used for y(n) and Wₜ (tₙ). As a result, (Formula 13) can be naturally applied to multi-dimensions.

In a case where all the weights are 1 and the reference point is the sample mean, (Formula 13) corresponds to a commonly used formula of sample variance. Therefore, (Formula 13) can be interpreted as an extension of the general sample variance.

For example, as can be considered from the fact that the degree of wear of an experimental instrument continuously changes with the lapse of time, in general, as the time is closer to the current time, the error variance at that time is similar to the error variance at the current time. Conversely, as the time is farther from the current time in terms of time, the error variance at the current time is often not useful as the error variance at that time.

In a case where such a situation is assumed, a weight that takes the maximum value at the current time and decreases as going back to the past from the current time, that is, as being temporally away from the current time may be set as the weight included in (Formula 13) above. Note that the weight included in the above (Formula 13) may be simplified as weight Wt below.

More specifically, weight Wt may be set to be the maximum value “1” at the current time and decrease as the temporal distance from the current time increases. At this time, the lower limit value of weight Wt is 0. Note that when the minimum value is a negative value, an offset may be added to all the weights so that the minimum value becomes 0), and when the maximum value is larger than 1, all weights Wt may be adjusted to a value of 0 to 1 by dividing all the weights by the maximum value.

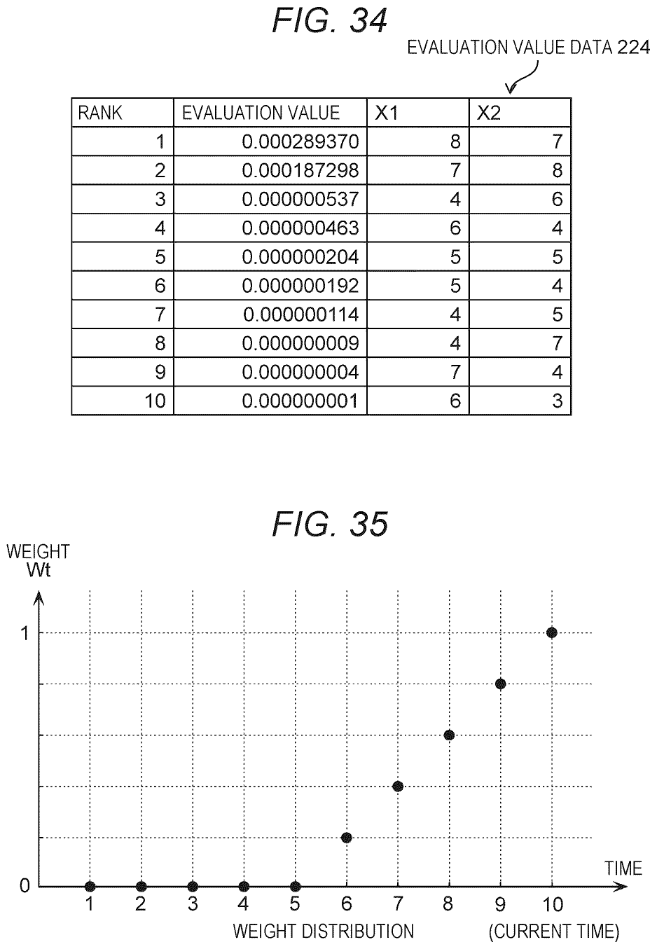

FIGS. 35 to 38 are diagrams illustrating an example of the weight distribution depending on time. Note that each of FIGS. 35 to 38 illustrates a graph, and the graph has a horizontal axis indicating time and a vertical axis indicating weight Wt.

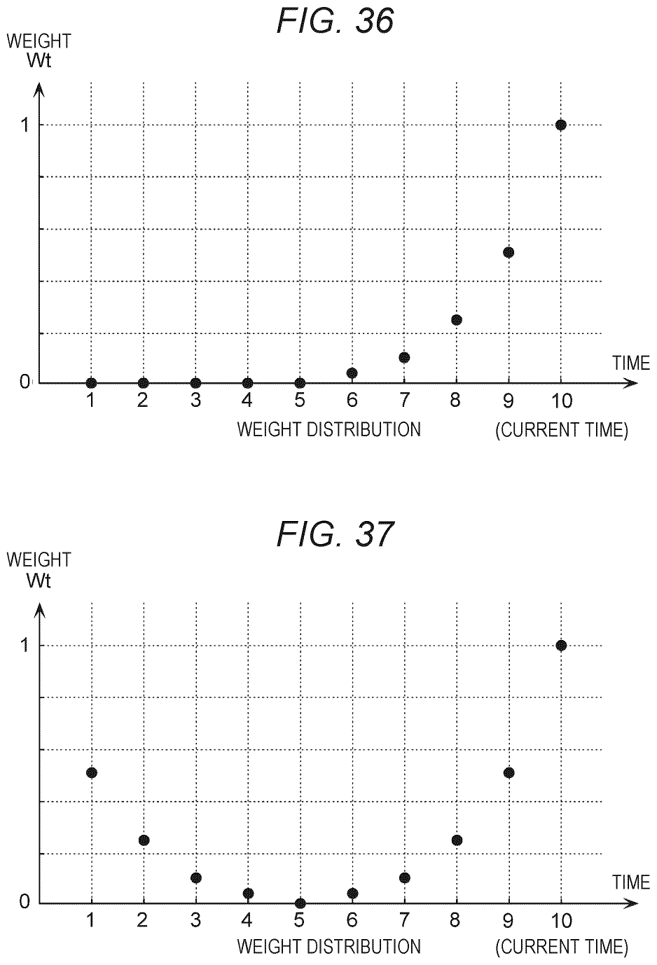

For example, in the weight distribution illustrated in FIG. 35, weight Wt becomes the maximum value “1” at the current time “10”, and decreases linearly as the temporal distance from the current time increases, that is, as going back to the past. Furthermore, as in the weight distribution illustrated in FIG. 36, weight Wt may decrease exponentially. Here, weight Wt represents a reference degree of data at a time corresponding to weight Wt. Therefore, in the weight distribution illustrated in FIG. 36, the time at which the tendency of error variance σ² is similar to the current time is temporally closer to the current time than in the weight distribution illustrated in FIG. 35. That is, the weight distribution illustrated in FIG. 36 indicates that the degree of reference to a time closer to the current time is large. In addition, in a situation where the temporal change of error variance σ² is severe, a weight distribution indicating weight Wt that rapidly decreases as going back to the past may be set. Conversely, in a situation where there is little temporal change in error variance σ², a weight distribution indicating weight Wt that gradually decreases as going back to the past may be set. Furthermore, the weight Wt does not need to monotonically decrease as going back from the current time.

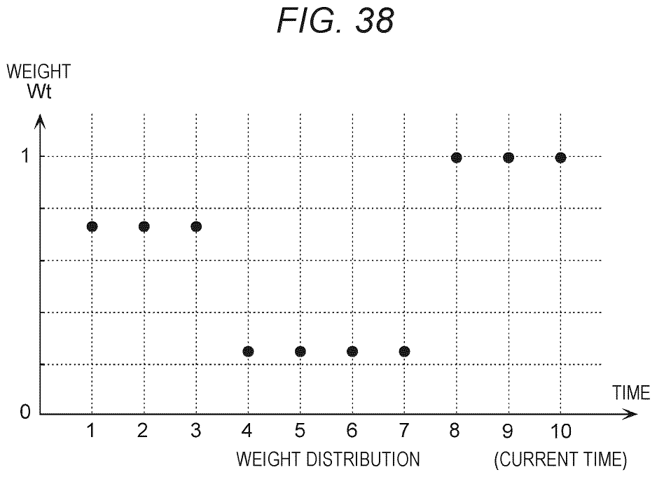

For example, as in the weight distribution illustrated in FIG. 37, weight Wt may periodically change as going back to the past. For example, the similar tendency of error variance σ² may be affected by a change in temperature in the morning and night, and may change periodically. That is, in a case where the similar tendency of error variance σ² changes periodically and the cycle is known to some extent, as illustrated in FIG. 37, weight Wt may be applied in accordance with the cycle. Furthermore, as in the weight distribution illustrated in FIG. 38, weight Wt may be set to a constant value in each temporal section. For example, the similar tendency of error variance σ² may be affected by the change of the worker, and may change for each temporal section. That is, in a case where the similar tendency of error variance σ² changes discontinuously with time and the change point is known to some extent, as illustrated in FIG. 38, weight Wt may be applied according to a section set by the change point.

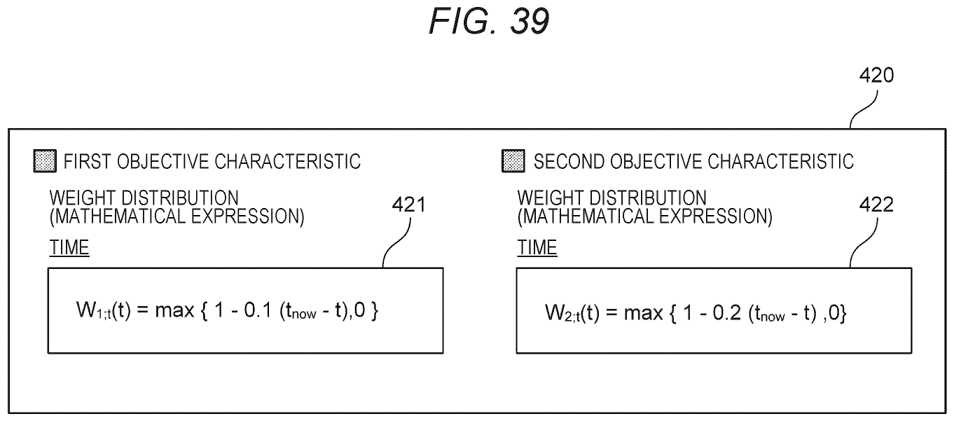

FIG. 39 is a diagram illustrating an example of a second reception image displayed on display 104 to receive an input of weight distribution data 213.

For example, arithmetic circuit 102 displays second reception image 420 illustrated in FIG. 39 on display 104.

Second reception image 420 includes first weight distribution setting region 421 and second weight distribution setting region 422. First weight distribution setting region 421 is a region for receiving the weight distribution for the first objective characteristic as a mathematical expression. For example, the user operates input unit 101a to write the weight distribution in first weight distribution setting region 421. As a result, reception controller 10 of arithmetic circuit 102 acquires weight distribution data 213 indicating the weight distribution written with respect to the first objective characteristic.

For example, the weight distribution may be expressed as W_{1;t} (t)=max {1−0.1|t_{now}−t|, 0}. Note that t is time, and t_{now} is the current time at which the experiment is performed.

In addition, second weight distribution setting region 422 is a region for receiving the weight distribution for the second objective characteristic as a mathematical expression. For example, the user operates input unit 101a to write the weight distribution in second weight distribution setting region 422. As a result, reception controller 10 of arithmetic circuit 102 acquires weight distribution data 213 indicating the weight distribution written with respect to the second objective characteristic.

For example, the weight distribution may be expressed as W_{2;t} (t)=max {1−0.2|t_{now}−t|, 0}. Note that, similarly to the above description, t is the time, and t_{now} is the current time at which the experiment is performed.

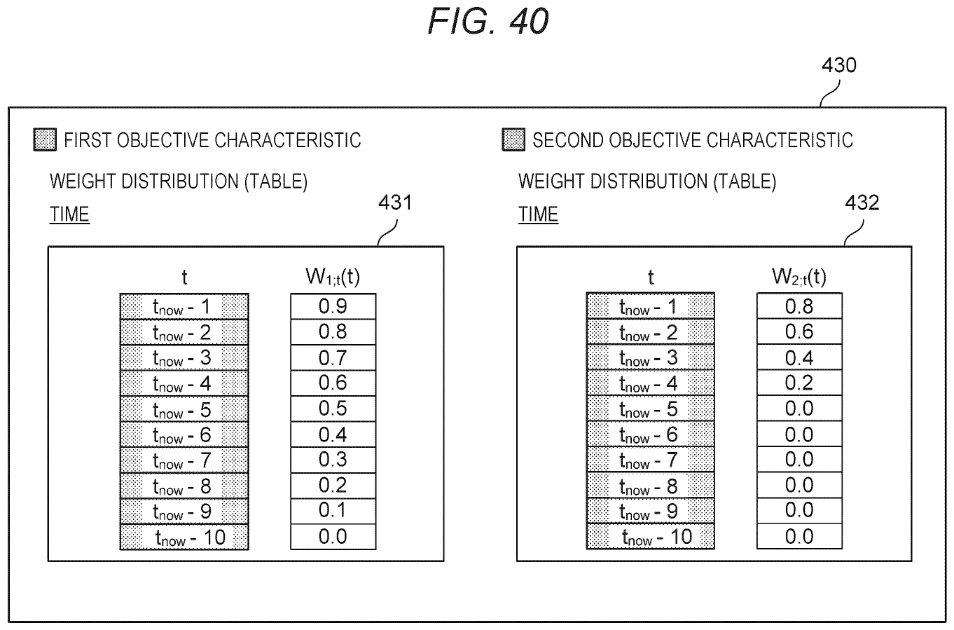

FIG. 40 is a diagram illustrating another example of the second reception image displayed on display 104 to receive an input of weight distribution data 213.

For example, arithmetic circuit 102 displays second reception image 430 illustrated in FIG. 40 on display 104.

Second reception image 430 is a tabular reception image and includes first weight distribution setting region 431 and second weight distribution setting region 432. First weight distribution setting region 431 is a region for receiving, for each time t for the first objective characteristic, weight Wt for the time t as W_{1;t} (t). Note that time t is expressed using current time t_{now} as a reference, such as “t_{now}−1”, “t_{now}−2”, and “t_{now}−3”. For example, the user operates input unit 101a to write weight W_{1;t} (t) for each of times t. As a result, reception controller 10 of arithmetic circuit 102 acquires weight distribution data 213 indicating the weight distribution including a plurality of weights W_{1;t} (t) written with respect to the first objective characteristic.

Second weight distribution setting region 432 is a region for receiving, for each time t for the second objective characteristic, weight Wt for the time t as W_{2;t} (t). For example, the user operates input unit 101a to write weight W_{2;t} (t) for each of times t. As a result, reception controller 10 of arithmetic circuit 102 acquires weight distribution data 213 indicating the weight distribution including a plurality of weights W_{2;t} (t) written with respect to the second objective characteristic.

Hereinafter, an example of processing for searching for an optimal solution of the objective characteristic while estimating error variance σ² depending on time will be described as an example. Example 1 is an example of a case including one each of the control factor and the objective characteristic, that is, the number of dimensions thereof is one. Example 2 is an example of a case including two each of the control factor and the objective characteristic, that is, the number of dimensions thereof is two. An example including three or more each of the control factor and the objective characteristic can be naturally applied from Example 2.

### Example 1 of Second Exemplary Embodiment

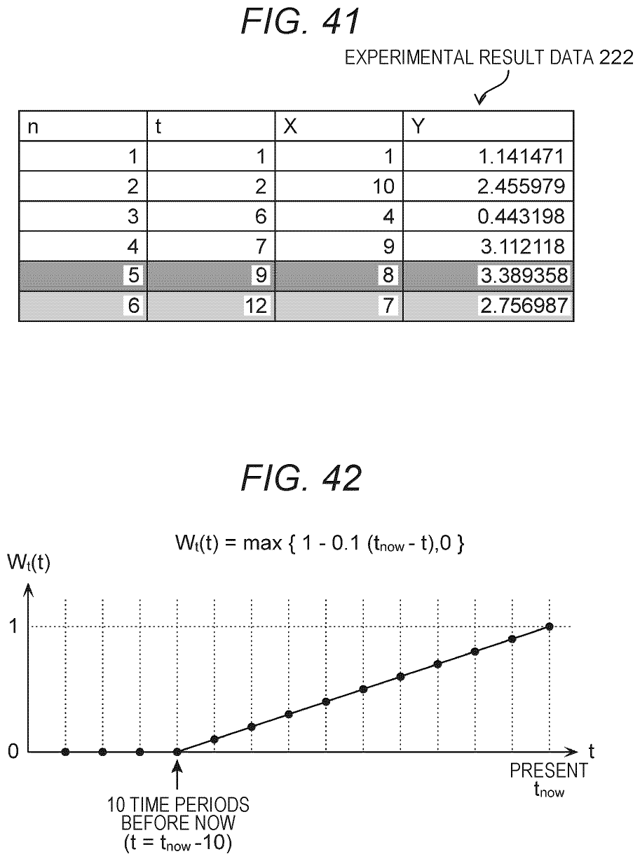

FIG. 41 is a diagram illustrating an example of experimental result data 222 in Example 1 of the present exemplary embodiment.

Experimental result data 222 indicates, for each experiment number n, time t at which the experiment identified by experimental number n was performed, an experimental point that is the level of the control factor used in the experiment, and an objective characteristic value obtained by the experiment. Note that the level of the control factor or experimental point is denoted as X, and the objective characteristic value is denoted as Y. Level X may take an integer of 1 to 10. The optimization objective of Y is, for example, maximization. Here, n is an integer of 1 or more.

For example, experimental result data 222 indicates that the experiment with the experiment number n=1 was performed at time t=1, “1” was used as level X in the experiment, and “1.141471” was obtained as objective characteristic value Y. Furthermore, experimental result data 222 indicates that the experiment with the experiment number n=2 was performed at time t=2, “10” was used as level X in the experiment, and “2.455979” was obtained as objective characteristic value Y.

In addition, the weight distribution may be defined by, for example, Wₜ (t)=max {1−0.1|t_{now}−t|, 0}. Moreover, the weight distribution is received as weight distribution data 213 by second reception image 420 or 430.

FIG. 42 is a diagram illustrating an example of a weight distribution indicated by weight distribution data 213.

In the weight distribution defined by Wₜ (t)=max {1−0.1|t_{now}−t|, 0} described above, when time t is current time t_{now}, weight Wt for time t becomes the maximum value “1”. Furthermore, as time t goes back to the past from current time t_{now}, weight Wt for time t decreases. That is, every time time t decreases from current time t_{now} by “1”, weight Wt for time t decreases by 0.1.

For example, when time t=t_{now}, weight Wt for time t becomes the maximum value “1”, and when time t=(t_{now}−1), weight Wt for time t becomes “0.9” smaller than “1” by 0.1. Furthermore, when time t=(t_{now}−2), weight Wt for time t becomes “0.8” even smaller than “0.9” by 0.1. Then, when time t=(t_{now}−10), weight Wt for time t becomes “0”. Then, at all times t before (t_{now}−10), that is, when the time t is smaller than (t_{now}−10), weight Wt for time t is “0”.

Here, a flow of processing when searching for an optimal solution of an objective characteristic by sequentially repeating experiments according to experiment number n of experimental result data 222 illustrated in FIG. 41 will be described.

For example, it is assumed that at the present time, each experiment with the experiment number n=1 to 4 illustrated in FIG. 41 is performed, and the experimental results (i.e., objective characteristic values Y) have already been obtained by the experiments. That is, the experiment with the experiment number n=1 is performed at time t=1, the experiment with the experiment number n=2 is performed at time t=2, the experiment with the experiment number n=3 is performed at time t=6, and the experiment with the experiment number n=4 is performed at time t=7. In this case, evaluation device 100 estimates error variance σ² used for searching for the level of the control factor (i.e., experimental point) used in the experiment with the experiment number n=5 based on the experimental result of each experiment with the experiment number n=1 to 4. Note that error variance σ² is an error variance represented by (Formula 13). The experiment with the experiment number n=5 is performed at time t=9.

Specifically, first, evaluation value calculator 12 derives weight Wt for time t at which each experiment with the experiment number n=1 to 4 was performed based on the weight distribution indicated by weight distribution data 213.

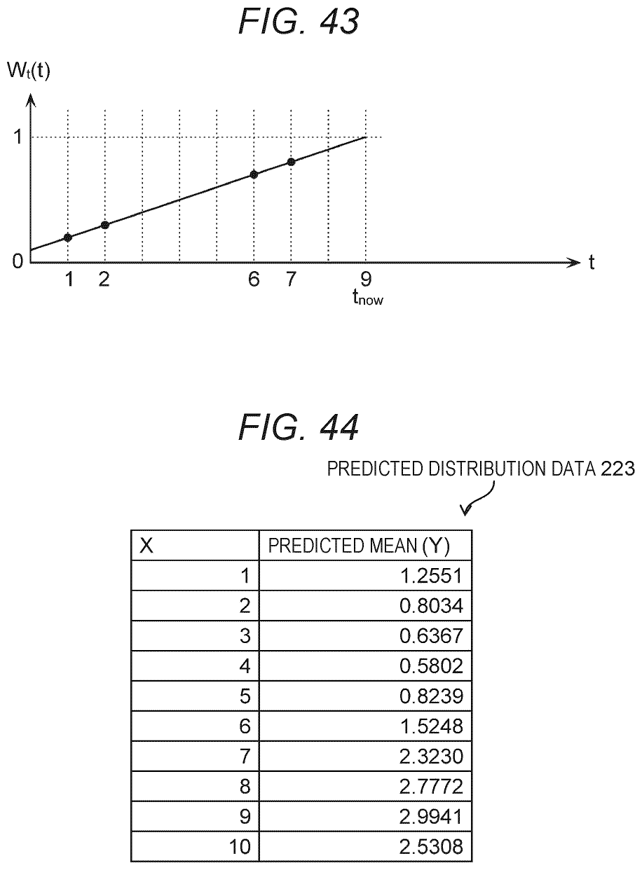

FIG. 43 is a diagram illustrating an example of weight distribution Wₜ (t) and weight Wt included in weight distribution Wₜ (t) for time t at which each experiment with the experiment number n=1 to 4 was performed. Note that time t=9 at which the experiment with the experiment number n=5 is performed is current time t_{now}. Weight distribution Wₜ (t) illustrated in FIG. 43 is equal to weight distribution Wₜ (t) illustrated in FIG. 42.

Evaluation value calculator 12 derives weight Wt for time t at which each experiment with the experiment number n=1 to 4 was performed based on weight distribution Wₜ (t) illustrated in FIG. 43. Time t at which each experiment with the experiment number n=1 to 4 was performed is “1, 2, 6, 7”. That is, evaluation value calculator 12 derives weights Wt=0.2, 0.3, 0.7, 0.8 for times t=1, 2, 6, 7, respectively.

FIG. 44 is a diagram illustrating an example of a predicted mean of each candidate experimental point.

When the experimental point (i.e., level X) used in the experiment with the experiment number n=4 is selected, evaluation value calculator 12 has already calculated the predicted mean at each candidate experimental point based on (Formula 1-1) as illustrated in FIG. 44. These predicted means are shown, for example, in predicted distribution data 223. Evaluation value calculator 12 calculates error variance σ² included in (Formula 1-1) and (Formula 2-1) using the predicted means as the above-described reference points. Note that the predicted mean illustrated in FIG. 44 is the mean of the predicted distribution before one iteration processing at experimental point x₍ₙ₎.

Specifically, evaluation value calculator 12 calculates error variance σ² for time t at which the experiment with the experiment number n=5 is performed, that is, the current time t_{now}=9 based on (Formula 13) as in the following (Formula 14).

$$\begin{matrix}[ Math . 18 ] & \\ {\hat{σ}}_{t}^{2} ( 9 ) = \frac{1}{0 . {2}^{2} + 0 . {3}^{2} + 0 . {7}^{2} + 0 . {8}^{2}} \times \{ 0 . {2}^{2} \cdot {( 1.141471 - 1.2551 )}^{2} + 0 . {3}^{2} \cdot {( 2. 455979 - 2.5308 )}^{2} + 0 . {7}^{2} \cdot {( 0.443198 - 0.5802 )}^{2} + 0 . {8}^{2} \cdot {( 3. 112118 - 2.9941 )}^{2} \} = 0.0 \; 15184 … & ( Formula 14 )\end{matrix}$$

Then, evaluation value calculator 12 uses the calculated error variance σ² for (Formula 1-1) and (Formula 2-1) to calculate the mean and variance of the predicted distribution for each candidate experimental point that is a candidate for the experimental point used in the experiment with the experiment number n=5. That is, evaluation value calculator 12 updates predicted distribution data 223. Then, evaluation value calculator 12 calculates the evaluation value based on the EHVI of each candidate experimental point by applying the mean and variance of the predicted distribution indicated by predicted distribution data 223 to (Formula 3) described above. As a result, evaluation value calculator 12 updates evaluation value data 224.

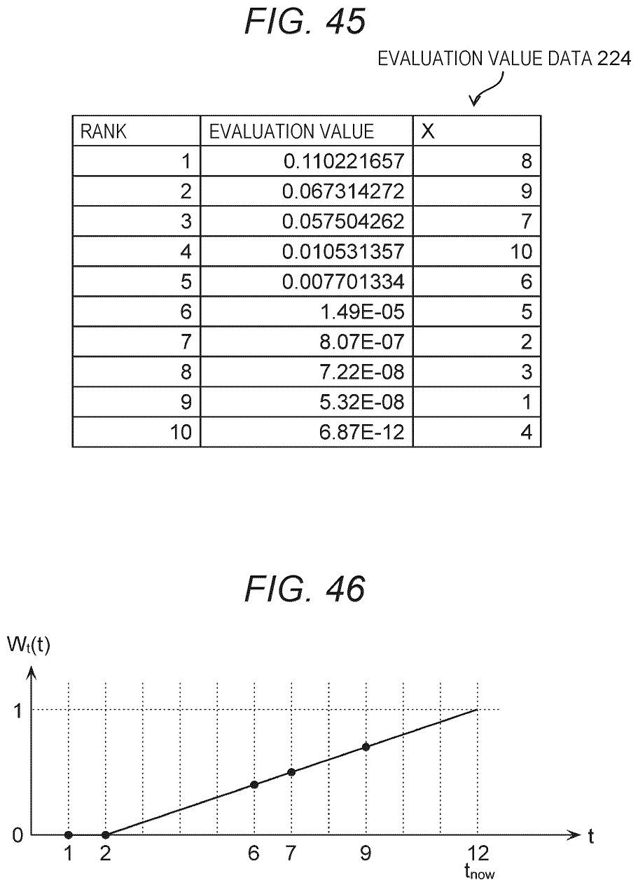

FIG. 45 is a diagram illustrating an example of evaluation value data 224.

Evaluation value data 224 illustrated in FIG. 45 shows evaluation values of the candidate experimental points arranged in descending order. Furthermore, evaluation value data 224 indicates, for each evaluation value, the level X of the candidate experimental point corresponding to the evaluation value and a rank of the evaluation value.

Arithmetic circuit 102 adopts the candidate experimental point of the level X=8 associated with the rank “1” indicated in evaluation value data 224, that is, the level X=8 associated with the maximum evaluation value as the experimental point used for the next experiment. The next experiment is the experiment identified by experiment number n=5. Then, arithmetic circuit 102 writes the level X=8 in experimental result data 222 illustrated in FIG. 41 in association with time t=9 and the experiment number n=5. When objective characteristic value Y “3.389358” that is the experimental result is obtained by the experiment with the experiment number n=5, arithmetic circuit 102 acquires characteristic point data 201 indicating objective characteristic value Y “3.389358” as the characteristic point, and writes objective characteristic value Y “3.389358” in experimental result data 222. That is, arithmetic circuit 102 writes objective characteristic value Y “3.389358” in experimental result data 222 illustrated in FIG. 41 in association with the experiment number n=5, time t=9, and the level X=8. As a result, experimental result data 222 indicates time t at which each experiment with the experiment number n=1 to 5 was performed, level X used in these experiments, and objective characteristic value Y obtained by these experiments.

Next, evaluation device 100 estimates error variance σ² used for searching for the level of the control factor (i.e., experimental point) used in the experiment with the experiment number n=6 based on the experimental result of each experiment with the experiment number n=1 to 5. The specific description is as follows: Note that the experiment with the experiment number n=6 is performed at time t=12.

First, evaluation value calculator 12 derives weight Wt for time t at which each experiment with the experiment number n=1 to 5 was performed based on the weight distribution indicated by weight distribution data 213.

FIG. 46 is a diagram illustrating an example of weight distribution Wₜ (t) and weight Wt included in weight distribution Wₜ (t) for time t at which each experiment with the experiment number n=1 to 5 was performed. Note that time t=12 at which the experiment with the experiment number n=6 is performed is current time t_{now}. Weight distribution Wₜ (t) illustrated in FIG. 46 is equal to weight distribution Wₜ (t) illustrated in FIG. 42.

Evaluation value calculator 12 derives weight Wt for time t at which each experiment with the experiment number n=1 to 5 was performed based on weight distribution Wₜ (t) illustrated in FIG. 46. Time t at which each experiment with the experiment number n=1 to 5 was performed is “1, 2, 6, 7, 9”. That is, evaluation value calculator 12 derives weights Wt=0.0, 0.0, 0.4, 0.5, 0.7 for times t=1, 2, 6, 7, 9, respectively.

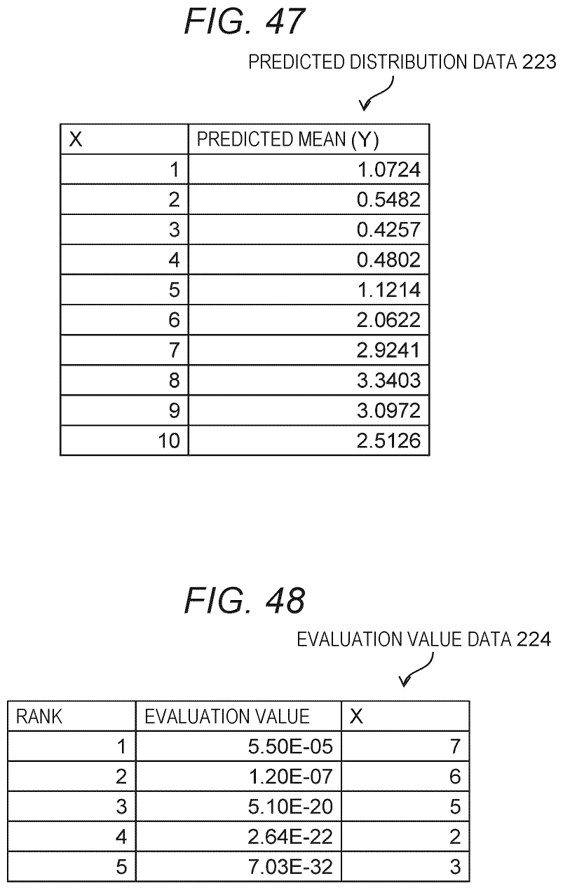

FIG. 47 is a diagram illustrating an example of a predicted mean of each candidate experimental point.

When the experimental point (i.e., level X) used in the experiment with the experiment number n=5 is selected, evaluation value calculator 12 has already calculated the predicted mean at each candidate experimental point based on (Formula 1-1) as illustrated in FIG. 47. These predicted means are shown, for example, in predicted distribution data 223. Evaluation value calculator 12 calculates error variance σ² included in (Formula 1-1) and (Formula 2-1) using the predicted means as the above-described reference points.

Specifically, evaluation value calculator 12 calculates error variance σ² for time t at which the experiment with the experiment number n=6 is performed, that is, the current time t_{now}=12 based on (Formula 13) as in the following (Formula 15).

$$\begin{matrix}[ Math . 19 ] & \\ {\hat{σ}}_{t}^{2} ( 12 ) = \frac{1}{0 . {4}^{2} + 0 . {5}^{2} + 0 . {7}^{2}} \times \{ 0 . {4}^{2} \cdot {( 0.443198 - 0.4802 )}^{2} + 0 . {5}^{2} \cdot {( 3. 112118 - 3.0972 )}^{2} + 0 . {7}^{2} \cdot {( 3.389358 - 3.3403 )}^{2} \} = 0.0 \; 01616 … & ( Formula 15 )\end{matrix}$$

Then, evaluation value calculator 12 uses the calculated error variance σ² for (Formula 1-1) and (Formula 2-1) to calculate the mean and variance of the predicted distribution for each candidate experimental point that is a candidate for the experimental point used in the experiment with the experiment number n=6. That is, evaluation value calculator 12 updates predicted distribution data 223. Then, evaluation value calculator 12 calculates the evaluation value based on the EHVI of each candidate experimental point by applying the mean and variance of the predicted distribution indicated by predicted distribution data 223 to (Formula 3) described above. As a result, evaluation value calculator 12 updates evaluation value data 224.

FIG. 48 is a diagram illustrating an example of evaluation value data 224.

Evaluation value data 224 illustrated in FIG. 48 shows evaluation values of the candidate experimental points arranged in descending order. Furthermore, evaluation value data 224 indicates, for each evaluation value, the level X of the candidate experimental point corresponding to the evaluation value and a rank of the evaluation value.

Arithmetic circuit 102 adopts the candidate experimental point of the level X=7 associated with the rank “1” indicated in evaluation value data 224, that is, the level X=7 associated with the maximum evaluation value as the experimental point used for the next experiment. The next experiment is the experiment identified by experiment number n=6. Then, arithmetic circuit 102 writes the level X=7 in experimental result data 222 illustrated in FIG. 41 in association with the experiment number n=6 and time t=12. When objective characteristic value Y “2.756987” that is the experimental result is obtained by the experiment with the experiment number n=6, arithmetic circuit 102 acquires characteristic point data 201 indicating objective characteristic value Y “2.756987” as the characteristic point, and writes objective characteristic value Y “2.756987” in experimental result data 222. That is, arithmetic circuit 102 writes objective characteristic value Y “2.756987” in experimental result data 222 illustrated in FIG. 41 in association with the experiment number n=6, time t=12, and the level X=7. As a result, experimental result data 222 indicates time t at which each experiment with the experiment number n=1 to 6 was performed, level X used in these experiments, and objective characteristic value Y obtained by these experiments.

By repeating the processing as described above, every time experiment number n is incremented, evaluation device 100 writes time t, level X, and objective characteristic value Y in experimental result data 222 in association with experiment number n. As a result, it is possible to perform an advanced optimization search in consideration of error variance σ² depending on time.

### Example 2 of Second Exemplary Embodiment

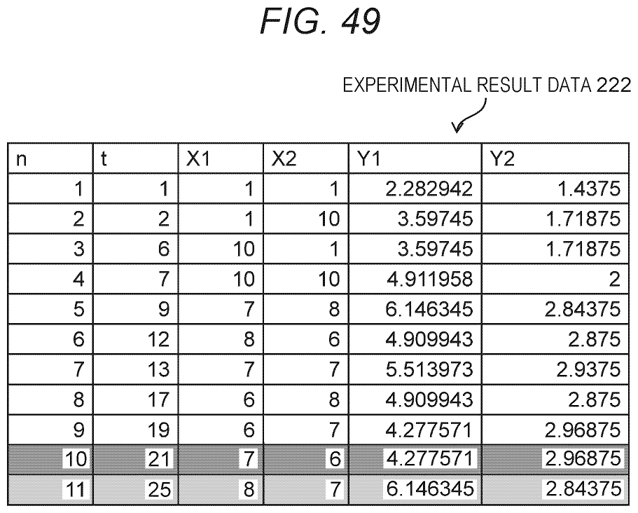

FIG. 49 is a diagram illustrating an example of experimental result data 222 in Example 2 of the present exemplary embodiment.

experimental result data 222 indicates, for each experiment number n, time t at which the experiment identified by the experiment number n was performed, experimental points used in the experiment, and characteristic points obtained by the experiment. Note that in Example 2, the experimental point is expressed by level X1 of the first control factor and level X2 of the second control factor, and the characteristic point is expressed by objective characteristic value Y1 of the first objective characteristic and objective characteristic value Y2 of the second objective characteristic. That is, in Example 2, the number of dimensions of the control factor is two, and the number of dimensions of the objective characteristic is also two. Level X1 and level X2 may each take an integer of 1 to 10. The optimization objective of each of objective characteristic value Y1 and objective characteristic value Y2 is, for example, maximization.

For example, experimental result data 222 illustrated in FIG. 49 indicates that the experiment with the experiment number n=1 was performed at time t=1, “1” and “1” were used as level X1 and level X2, respectively, in the experiment, and “2.282942” and “1.4375” were obtained as objective characteristic value Y1 and objective characteristic value Y2, respectively. Furthermore, experimental result data 222 indicates that the experiment with the experiment number n=2 was performed at time t=2, “1” and “10” were used as level X1 and level X2, respectively, in the experiment, and “3.59745” and “1.71875” were obtained as objective characteristic value Y1 and objective characteristic value Y2, respectively.

Furthermore, the weight distribution of the first objective characteristic is defined as, for example, W_{1;t} (t)=max {1−0.1|t_{now}−t|, 0}, and the weight distribution of the second objective characteristic is defined as, for example, W_{2;t} (t)=max {1−0.2|t_{now}−t|, 0}. Note that these weight distributions are received as weight distribution data 213 by second reception image 420 or 430, for example. Weight distribution W_{1;t} (t) of the first objective characteristic is the same as weight distribution Wₜ (t) defined in Example 1 of the second exemplary embodiment. In weight distribution W_{2;t} (t) of the second objective characteristic, similarly to weight distribution W_{1;t} (t) of the first objective characteristic, when time t is current time t_{now}, weight W_{2;t} for time t becomes the maximum value “1”. Furthermore, as time t goes back to the past from current time t_{now}, weight W_{2;t} for time t decreases. However, in weight distribution W_{2;t} (t) of the second objective characteristic, unlike weight distribution W_{1;t} (t) of the first objective characteristic, every time time t decreases by “1” from current time t_{now}, weight W_{2;t} for time t decreases by 0.2.

For example, when time t=t_{now}, weight W_{2;t} for time t becomes the maximum value “1”, and when time t=(t_{now}−1), weight W_{2;t} for time t becomes “0.8” smaller than “1” by 0.2. Furthermore, when time t=(t_{now}−2), weight W_{2;t} for time t becomes “0.6” even smaller than “0.8” by 0.2. Then, when time t=(t_{now}−5), weight W_{2;t} for time t becomes “0”. Then, at all times t before (t_{now}−5), that is, when the time t is smaller than (t_{now}−5), weight W_{2;t} for time t is “0”.

Here, a flow of processing when searching for an optimal solution of an objective characteristic by sequentially repeating experiments according to experiment number n of experimental result data 222 illustrated in FIG. 49 will be described.

For example, it is assumed that at the present time, each experiment with the experiment number n=1 to 9 illustrated in FIG. 49 is performed, and the experimental results (i.e., objective characteristic values Y1 and Y2) have already been obtained by the experiments. For example, the experiment with the experiment number n=1 is performed at time t=1, the experiment with the experiment number n=2 is performed at time t=2, the experiment with the experiment number n=3 is performed at time t=6, and the experiment with the experiment number n=4 is performed at time t=7. In this case, evaluation device 100 estimates error variance σ² used for searching for the level of the control factor (i.e., experimental point) used in the experiment with the experiment number n=10 based on the experimental result of each experiment with the experiment number n=1 to 9. Note that error variance σ² is an error variance represented by (Formula 13). The experiment with the experiment number n=10 is performed at time t=21.

Specifically, first, evaluation value calculator 12 derives weight W_{1;t} and weight W_{2;t} for time t at which each experiment with the experiment number n=1 to 9 was performed based on the weight distribution indicated by weight distribution data 213.

Evaluation value calculator 12 derives weight W_{1;t} for time t at which each experiment with the experiment number n=1 to 9 was performed based on weight distribution W_{1;t} (t)=max {1−0.1|t_{now}−t|, 0} of the first objective characteristic. Note that time t=21 at which the experiment with the experiment number n=10 is performed is current time t_{now}. Time t at which each experiment with the experiment number n=1 to 9 was performed is “1, 2, 6, 7, 9, 12, 13, 17, 19”. That is, evaluation value calculator 12 derives weights W_{1;t}=0, 0, 0, 0, 0, 0.1, 0.2, 0.6, 0.8 for times t=1, 2, 6, 7, 9, 12, 13, 17, 19, respectively.

Furthermore, evaluation value calculator 12 derives weight W_{2;t} for time t at which each experiment with the experiment number n=1 to 9 was performed based on weight distribution W_{2;t} (t)=max {1−0.2|t_{now}−t|, 0} of the second objective characteristic. That is, evaluation value calculator 12 derives weights W_{2;t}=0, 0, 0, 0, 0, 0, 0, 0.2, 0.6 for times t=1, 2, 6, 7, 9, 12, 13, 17, 19, respectively.

When deriving the experimental point (i.e., level X1 and level X2) used in the experiment with the experiment number n=9, evaluation value calculator 12 has already calculated the predicted mean at each candidate experimental point based on (Formula 1-1) as illustrated in FIG. 31, for example. These predicted means are shown, for example, in predicted distribution data 223. Evaluation value calculator 12 calculates error variance σ² included in (Formula 1-1) and (Formula 2-1) using the predicted means as the above-described reference points. Specifically, evaluation value calculator 12 calculates error variance σ² of each of the first objective characteristic and the second objective characteristic for time t at which the experiment with the experiment number n=10 is performed, that is, the current time t_{now}=21 based on (Formula 13) as in the following (Formula 16a) and (Formula 16b). Note that (Formula 16a) represents error variance σ² of the first objective characteristic, and (Formula 16b) represents error variance σ² of the second objective characteristic.

$$\begin{matrix}[ Math . 20 ] & \\ {\hat{σ}}_{1 ; t}^{2} ( 21 ) = \frac{1}{0 . {1}^{2} + 0 . {2}^{2} + 0 . {6}^{2} + 0 . {8}^{2}} \times \{ 0 . {1}^{2} \cdot {( 4. 909943 - 4.8649 )}^{2} + 0 . {2}^{2} \cdot {( 5. 513973 - 5.5164 )}^{2} + 0 . {6}^{2} \cdot {( 4.909943 - 4.9671 )}^{2} + 0 . {8}^{2} \cdot {( 4. 277571 - 4.2327 )}^{2} \} = 0.002367 … & ( Formula 16 a )\end{matrix}$$

$${\hat{σ}}_{2 ; t}^{2} ( 21 ) = \frac{1}{0 . {2}^{2} + 0 . {6}^{2}} \times \{ 0 . {2}^{2} \cdot {( 2. 875 - 2.9324 )}^{2} + 0 . {6}^{2} \cdot {( 2. 96875 - 2.9232 )}^{2} \} = 0.002197 … \qquad ( Formula 16 b )$$

Then, evaluation value calculator 12 uses the calculated error variance σ² for (Formula 1-1) and (Formula 2-1) to calculate the mean and variance of the predicted distribution for each candidate experimental point that is a candidate for the experimental point used in the experiment with the experiment number n=10 for each dimension of the objective characteristic. That is, evaluation value calculator 12 updates predicted distribution data 223. Then, evaluation value calculator 12 calculates the evaluation value based on the EHVI of each candidate experimental point by applying the mean and variance of the predicted distribution indicated by predicted distribution data 223 to (Formula 3) described above. As a result, evaluation value calculator 12 updates evaluation value data 224. As a result, for example, evaluation value data 224 illustrated in FIG. 32 is obtained.

Arithmetic circuit 102 adopts the candidate experimental point of the set of levels (X1, X2)=(7, 6) associated with the rank “1” indicated in evaluation value data 224 illustrated in FIG. 32, that is, the set of levels (X1, X2)=(7, 6) associated with the maximum evaluation value as the experimental point used for the next experiment. The next experiment is the experiment identified by experiment number n=10. Then, arithmetic circuit 102 writes the set of levels (X1, X2)=(7, 6) in experimental result data 222 illustrated in FIG. 49 in association with time t=21 and the experiment number n=10. When the set of objective characteristic values (Y1, Y2)=(4.277571, 2.96875) that is the experimental result is obtained by the experiment with the experiment number n=10, arithmetic circuit 102 acquires characteristic point data 201 indicating the set of objective characteristic values (Y1, Y2)=(4.277571, 2.96875) as the characteristic point, and writes the set of objective characteristic values (Y1, Y2)=(4.277571, 2.96875) in experimental result data 222. That is, arithmetic circuit 102 writes the set of objective characteristic values (Y1, Y2)=(4.277571, 2.96875) in experimental result data 222 illustrated in FIG. 49 in association with the experiment number n=10, time t=21, and the set of levels (X1, X2)=(7, 6). As a result, experimental result data 222 indicates time t at which each experiment with the experiment number n=1 to 10 was performed, the set of levels (X1, X2) used in these experiments, and the set of objective characteristic values (Y1, Y2) obtained by these experiments.

Next, evaluation device 100 estimates error variance σ² used for searching for the level of the control factor (i.e., experimental point) used in the experiment with the experiment number n=11 based on the experimental result of each experiment with the experiment number n=1 to 10. The specific description is as follows: Note that the experiment with the experiment number n=11 is performed at time t=25.

First, evaluation value calculator 12 derives weight W_{1;t} and weight W_{2;t} for time t at which each experiment with the experiment number n=1 to 10 was performed based on the weight distribution indicated by weight distribution data 213.

For example, evaluation value calculator 12 derives weight W_{1;t} for time t at which each experiment with the experiment number n=1 to 10 was performed based on weight distribution W_{1;t} (t)=max {1−0.1|t_{now}−t|, 0} of the first objective characteristic. Note that time t=25 at which the experiment with the experiment number n=11 is performed is current time t_{now}. Time t at which each experiment with the experiment number n=1 to 10 was performed is “1, 2, 6, 7, 9, 12, 13, 17, 19, 21”. That is, evaluation value calculator 12 derives weights W_{1;t}=0, 0, 0, 0, 0, 0, 0, 0.2, 0.4, 0.6 for times t=1, 2, 6, 7, 9, 12, 13, 17, 19, 21, respectively.

Furthermore, evaluation value calculator 12 derives weight W_{2;t} for time t at which each experiment with the experiment number n=1 to 10 was performed based on weight distribution W_{2;t} (t)=max {1−0.2|t_{now}−t|, 0} of the second objective characteristic. That is, evaluation value calculator 12 derives weights W_{2;t}=0, 0, 0, 0, 0, 0, 0, 0, 0, 0.2 for times t=1, 2, 6, 7, 9, 12, 13, 17, 19, 21, respectively.

When the experimental point (i.e., level X) used in the experiment with the experiment number n=10 is selected, evaluation value calculator 12 has already calculated the predicted mean at each candidate experimental point based on (Formula 1-1) as illustrated in FIG. 33, for example. These predicted means are shown, for example, in predicted distribution data 223. Evaluation value calculator 12 calculates error variance σ² included in (Formula 1-1) and (Formula 2-1) using the predicted means as the above-described reference points.

Specifically, evaluation value calculator 12 calculates error variance σ² for time t at which the experiment with the experiment number n=11 is performed, that is, the current time t_{now}=25 based on (Formula 13) as in the following (Formula 17a) and (Formula 17b). Note that (Formula 17a) represents error variance σ² of the first objective characteristic, and (Formula 17b) represents error variance σ² of the second objective characteristic.

$$\begin{matrix}[ Math . 21 ] & \\ {\hat{σ}}_{1 ; t}^{2} ( 25 ) = \frac{1}{0 . {2}^{2} + 0 . {4}^{2} + 0 . {6}^{2}} \times \{ 0 . {2}^{2} \cdot {( 4. 909943 - 4.9827 )}^{2} + 0 . {2}^{2} \cdot {( 4. 277571 - 4.2278 )}^{2} + 0 . {6}^{2} \cdot {( 4.277571 - 4.1753 )}^{2} \} = 0.00781 … & ( Formula 17 a )\end{matrix}$$

$${\hat{σ}}_{2 ; t}^{2} ( 21 ) = \frac{1}{0 . {2}^{2}} \times \{ 0 . {2}^{2} \cdot {( 2. 96875 - 2.8977 )}^{2} \} = 0.005048 … \qquad ( Formula 17 b )$$

Then, evaluation value calculator 12 uses the calculated error variance σ² for (Formula 1-1) and (Formula 2-1) to calculate the mean and variance of the predicted distribution for each candidate experimental point that is a candidate for the experimental point used in the experiment with the experiment number n=11 for each dimension of the objective characteristic. That is, evaluation value calculator 12 updates predicted distribution data 223. Then, evaluation value calculator 12 calculates the evaluation value based on the EHVI of each candidate experimental point by applying the mean and variance of the predicted distribution indicated by predicted distribution data 223 to (Formula 3) described above. As a result, evaluation value calculator 12 updates evaluation value data 224. As a result, for example, evaluation value data 224 illustrated in FIG. 34 is obtained.

Arithmetic circuit 102 adopts the candidate experimental point of the set of levels (X1, X2)=(8, 7) associated with the rank “1” indicated in evaluation value data 224 illustrated in FIG. 34, that is, the candidate experimental point (X1, X2)=(8, 7) associated with the maximum evaluation value as the experimental point used for the next experiment. The next experiment is the experiment identified by experiment number n=11. Then, arithmetic circuit 102 writes the set of levels (X1, X2)=(8, 7) in experimental result data 222 illustrated in FIG. 49 in association with time t=25 and the experiment number n=11. When the set of objective characteristic values (Y1, Y2)=(6.146345, 2.84375) that is the experimental result is obtained by the experiment with the experiment number n=11, arithmetic circuit 102 acquires characteristic point data 201 indicating the set of objective characteristic values (Y1, Y2)=(6.146345, 2.84375) as the characteristic point, and writes the set of objective characteristic values (Y1, Y2)=(6.146345, 2.84375) in experimental result data 222. That is, arithmetic circuit 102 writes the set of objective characteristic values (Y1, Y2)=(6.146345, 2.84375) in experimental result data 222 illustrated in FIG. 49 in association with the experiment number n=11, time t=25, and the set of levels (X1, X2)=(8, 7). As a result, experimental result data 222 indicates time t at which each experiment with the experiment number n=1 to 11 was performed, the set of levels (X1, X2) used in these experiments, and the set of objective characteristic values (Y1, Y2) obtained by these experiments.

By repeating the processing as described above, every time experiment number n is incremented, evaluation device 100 writes time t, the set of levels (X1, X2), and the set of objective characteristic values (Y1, Y2) in experimental result data 222 in association with experiment number n. As a result, it is possible to perform an advanced optimization search in consideration of error variance σ² depending on time.

As described above, in the present exemplary embodiment, error variance σ² that changes depending on time is estimated, and the experimental condition is evaluated by Bayesian optimization using error variance σ². Therefore, even in an environment where error variance σ² changes, the experimental conditions can be quantitatively evaluated with high accuracy. That is, conventionally, a quantitative determination method for error variance σ² is not shown, and a fixed value such as “1” is generally used for error variance 2. Therefore, error variance σ² is universally handled, and there is a possibility that the actual phenomenon is not fully reflected in error variance σ². However, in the present exemplary embodiment, since a plurality of non-universal error variances σ² different from each other are estimated with the lapse of time and used for Bayesian optimization, highly accurate evaluation can be performed. As a result, in the present exemplary embodiment, it is possible to provide evaluation device 100 to which the Bayesian optimization capable of quantitatively responding to a change is applied while estimating error variance σ².

### Summary of Second Exemplary Embodiment

As described above, evaluation device 100 according to the present exemplary embodiment is a device that evaluates one or more unknown characteristic points corresponding to one or more candidate experimental points by Bayesian optimization based on known characteristic points corresponding to experimented experimental points. Such evaluation device 100 includes a first reception means that acquires experimental result data 222 indicating experimented experimental points and known characteristic points, and a second reception means that acquires, in a case where each of the one or more unknown characteristic points and known characteristic points is expressed by one or more values of objective characteristics, objective data 212 indicating an optimization objective of each of the one or more objective characteristics. The first reception means and the second reception means are included in reception controller 10 in FIG. 4. In addition, evaluation device 100 includes a calculation means that estimates a plurality of error variances σ² that are variances of observation errors of characteristic points and are different from each other, and calculates evaluation values of one or more unknown characteristic points based on experimental result data 222, objective data 212, and the plurality of error variances σ², and an output means that outputs the evaluation values. The calculation means and the output means correspond to evaluation value calculator 12 and evaluation value output unit 13 in FIG. 4, respectively. In addition, in a case where evaluation of one or more unknown characteristic points corresponding to one or more candidate experimental points is repeatedly performed by performing an experiment at each of a plurality of times, the calculation means estimates a plurality of error variances σ² different from each other for the plurality of times.

As a result, in the case where the experiment is performed at the plurality of times, each of the one or more candidate experimental points is evaluated by the evaluation value as the experimental condition using the plurality of error variances σ² different from each other for the times. Therefore, it is possible to increase the possibility of bringing the plurality of error variances σ² close to the variance of the observation error according to the actual experiment. That is, it is possible to increase the possibility that appropriate error variance σ² according to time can be used for each of the plurality of times. Therefore, the experimental conditions can be evaluated with higher accuracy than the case of using the same error variance for the plurality of times.

In addition, the calculation means in the present exemplary embodiment calculates a predicted distribution for each of one or more candidate experimental points by using error variance σ² corresponding to each of a plurality of times among the plurality of error variances σ² for the Gaussian process regression, and calculates evaluation values of one or more unknown characteristic points by using the calculated predicted distribution.

As a result, since error variance σ² corresponding to the time is used for the Gaussian process regression, the accuracy of the predicted distribution at the time can be improved. Therefore, the experimental conditions can be evaluated with higher accuracy.

In addition, the calculation means in the present exemplary embodiment acquires a weight distribution defined depending on time, and when each of the plurality of error variances σ² is estimated, error variance σ² is estimated based on weight Wt associated with the time at which the experiment using the experimented experimental point was performed, among the plurality of weights Wt indicated by the weight distribution. For example, a weight distribution illustrated in FIG. 42 or the like is acquired.

As a result, in the weight distribution, weight Wt associated with the time at which the experiment was performed can be used as a reference degree for the observation error of the known characteristic point obtained by the experiment. Therefore, error variance σ² for the time at which the experiment using the candidate experimental point is performed can be estimated by using such only weight Wt of such an observation error. That is, error variance σ² for the time at which the experiment using the candidate experimental point is performed can be estimated using the known characteristic point. As a result, the experimental conditions can be evaluated effectively with high accuracy.

Furthermore, in the present exemplary embodiment, the weight Wt indicated by the weight distribution is smaller as the time associated with the weight Wt is temporally farther from the time (e.g., t_{now}) at which the experiment using any one candidate experimental point of interest among the one or more candidate experimental points is performed.

As a result, when an unknown characteristic point corresponding to the candidate experimental point of interest is evaluated, a small weight Wt is used for an experimental point experimented at a time that is temporally far from the time (i.e., t_{now}) at which the experiment using the candidate experimental point of interest is performed. Conversely, a large weight Wt is used for an experimental point experimented at close times. For example, the degree of wear of an experimental instrument used in the experiment continuously changes with the lapse of time. In such a case, the smaller the difference between the times when the two experiments are performed, that is, the closer the two times are, the more similar the error variance σ² for those times is, and the larger the difference between the two times, that is, the farther the two times are apart, the less similar the error variance σ² for those times is. Therefore, in the examples of FIGS. 35 and 36, when the evaluation value is calculated for the candidate experimental point of interest, the degree of reference to the observation error obtained by the experiment performed at the time far from the time t_{now} of the candidate experimental point of interest can be lowered so as to follow the similar tendency of the actual error variance σ² described above. As a result, the experimental conditions can be evaluated appropriately with high accuracy.

Furthermore, in the present exemplary embodiment, as illustrated in FIG. 35, for example, the weight Wt indicated by the weight distribution linearly decreases as the time associated with the weight Wt is temporally away from the time at which the experiment using the candidate experimental point is performed.

As a result, in a case where the similar tendency of the actual error variance σ² changes linearly with the lapse of time, the experimental conditions can be evaluated with higher accuracy.

Furthermore, in the present exemplary embodiment, as illustrated in FIG. 36, for example, the weight Wt indicated by the weight distribution decreases exponentially as the time associated with the weight Wt is temporally away from the time at which the experiment using the candidate experimental point is performed.

As a result, in a case where the similar tendency of the actual error variance σ² changes exponentially with the lapse of time, the experimental conditions can be evaluated with higher accuracy.

Furthermore, in the present exemplary embodiment, the weight Wt indicated by the weight distribution periodically increases or decreases with the lapse of time, for example, as illustrated in FIG. 37.

As a result, in a case where the similar tendency of the actual error variance σ² changes periodically with the lapse of time, the experimental conditions can be evaluated with higher accuracy.

Furthermore, in the present exemplary embodiment, the weight Wt indicated by the weight distribution is set for each time section, for example, as illustrated in FIG. 38.

As a result, in a case where the similar tendency of the actual error variance σ² differs for each time section, the experimental conditions can be evaluated with higher accuracy.

In addition, in the present exemplary embodiment, when each of the experimented experimental point and the one or more candidate experimental points is expressed by the level of two or more control factors, the calculation means acquires a weight distribution for the control factor of each of the two or more control factors as the weight distribution. Then, when estimating each of the plurality of error variances σ², the calculation means estimates error variance σ² based on the product of weights Wt associated with the time at which the experiment using the experimented experimental point was performed among the plurality of weights Wt indicated by a control factor weight distribution in each of two or more control factor weight distributions.

As a result, in a case where each of the experimented experimental points and the one or more candidate experimental points is expressed by the level of two or more control factors, that is, in a case where each of the experimented experimental points and the one or more candidate experimental points is expressed by two-dimensional or more control factors, error variance σ² is estimated based on the product of weights Wt. Therefore, even in such a case, the experimental conditions can be evaluated with high accuracy.

In addition, in the present exemplary embodiment, when each of the unknown one or more characteristic points and the known characteristic point is expressed by two or more objective characteristic values, the calculation means estimates error variance σ² for each of the two or more objective characteristics by using the objective characteristic value of the known characteristic point.

As a result, even when each of the unknown one or more characteristic points and the known characteristic point is expressed by two or more objective characteristic values, that is, even when each of the unknown one or more characteristic points and the known characteristic point is expressed by two-dimensional or more objective characteristic values, error variance σ² is estimated for each objective characteristic. Therefore, even in such a case, the experimental conditions can be evaluated with high accuracy.

### Third Exemplary Embodiment

Evaluation device 100 according to the first exemplary embodiment estimates error variance σ² using the weight distribution depending on the level space, and evaluation device 100 according to the second exemplary embodiment estimates error variance σ² using the weight distribution depending on time. On the other hand, evaluation device 100 according to the present exemplary embodiment estimates error variance σ² using the weight distribution depending on the level space and time. Then, evaluation device 100 calculates a predicted distribution of each candidate experimental point using error variance σ². Note that in the present exemplary embodiment, the processing of estimating error variance σ² is different from that in the first and second exemplary embodiments, and the rest of the processing is performed in the same manner as in the first exemplary embodiment. Note that, constituent elements of the present exemplary embodiment identical to constituent elements of the first or second exemplary embodiment are denoted by numerals or symbols identical to numerals or symbols used in the first exemplary embodiment, and detailed descriptions of the constituent elements are omitted.

Specifically, evaluation device 100 according to the present exemplary embodiment calculates the mean and variance of the predicted distribution according to the following (Formula 1-2) and (Formula 2-2).

$$\begin{matrix}[ Math . 22 ] & \\ \hat{m} ( {x}_{( N + 1 )} ) = m ( {x}_{( N + 1 )} ) + {( {k}_{N + 1} )}^{T} {( {K}_{N , N} + {\hat{σ}}_{X , t}^{2} ( {x}_{( N + 1 )} , {t}_{N + 1} ) I )}^{- 1} ( {y}^{N} - m ( {x}^{N} ) ) & ( Formula 1 - 2 )\end{matrix}$$

$$\hat{v} ( {x}_{( N + 1 )} , {x}_{( N + 1 )} ) = k ( {x}_{( N + 1 )} , {x}_{( N + 1 )} ) - {( {k}_{N + 1} )}^{T} {( {K}_{N , N} + {\hat{σ}}_{X , t}^{2} ( {x}_{( N + 1 )} , {t}_{N + 1} ) I )}^{- 1} {k}_{N + 1} + {\hat{σ}}_{X , t}^{2} ( {x}_{( N + 1 )} , {t}_{N + 1} ) \qquad ( Formula 2 - 2 )$$

In (Formula 1-1) and (Formula 2-1),

$$\begin{matrix}[ Math . 23 ] & \\ {\hat{σ}}_{X , t}^{2} ( {x}_{( N + 1 )} , {t}_{N + 1} ) & \end{matrix}$$

the above represents error variance σ² based on the observation error in the present exemplary embodiment. Error variance σ² is estimated using a weight distribution depending on the level space and time indicated by weight distribution data 213. Note that in (Formula 1-2) and (Formula 2-2), error variance σ² is different from (Formula 1) and (Formula 2) of the first exemplary embodiment, and variables and the like other than error variance σ² are the same as (Formula 1) and (Formula 2).

### [Weight Distribution Depending on Level Space and Time]

The weight distribution depending on the level space and time will be specifically described below.

Weight distribution data 213 in the present exemplary embodiment is data indicating a weight as a reference degree for each control factor and each level thereof and past time as a weight distribution.

Error variance σ² included in (Formula 1-2) and (Formula 2-2) described above in the present exemplary embodiment depends on the level space and time, and is an amount efficiently estimated from a small number of experimental results. Such error variance σ² is calculated by the following (Formula 18).

$$\begin{matrix}[ Math . 24 ] & \\ {\hat{σ}}_{X , t}^{2} ( {x}_{( N + 1 )} , {t}_{N + 1} ) = \frac{{\sum }_{n = 1}^{N} {\{ {W}_{{x}_{( N + 1 )} , t} ( {x}_{( n )} , {t}_{n} ) ( {y}_{( n )} - \overline{y} ( n ) ) \}}^{2}}{{\sum }_{n = 1}^{N} {W}_{{x}_{( N + 1 )} , t}^{2} ( {x}_{( n )} , {t}_{n} )} & ( Formula 18 )\end{matrix}$$

Here, W_{x(N+1),t}(x₍ₙ₎, tₙ) is a weight distribution determined by the user for candidate experimental point x_{(N+1)}, and represents the weight at experimental point x₍ₙ₎ and time tₙ at which the experiment using experimental point x₍ₙ₎ was performed. The weight distribution is indicated by weight distribution data 213 described above.

$$\begin{matrix}[ Math . 25 ] & \\ {\overline{y}}_{( n )} & \end{matrix}$$

Similarly to (Formula 4), the above is a reference point (or representative point) set by the user. In addition, (Formula 18) is a mathematical expression when the dimension of the objective characteristic is 1. When there are a plurality of dimensions of the objective characteristic, error variance σ² is estimated for each dimension. In this case, a value corresponding to the dimension of each objective characteristics is used for y (n) and W_{x(N+1),t}(x₍ₙ₎, tₙ). As a result, (Formula 18) can be naturally applied to multi-dimensions.

In a case where all the weights are 1 and the reference point is the sample mean, (Formula 18) corresponds to a commonly used formula of sample variance. Therefore, (Formula 18) can be interpreted as an extension of the general sample variance.

Weight distribution W_{x(N+1),t}(x₍ₙ₎, tₙ) in the present exemplary embodiment is defined as, for example, a product of weight distribution W_{x(N+1)} (x₍ₙ₎) in the first exemplary embodiment and weight distribution Wₜ (tₙ) in the second exemplary embodiment as expressed in the following (Formula 19).

$$\begin{matrix}[ Math . 26 ] & \\ {W}_{X , t} ( {X}^{′} , {t}_{n} ) = {W}_{X} ( {X}^{′} ) {W}_{t} ( {t}_{n} ) & ( Formula 19 )\end{matrix}$$

Note that in (Formula 19), weight distribution W_{x(N+1),t}(x₍ₙ₎, tₙ) in the present exemplary embodiment is simplified as W_{X,t}(X′, tₙ). Similarly, weight distribution W_{x(N+1)}(x₍ₙ₎) in the first exemplary embodiment is simplified as W_{X} (X′). Furthermore, in the following description, W_{X} (X′) may be expressed as weight Wx for level X′ indicated in the weight distribution depending on the level space, and Wₜ (tₙ) may be expressed as weight Wt for time t indicated in the weight distribution depending on time. Similarly, W_{X,t}(X′, tₙ) may be expressed as weight W_{X,t} for level X′ and time t indicated in the weight distribution. When the number of dimensions of the control factor is plural, weight distribution W_{X} (X′) may be defined by (Formula 5).

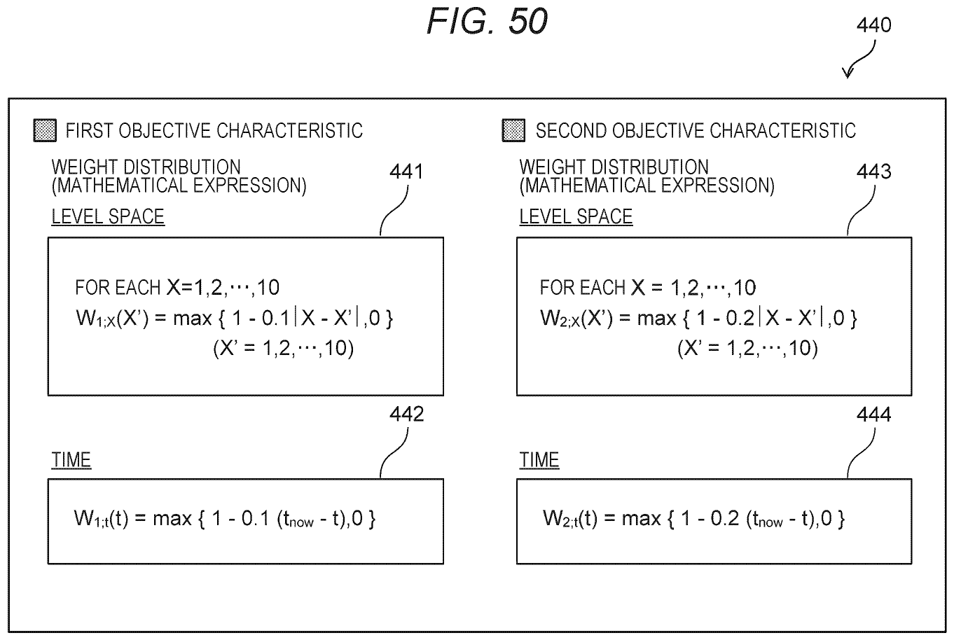

FIG. 50 is a diagram illustrating an example of a second reception image displayed on display 104 to receive an input of weight distribution data 213.

For example, arithmetic circuit 102 displays second reception image 440 illustrated in FIG. 50 on display 104.

Second reception image 440 includes first weight distribution setting regions 441 and 442 and second weight distribution setting regions 443 and 444. First weight distribution setting region 441 is a region for receiving weight distribution W_{1;X} (X′) depending on the level space for the first objective characteristic as a mathematical expression. For example, the user operates input unit 101a to write weight distribution W_{1;X} (X′) in first weight distribution setting region 441. As a result, reception controller 10 of arithmetic circuit 102 acquires weight distribution data 213 indicating weight distribution W_{1;X} (X′) written with respect to the first objective characteristic. For example, the weight distribution is expressed as W_{1;x} (X′)=max {1−0.1|X−X′|, 0} for each of X=1, 2 . . . , 10. Note that X is the attention level. X′ is a level corresponding to the above-described comparison objective level, and is expressed as X′=1, 2, . . . , 10.

First weight distribution setting region 442 is a region for receiving weight distribution W_{1;t} (t) depending on time for the first objective characteristic as a mathematical expression. For example, the user operates input unit 101a to write weight distribution W_{1;t} (t) in first weight distribution setting region 442. As a result, reception controller 10 of arithmetic circuit 102 acquires weight distribution data 213 indicating weight distribution W_{1;t} (t) written with respect to the first objective characteristic. For example, the weight distribution may be expressed as W_{1;t} (t)=max {1−0.1|t_{now}−t|, 0}.

In addition, second weight distribution setting region 443 is a region for receiving weight distribution W_{2;X}(X′) depending on the level space for the second objective characteristic as a mathematical expression. For example, the user operates input unit 101a to write weight distribution W_{2;X}(X′) in second weight distribution setting region 443. As a result, reception controller 10 of arithmetic circuit 102 acquires weight distribution data 213 indicating weight distribution W_{2;X}(X′) written with respect to the second objective characteristic. For example, the weight distribution is expressed as W_{2;X}(X)=max {1−0.2|X−X′|, 0} for each of X=1, 2, . . . , 10. Note that X′ is expressed as X′=1, 2, . . . , 10.

Second weight distribution setting region 444 is a region for receiving weight distribution W_{2;t} (t) depending on time for the second objective characteristic as a mathematical expression. For example, the user operates input unit 101a to write weight distribution W_{2;t} (t) in second weight distribution setting region 444. As a result, reception controller 10 of arithmetic circuit 102 acquires weight distribution data 213 indicating weight distribution W_{2;t} (t) written with respect to the second objective characteristic. For example, the weight distribution may be expressed as W_{2;t} (t)=max {1−0.2|t_{now}−t|, 0}.

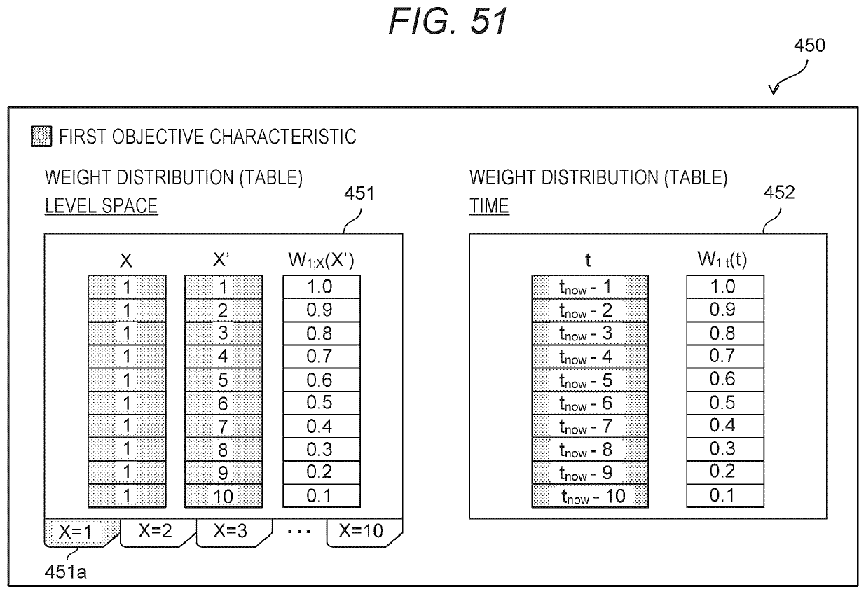

FIG. 51 is a diagram illustrating another example of the second reception image displayed on display 104 to receive an input of weight distribution data 213.

For example, arithmetic circuit 102 displays second reception image 450 illustrated in FIG. 51 on display 104. Note that second reception image 450 illustrated in FIG. 51 is an image for the first objective characteristic. For the second objective characteristic, a second reception image similar to second reception image 450 illustrated in FIG. 51 is displayed on display 104.

The second reception image 450 is a tabular reception image and includes first weight distribution setting regions 451 and 452. First weight distribution setting region 451 is a region for receiving, for each combination of attention level X and level X′ for the first objective characteristic, weight Wx for the combination as W_{1;x} (X′). For example, the user operates input unit 101a to write weight W_{1;x} (X′) for each of the combinations.

Specifically, arithmetic circuit 102 derives a combination of attention level X and each level X′ for each attention level X based on control factor data 211 or candidate experimental point data 221, and displays the combination in first weight distribution setting region 451. Note that when tab 451a of first weight distribution setting region 451 is selected according to an input operation of the user to input unit 101a, the combination of attention level X and each level X′ associated with tab 451a is displayed in first weight distribution setting region 411. Then, the user operates input unit 101a to write weight W_{1;x} (X′) for each of the combinations. As a result, reception controller 10 of arithmetic circuit 102 acquires weight distribution data 213 indicating the weight distribution including a plurality of weights W_{1;x} (X′) written with respect to the first objective characteristic.

First weight distribution setting region 452 is a region for receiving, for each time t for the first objective characteristic, weight Wt for the time t as W_{1;t} (t). Note that time t is expressed using current time t_{now} as a reference, such as “t_{now}−1”, “t_{now}−2”, and “t_{now}−3”. For example, the user operates input unit 101a to write weight W_{1;t} (t) for each of times t. As a result, reception controller 10 of arithmetic circuit 102 acquires weight distribution data 213 indicating the weight distribution including a plurality of weights W_{1;t} (t) written with respect to the second objective characteristic.

Hereinafter, an example of processing for searching for an optimal solution of the objective characteristic while estimating error variance σ² depending on the level space and time will be described as an example. Example 1 is an example of a case including one each of the control factor and the objective characteristic, that is, the number of dimensions thereof is one. Example 2 is an example of a case including two each of the control factor and the objective characteristic, that is, the number of dimensions thereof is two. An example including three or more each of the control factor and the objective characteristic can be naturally applied from Example 2.

### Example 1 of Third Exemplary Embodiment

Experimental result data 222 in Example 1 of the present exemplary embodiment is, for example, the same as experimental result data 222 illustrated in FIG. 41.

Experimental result data 222 indicates, for each experiment number n, time t at which the experiment identified by experimental number n was performed, an experimental point that is the level of the control factor used in the experiment, and an objective characteristic value obtained by the experiment. Note that the level of the control factor or experimental point is denoted as X, and the objective characteristic value is denoted as Y. Level X may take an integer of 1 to 10. The optimization objective of Y is, for example, maximization. Here, n is an integer of 1 or more.

For example, experimental result data 222 indicates that the experiment with the experiment number n=1 was performed at time t=1, “1” was used as level X in the experiment, and “1.141471” was obtained as objective characteristic value Y. Furthermore, experimental result data 222 indicates that the experiment with the experiment number n=2 was performed at time t=2, “10” was used as level X in the experiment, and “2.455979” was obtained as objective characteristic value Y.

Furthermore, the weight distribution in the present exemplary embodiment is defined by the above-described (Formula 19). That is, the weight distribution is defined as W_{X,t} (X′, tₙ)=W_{X} (X′) Wₜ(tₙ). W_{X} (X′) is a weight distribution depending on the level space, and is defined as W_{X} (X′)=max {1−0.1|X−X′|, 0}, (X′=1, 2 . . . , 10) for each of the attention levels X=1, 2 . . . , and 10, similarly to Example 1 of the first exemplary embodiment. In addition, W (tₙ) is a weight distribution depending on time and is defined as Wₜ (t)=max {1−0.1|t_{now}−t|, 0} as in Example 1 of the second exemplary embodiment. Note that t is time, and t_{now} is the current time at which the experiment is performed. Moreover, the weight distribution is received as weight distribution data 213 by second reception image 440 or 450.

Here, a flow of processing when searching for an optimal solution of an objective characteristic by sequentially repeating experiments according to experiment number n of experimental result data 222 illustrated in FIG. 41 will be described.

For example, it is assumed that at the present time, each experiment with the experiment number n=1 to 4 illustrated in FIG. 41 is performed, and the experimental results (i.e., objective characteristic values Y) have already been obtained by the experiments. That is, the experiment with the experiment number n=1 is performed at time t=1, the experiment with the experiment number n=2 is performed at time t=2, the experiment with the experiment number n=3 is performed at time t=6, and the experiment with the experiment number n=4 is performed at time t=7. In this case, evaluation device 100 estimates error variance σ² used for searching for the level of the control factor (i.e., experimental point) used in the experiment with the experiment number n=5 based on the experimental result of each experiment with the experiment number n=1 to 4. Note that error variance σ² is an error variance represented by (Formula 18). The experiment with the experiment number n=5 is performed at time t=9.

Specifically, first, evaluation value calculator 12 derives weight W_{X,t} for level X″ used in each experiment with the experiment number n=1 to 4 for each candidate experimental point (i.e., attention level X) and time t at which each experiment was performed based on the weight distribution indicated by weight distribution data 213.

For example, evaluation value calculator 12 derives weight Wx for level X′ used in each experiment with the experiment number n=1 to 4 at the attention level X=1 based on weight distribution W_{X} (X′) illustrated in part (a) of FIG. 24. Level X′ used in each experiment with the experiment number n=1 to 4 is “1, 10, 4, 9”. That is, evaluation value calculator 12 derives weights Wx=1.0, 0.1, 0.7, 0.2 for levels X′=1, 10, 4, 9, respectively. In addition, evaluation value calculator 12 derives weight Wx for level X′ used in each experiment with the experiment number n=1 to 4 at the attention level X=3 based on the weight distribution illustrated in part (b) of FIG. 24. That is, evaluation value calculator 12 derives weights Wx=0.8, 0.3, 0.9, 0.4 for levels X′=1, 10, 4, 9, respectively.

Furthermore, evaluation value calculator 12 derives weight Wt for time t at which each experiment with the experiment number n=1 to 4 was performed based on weight distribution Wₜ (t) illustrated in FIG. 43. Time t at which each experiment with the experiment number n=1 to 4 was performed is “1, 2, 6, 7”. That is, evaluation value calculator 12 derives weights Wt=0.2, 0.3, 0.7, 0.8 for times t=1, 2, 6, 7, respectively.

As a result, evaluation value calculator 12 calculates weight W_{X,t} for level X′ and time t at the attention level X=1 according to (Formula 19). That is, evaluation value calculator 12 calculates “1.0×0.2=0.20” as weight W_{X,t} for the level X′=1 and time t=1, and calculates “0.1×0.3=0.03” as weight W_{X,t} for the level X′=10 and time t=2. Evaluation value calculator 12 calculates “0.7×0.7=0.49” as weight W_{X,t} for the level X′=4 and time t=6, and calculates “0.2×0.8=0.16” as weight W_{X,t} for the level X′=9 and time t=7.

Similarly, evaluation value calculator 12 calculates weight W_{X,t} for the level X′ and time t at the attention level X=3 according to (Formula 19). That is, evaluation value calculator 12 calculates “0.8×0.2-0.16” as weight W_{X,t} for the level X′=1 and time t=1, and calculates “0.3×0.3=0.09” as weight W_{X,t} for the level X′=10 and time t=2. Evaluation value calculator 12 calculates “0.9×0.7=0.63” as weight W_{X,t} for the level X′=4 and time t=6, and calculates “0.4×0.8-0.32” as weight W_{X,t} for the level X′=9 and time t=7.

When the experimental point (i.e., level X) used in the experiment with the experiment number n=4 is selected, evaluation value calculator 12 has already calculated the predicted mean at each candidate experimental point based on (Formula 1-2) as illustrated in FIG. 44. These predicted means are shown, for example, in predicted distribution data 223. Evaluation value calculator 12 calculates error variance σ² included in (Formula 1-2) and (Formula 2-2) using the predicted means as the above-described reference points. Specifically, evaluation value calculator 12 calculates, for example, error variance σ² for each of the attention level X=1 and the attention level X=3 and time t at which the experiment with the experiment number n=5 is performed (i.e., current time t_{now}=9) as in the following (Formula 20) based on (Formula 18). In other words, evaluation value calculator 12 calculates error variance σ² for each of the candidate experimental point of the attention level X=1 and the candidate experimental point of the attention level X=3 and time t at which the experiment with the experiment number n=5 is performed.

$$\begin{matrix}[ Math . 27 ] & \\ {\hat{σ}}_{x , t}^{2} ( 1 , 9 ) = \frac{1}{0 . {2}^{2} + 0.0 {3}^{2} + 0.4 {9}^{2} + 0.1 {6}^{2}} \times \{ 0 . {2}^{2} \cdot {( 1.141471 - 1.2551 )}^{2} + 0.0 {3}^{2} \cdot {( 2. 455979 - 2.5308 )}^{2} + 0.4 {9}^{2} \cdot {( 0.443198 - 0.5802 )}^{2} + 0.1 {6}^{2} \cdot {( 3. 112118 - 2.9941 )}^{2} \} = 0.017562 … \\ {\hat{σ}}_{x , t}^{2} ( 3 , 9 ) = \frac{1}{0.1 {6}^{2} + 0.0 {9}^{2} + 0.6 {3}^{2} + 0.3 {2}^{2}} \times \{ 0.1 {6}^{2} \cdot {( 1. 141471 - 1.2551 )}^{2} + {0.09}^{2} \cdot {( 2. 455979 - 2.5308 )}^{2} + 0.6 {3}^{2} \cdot {( 0.443198 - 0.5802 )}^{2} + 0.3 {2}^{2} \cdot {( 3. 112118 - 2.9941 )}^{2} \} = 0.0 \; 17358 … & ( Formula 20 )\end{matrix}$$

Evaluation value calculator 12 also calculates error variance σ² for the other candidate experimental points except the candidate experimental point of the attention level X=1 and the candidate experimental point of the attention level X=3 and time t at which the experiment with the experiment number n=5 is performed in the same manner as described above. Then, evaluation value calculator 12 uses error variance σ² calculated for the candidate experimental points for (Formula 1-2) and (Formula 2-2) to calculate the mean and variance of the predicted distribution for each candidate experimental point that is a candidate for the experimental point used in the experiment with the experiment number n=5. That is, evaluation value calculator 12 updates predicted distribution data 223. Then, evaluation value calculator 12 calculates the evaluation value based on the EHVI of each candidate experimental point by applying the mean and variance of the predicted distribution indicated by predicted distribution data 223 to (Formula 3) described above. As a result, evaluation value calculator 12 updates evaluation value data 224. As a result, for example, evaluation value data 224 illustrated in FIG. 45 is obtained.

Arithmetic circuit 102 adopts the candidate experimental point of the level X=8 associated with the rank “1” indicated in evaluation value data 224 illustrated in FIG. 45, that is, the level X=8 associated with the maximum evaluation value as the experimental point used for the next experiment. The next experiment is the experiment identified by experiment number n=5. Then, arithmetic circuit 102 writes the level X=8 in experimental result data 222 illustrated in FIG. 41 in association with time t-9 and the experiment number n=5. When objective characteristic value Y “3.389358” that is the experimental result is obtained by the experiment with the experiment number n=5, arithmetic circuit 102 acquires characteristic point data 201 indicating objective characteristic value Y “3.389358” as the characteristic point, and writes objective characteristic value Y “3.389358” in experimental result data 222. That is, arithmetic circuit 102 writes objective characteristic value Y “3.389358” in experimental result data 222 illustrated in FIG. 41 in association with the experiment number n=5, time t=9, and the level X=8. As a result, experimental result data 222 indicates time t at which each experiment with the experiment number n=1 to 5 was performed, level X used in these experiments, and objective characteristic value Y obtained by these experiments.

Next, evaluation device 100 estimates error variance σ² used for searching for the level of the control factor (i.e., experimental point) used in the experiment with the experiment number n=6 based on the experimental result of each experiment with the experiment number n=1 to 5. The specific description is as follows: Note that the experiment with the experiment number n=6 is performed at time t=12.

First, evaluation value calculator 12 derives weight W_{X,t} for level X′ used in each experiment with the experiment number n=1 to 5 for each candidate experimental point (i.e., attention level X) and time t at which each experiment was performed based on the weight distribution indicated by weight distribution data 213.

For example, evaluation value calculator 12 derives weight Wx for level X′ used in each experiment with the experiment number n=1 to 5 at the attention level X=6 based on weight distribution W_{X} (X′) illustrated in part (a) of FIG. 27. Level X′ used in each experiment with the experiment number n=1 to 5 is “1, 10, 4, 9, 8”. That is, evaluation value calculator 12 derives weights Wx=0.5, 0.6, 0.8, 0.7, 0.8 for levels X′=1, 10, 4, 9, 8, respectively. In addition, evaluation value calculator 12 derives weight Wx for level X′ used in each experiment with the experiment number n=1 to 4 at the attention level X=10 based on the weight distribution illustrated in part (b) of FIG. 27. That is, evaluation value calculator 12 derives weights Wₓ=0.1, 1.0, 0.4, 0.9, 0.8 for levels X′=1, 10, 4, 9, 8, respectively.

Furthermore, evaluation value calculator 12 derives weight Wt for time t at which each experiment with the experiment number n=1 to 5 was performed based on weight distribution Wₜ (t) illustrated in FIG. 46. Time t at which each experiment with the experiment number n=1 to 5 was performed is “1, 2, 6, 7, 9”. That is, evaluation value calculator 12 derives weights Wₜ=0, 0, 0.4, 0.5, 0.7 for times t=1, 2, 6, 7, 9, respectively.

As a result, evaluation value calculator 12 calculates weight W_{X,t} for level X′ and time t at the attention level X=6 according to (Formula 19). That is, evaluation value calculator 12 calculates “0.5×0)=0” as weight W_{X,t} for the level X′=1 and time t=1, and calculates “0.6×0=0” as weight W_{X,t} for the level X′=10 and time t=2. Evaluation value calculator 12 calculates “0.8×0.4=0.32” as weight W_{X,t} for the level X′=4 and time t=6, and calculates “0.7×0.5=0.35” as weight W_{X,t} for the level X′=9 and time t=7. Furthermore, evaluation value calculator 12 calculates “0.8×0.7=0.56” as weight W_{X,t} for the level X′=8 and time t=9.

Similarly, evaluation value calculator 12 calculates weight W_{X,t} for the level X′ and time t at the attention level X=10 according to (Formula 19). That is, evaluation value calculator 12 calculates “0.1×0-0” as weight W_{X,t} for the level X′=1 and time t=1, and calculates “1.0×0=0” as weight W_{X,t} for the level X′=10 and time t=2. Evaluation value calculator 12 calculates “0.4×0.4=0.16” as weight W_{X,t} for the level X′=4 and time t=6, and calculates “0.9×0.5=0.45” as weight W_{X,t} for the level X′=9 and time t=7. Furthermore, evaluation value calculator 12 calculates “0.8×0.7=0.56” as weight W_{X,t} for the level X′=8 and time t=9.

When the experimental point (i.e., level X) used in the experiment with the experiment number n=5 is selected, evaluation value calculator 12 has already calculated the predicted mean at each candidate experimental point based on (Formula 1-2) as illustrated in FIG. 47. These predicted means are shown, for example, in predicted distribution data 223. Evaluation value calculator 12 calculates error variance σ² included in (Formula 1-2) and (Formula 2-2) using the predicted means as the above-described reference points. Specifically, evaluation value calculator 12 calculates, for example, error variance σ² for each of the attention level X=6 and the attention level X=10 and time t at which the experiment with the experiment number n=6 is performed (i.e., current time t_{now}=12) as in the following (Formula 21) based on (Formula 18). In other words, evaluation value calculator 12 calculates error variance σ² for each of the candidate experimental point of the attention level X=6 and the candidate experimental point of the attention level X=10 and time t at which the experiment with the experiment number n=6 is performed.

$$\begin{matrix}[ Math . 28 ] & \\ {\hat{σ}}_{x , t}^{2} ( 6 , 12 ) = \frac{1}{0.3 {2}^{2} + 0.3 {5}^{2} + 0.5 {6}^{2}} \times \{ 0.3 {2}^{2} \cdot {( 0. 443198 - 0.4802 )}^{2} + 0.3 {5}^{2} \cdot {( 3. 112118 - 3.0972 )}^{2} + 0.5 {6}^{2} \cdot {( 3.389358 - 3.3403 )}^{2} \} = 0.0 \; 01713 … \\ {\hat{σ}}_{x , t}^{2} ( 10 , 12 ) = \frac{1}{0.1 {6}^{2} + 0.4 {5}^{2} + 0.5 {6}^{2}} \times \{ 0.1 {6}^{2} \cdot {( 0. 443198 - 0.4802 )}^{2} + 0.4 {5}^{2} \cdot {( 3. 112118 - 3.0972 )}^{2} + 0.5 {6}^{2} \cdot {( 3.389358 - 3.3403 )}^{2} \} = 0.0 \; 01541 … & ( Formula 21 )\end{matrix}$$

Evaluation value calculator 12 also calculates error variance σ² for the other candidate experimental points except the candidate experimental point of the attention level X=6 and the candidate experimental point of the attention level X=10 and time t at which the experiment with the experiment number n=6 is performed in the same manner as described above. Then, evaluation value calculator 12 uses error variance σ² calculated for the candidate experimental points for (Formula 1-2) and (Formula 2-2) to calculate the mean and variance of the predicted distribution for each candidate experimental point that is a candidate for the experimental point used in the experiment with the experiment number n=6. That is, evaluation value calculator 12 updates predicted distribution data 223. Then, evaluation value calculator 12 calculates the evaluation value based on the EHVI of each candidate experimental point by applying the mean and variance of the predicted distribution indicated by predicted distribution data 223 to (Formula 3) described above. As a result, evaluation value calculator 12 updates evaluation value data 224. As a result, for example, evaluation value data 224 illustrated in FIG. 48 is obtained.

Arithmetic circuit 102 adopts the candidate experimental point of the level X=7 associated with the rank “1” indicated in evaluation value data 224 illustrated in FIG. 48, that is, level X=7 associated with the maximum evaluation value as the experimental point used for the next experiment. The next experiment is the experiment identified by experiment number n=6. Then, arithmetic circuit 102 writes the level X=7 in experimental result data 222 illustrated in FIG. 41 in association with time t=12 and the experiment number n=6. When objective characteristic value Y “2.756987” that is the experimental result is obtained by the experiment with the experiment number n=6, arithmetic circuit 102 acquires characteristic point data 201 indicating objective characteristic value Y “2.756987” as the characteristic point, and writes objective characteristic value Y “2.756987” in experimental result data 222. That is, arithmetic circuit 102 writes objective characteristic value Y “2.756987” in experimental result data 222 illustrated in FIG. 41 in association with the experiment number n=6, time t=12, and the level X=7. As a result, experimental result data 222 indicates time t at which each experiment with the experiment number n=1 to 6 was performed, level X used in these experiments, and objective characteristic value Y obtained by these experiments.

By repeating the processing as described above, every time experiment number n is incremented, evaluation device 100 writes time t, level X, and objective characteristic value Y in experimental result data 222 in association with experiment number n. As a result, it is possible to perform an advanced optimization search in consideration of error variance σ² depending on the level space and time.

### Example 2 of Third Exemplary Embodiment

Experimental result data 222 in Example 2 of the present exemplary embodiment is, for example, the same as experimental result data 222 illustrated in FIG. 49.

experimental result data 222 indicates, for each experiment number n, time t at which the experiment identified by the experiment number n was performed, experimental points used in the experiment, and characteristic points obtained by the experiment. Note that in Example 2, the experimental point is expressed by level X1 of the first control factor and level X2 of the second control factor, and the characteristic point is expressed by objective characteristic value Y1 of the first objective characteristic and objective characteristic value Y2 of the second objective characteristic. That is, in Example 2, the number of dimensions of the control factor is two, and the number of dimensions of the objective characteristic is also two. Level X1 and level X2 may each take an integer of 1 to 10. The optimization objective of each of objective characteristic value Y1 and objective characteristic value Y2 is, for example, maximization.

For example, experimental result data 222 illustrated in FIG. 49 indicates that the experiment with the experiment number n=1 was performed at time t=1, “1” and “1” were used as level X1 and level X2, respectively, in the experiment, and “2.282942” and “1.4375” were obtained as objective characteristic value Y1 and objective characteristic value Y2, respectively. Furthermore, experimental result data 222 indicates that the experiment with the experiment number n=2 was performed at time t=2, “1” and “10” were used as level X1 and level X2, respectively, in the experiment, and “3.59745” and “1.71875” were obtained as objective characteristic value Y1 and objective characteristic value Y2, respectively.

Furthermore, the weight distribution in the present exemplary embodiment is defined by the above-described (Formula 19). That is, the weight distribution for each candidate experimental point with respect to the first objective characteristic is defined as W_{1;X,t} (X′, tₙ)=W_{1;X}(X′)W_{1;t} (tₙ). The weight distribution for each candidate experimental point with respect to the second objective characteristic is defined as W_{2;X,t} (X′, tₙ)=W_{2;X} (X′) W_{2;t} (tₙ). W_{1;X}(X′) and W_{2;X}(X′) are weight distributions depending on the level space, and is defined by (Formula 8) and (Formula 9) for each candidate experimental point (X1, X2) as in Example 2 of the first exemplary embodiment. In addition, W_{1;t} (tₙ) and W_{2;t} (tₙ) are weight distributions depending on time and are defined as W_{1;t} (t)=max {1−0.1|t_{now}−t|, 0)} and W_{2;t}(t)=max {1−0.2|t_{now}−t|,0)} as in Example 2 of the second exemplary embodiment.

Here, a flow of processing when searching for an optimal solution of an objective characteristic by sequentially repeating experiments according to experiment number n of experimental result data 222 illustrated in FIG. 49 will be described.

For example, it is assumed that at the present time, each experiment with the experiment number n=1 to 9 illustrated in FIG. 49 is performed, and the experimental results (i.e., objective characteristic values Y1 and Y2) have already been obtained by the experiments. For example, the experiment with the experiment number n=1 is performed at time t=1, the experiment with the experiment number n=2 is performed at time t=2, the experiment with the experiment number n=3 is performed at time t=6, and the experiment with the experiment number n=4 is performed at time t=7. In this case, evaluation device 100 estimates error variance σ² used for searching for the level of the control factor (i.e., experimental point) used in the experiment with the experiment number n=10 based on the experimental result of each experiment with the experiment number n=1 to 9. Note that error variance 2 is an error variance represented by (Formula 18). The experiment with the experiment number n=10 is performed at time t=21.

Specifically, first, evaluation value calculator 12 calculates, for each candidate experimental point (X1, X2), weight W_{1;X} of the first objective characteristic and weight W_{2;X} of the second objective characteristic for the experimental point (X1′, X2″) used in each experiment with the experiment number n=1 to 9 based on the weight distribution indicated by weight distribution data 213. For example, as in Example 2 of the first exemplary embodiment, as weight W_{1;X} for each experimental point in candidate experimental point (X1, X2)=(1, 1), evaluation value calculator 12 calculates “1.0, 0.1, 0.1, 0.01, 0.12, 0.15, 0.16, 0.15, 0.2” based on (Formula 8). Furthermore, for example, as weight W_{2;x} for each experimental point in candidate experimental point (X1, X2)=(1, 1), evaluation value calculator 12 calculates “1.0, 0.1, 0.1, 0.05263, 0.07143, 0.07692, 0.07692, 0.07692, 0.08333” based on (Formula 9).

Furthermore, evaluation value calculator 12 calculates weight W_{1;t} of the first objective characteristic and weight W_{2;t} of the second objective characteristic for time t at which each experiment with the experiment number n=1 to 9 was performed based on the weight distribution indicated by weight distribution data 213. For example, as in Example 2 of the second exemplary embodiment, as weight W_{1;t} for time t at which each experiment was performed, evaluation value calculator 12 calculates “0, 0, 0, 0, 0, 0.1, 0.2, 0.6, 0.8” based on W_{1;t} (t)=max {1−0.1|t_{now}−t|, 0}. In addition, for example, as weight W_{2;t} for time t at which each experiment was performed, evaluation value calculator 12 calculates “0, 0, 0, 0, 0, 0, 0, 0.2, 0.6” based on W_{2;t} (t)=max {1−0.2|t_{now}−t|, 0}.

Then, evaluation value calculator 12 calculates weight W_{1;X,t} of the first objective characteristic with respect to the experimental point (X1′, X2′) used in each experiment with the experiment number n=1 to 9 and time t at which the experiment was performed in candidate experimental point (X1, X2)=(1, 1) according to W_{1;X,t}=W_{1;X}×W_{1;t}. Their weights W_{1;X,t} are calculated as “1.0×0=0, 0.1×0=0, 0.1×0=0, 0.01×0=0, 0.12×0=0, 0.15×0.1=0.015, 0.16×0.2=0.032, 0.15×0.6=0.09, 0.2×0.8=0.16”. Furthermore, evaluation value calculator 12 also calculates W_{2;X,t} of the second objective characteristic as with W_{1;X,t} of the first objective characteristic. Specifically, evaluation value calculator 12 calculates weight W_{2;X,t} of the second objective characteristic with respect to the experimental point (X1′, X2′) used in each experiment with the experiment number n=1 to 9 and time t at which the experiment was performed in candidate experimental point (X1, X2)=(1, 1) according to W_{2;X,t}=W_{2;X}×W_{2;t}. Their weights W_{2;X,t} are calculated as “1.0×0=0, 0.1×0=0, 0.1×0=0, 0.05263×0×0, 0.07143×0=0, 0.07692×0=0, 0.07692×0=0, 0.07692×0.2=0.015384, 0.08333×0.6=0.05”.

When the experimental point (i.e., level X1 and level X2) used in the experiment with the experiment number n=9 is selected, evaluation value calculator 12 has already calculated the predicted mean at each candidate experimental point based on (Formula 1-2) as illustrated in FIG. 31. These predicted means are shown, for example, in predicted distribution data 223. Evaluation value calculator 12 calculates error variance σ² included in (Formula 1-2) and (Formula 2-2) using the predicted means as the above-described reference points. Specifically, evaluation value calculator 12 calculates, for example, error variance σ² for the candidate experimental point expressed by the set of attention levels (X1, X2)=(1, 1) and time t at which the experiment with the experiment number n=10 is performed (i.e., current time t_{now}=21) based on (Formula 18) as in the following (Formula 22a) and (Formula 22b). In other words, evaluation value calculator 12 calculates error variance σ² of each of the first objective characteristic and the second objective characteristic with respect to the candidate experimental point (X1, X2)=(1, 1) and time t at which the experiment with the experiment number n=10 is performed. Note that (Formula 22a) represents error variance σ² of the first objective characteristic, and (Formula 22b) represents error variance σ² of the second objective characteristic.

$$\begin{matrix}[ Math . 29 ] & \\ {\hat{σ}}_{1 ; x , t}^{2} ( 1 , 1 , 21 ) = \frac{1}{0.01 {5}^{2} + 0.03 {2}^{2} + 0.0 {9}^{2} + 0.1 {6}^{2}} \times \{ 0.01 {5}^{2} \cdot {( 4. 909943 - 4.8649 )}^{2} + 0.03 {2}^{2} \cdot {( 5. 513973 - 5.5164 )}^{2} + 0.0 {9}^{2} \cdot {( 4.909943 - 4.9671 )}^{2} + 0.1 {6}^{2} \cdot {( 4. 277571 - 4.2327 )}^{2} \} = 0.002245 … & ( Formula 22 a )\end{matrix}$$

$${\hat{σ}}_{2 ; x , t}^{2} ( 1 , 1 , 21 ) = \frac{1}{0.01538 {4}^{2} + 0.0 {5}^{2}} \times \{ 0.01538 {4}^{2} \cdot {( 2. 875 - 2.9324 )}^{2} + 0.0 {5}^{2} \cdot {( 2. 96875 - 2.9232 )}^{2} \} = 0.00218 … \qquad ( Formula 22 b )$$

Evaluation value calculator 12 also calculates error variance σ² for the other candidate experimental points except candidate experimental point (X1, X2)=(1, 1) and time t at which the experiment with the experiment number n=10 is performed in the same manner as described above. Then, evaluation value calculator 12 uses error variance σ² calculated for the candidate experimental points for (Formula 1-2) and (Formula 2-2) to calculate the mean and variance of the predicted distribution for each candidate experimental point that is a candidate for the experimental point used in the experiment with the experiment number n=10 for each dimension of the objective characteristic. That is, evaluation value calculator 12 updates predicted distribution data 223. Then, evaluation value calculator 12 calculates the evaluation value based on the EHVI of each candidate experimental point by applying the mean and variance of the predicted distribution indicated by predicted distribution data 223 to (Formula 3) described above. As a result, evaluation value calculator 12 updates evaluation value data 224. As a result, for example, evaluation value data 224 illustrated in FIG. 32 is obtained.

Arithmetic circuit 102 adopts the candidate experimental point of the set of attention levels (X1, X2)=(7, 6) associated with the rank “1” indicated in evaluation value data 224 illustrated in FIG. 32, that is, candidate experimental point (X1, X2)=(7, 6) associated with the maximum evaluation value as the experimental point used for the next experiment. The next experiment is the experiment identified by experiment number n=10. Then, arithmetic circuit 102 writes the set of levels (X1, X2)=(7, 6) in experimental result data 222 illustrated in FIG. 49 in association with time t=21 and the experiment number n=10. When the set of objective characteristic values (Y1, Y2)=(4.277571, 2.96875) that is the experimental result is obtained by the experiment with the experiment number n=10, arithmetic circuit 102 acquires characteristic point data 201 indicating the set of objective characteristic values (Y1, Y2)=(4.277571, 2.96875) as the characteristic point, and writes the set of objective characteristic values (Y1, Y2)=(4.277571,2.96875) in experimental result data 222. That is, arithmetic circuit 102 writes the set of objective characteristic values (Y1, Y2)=(4.277571, 2.96875) in experimental result data 222 illustrated in FIG. 49 in association with the experiment number n=10, time t=21, and the set of levels (X1, X2)=(7,6). As a result, experimental result data 222 indicates time t at which each experiment with the experiment number n=1 to 10 was performed, the set of levels (X1, X2) used in these experiments, and the set of objective characteristic values (Y1, Y2) obtained by these experiments.

Next, evaluation device 100 estimates error variance σ² used for searching for the level of the control factor (i.e., experimental point) used in the experiment with the experiment number n=11 based on the experimental result of each experiment with the experiment number n=1 to 10. The specific description is as follows: Note that the experiment with the experiment number n=11 is performed at time t=25.

First, evaluation value calculator 12 calculates, for each candidate experimental point (X1, X2), weight W_{1;X} of the first objective characteristic and weight W_{2;X} of the second objective characteristic for the experimental point (X1′, X2′) used in each experiment with the experiment number n=1 to 10 based on the weight distribution indicated by weight distribution data 213. For example, as in Example 2 of the first exemplary embodiment, as weight W_{1;X} for each experimental point in candidate experimental point (X1, X2)=(5, 8), evaluation value calculator 12 calculates “0.18, 0.48, 0.15, 0.4, 0.8, 0.56, 0.72, 0.9, 0.81, 0.64” based on (Formula 8). Furthermore, for example, as weight W_{2;X} for each experimental point in candidate experimental point (X1, X2)=(5, 8), evaluation value calculator 12 calculates “0.08333, 0.14286, 0.76923, 0.125, 0.33333, 0.16667, 0.25, 0.5, 0.33333, 0.2” based on (Formula 9).

Furthermore, evaluation value calculator 12 calculates weight W_{1;t} of the first objective characteristic and weight W_{2;t} of the second objective characteristic for time t at which each experiment with the experiment number n=1 to 10 was performed based on the weight distribution indicated by weight distribution data 213. For example, as in Example 2 of the second exemplary embodiment, as weight W_{1;t} for time t at which each experiment was performed, evaluation value calculator 12 calculates “0, 0, 0, 0, 0, 0, 0, 0.2, 0.4, 0.6” based on W_{1;t} (t)=max {1−0.1|t_{now}−t|, 0}. In addition, for example, as weight W_{2;t}, evaluation value calculator 12 calculates “0, 0, 0, 0, 0, 0, 0, 0, 0, 0.2” based on W_{2;t} (t)=max {1−0.2|t_{now}−t|, 0}.

Then, evaluation value calculator 12 calculates weight W_{1;X,t} of the first objective characteristic with respect to the experimental point (X1′, X2′) used in each experiment with the experiment number n=1 to 10 and time t at which the experiment was performed in candidate experimental point (X1, X2)=(5, 8) according to W_{1;X,t}=W_{1;X}×W_{1;t}. Their weights W_{1;X,t} are calculated as “0.18×0=0, 0.48×0=0, 0.15×0=0, 0.4×0=0, 0.8×0=0, 0.56×0=0, 0.72×0=0, 0.9×0.2=0.18, 0.81×0.4=0.324, 0.64×0.6=0.384”. Furthermore, evaluation value calculator 12 also calculates W_{2;X,t} of the second objective characteristic as with W_{1;X,t} of the first objective characteristic. Specifically, evaluation value calculator 12 calculates weight W_{2;X,t} of the second objective characteristic with respect to the experimental point (X1′, X2′) used in each experiment with the experiment number n=1 to 10 and time t at which the experiment was performed in candidate experimental point (X1, X2)=(5,8) according to W_{2;X,t}=W_{2;X}×W_{2;t}. Their weights W_{2;X,t} are calculated as “0.08333×0-0, 0.14286×0=0, 0.76923×0=0, 0.125×0=0, 0.33333×0=0, 0.16667×0=0, 0.25×0=0, 0.5×0=0, 0.33333×0=0, 0.2×0.2=0.04”.

When the experimental point (i.e., level X1 and level X2) used in the experiment with the experiment number n=10 is selected, evaluation value calculator 12 has already calculated the predicted mean at each candidate experimental point based on (Formula 1-2) as illustrated in FIG. 33. These predicted means are shown, for example, in predicted distribution data 223. Evaluation value calculator 12 calculates error variance σ² included in (Formula 1-2) and (Formula 2-2) using the predicted means as the above-described reference points. Specifically, evaluation value calculator 12 calculates, for example, error variance σ² for the candidate experimental point expressed by the set of attention levels (X1, X2)=(5, 8) and time t at which the experiment with the experiment number n=11 is performed (i.e., current time t_{now}=25) based on (Formula 18) as in the following (Formula 23a) and (Formula 23b). In other words, evaluation value calculator 12 calculates error variance σ² of each of the first objective characteristic and the second objective characteristic with respect to the candidate experimental point (X1, X2)=(5, 8) and time t at which the experiment with the experiment number n=11 is performed. Note that (Formula 23a) represents error variance σ² of the first objective characteristic, and (Formula 23b) represents error variance σ² of the second objective characteristic.

$$\begin{matrix}[ Math . 30 ] & \\ {\hat{σ}}_{1 ; x , t}^{2} ( 5 , 8 , 25 ) = \frac{1}{0.1 {8}^{2} + 0.32 {4}^{2} + 0.38 {4}^{2}} \times \{ 0.1 {8}^{2} \cdot {( 4. 909943 - 4.9827 )}^{2} + 0.32 {4}^{2} \cdot {( 4. 277571 - 4.2278 )}^{2} + 0.38 {4}^{2} \cdot {( 4.277571 - 4.1753 )}^{2} \} = 0.00692 … & ( Formula 23 a )\end{matrix}$$

$${\hat{σ}}_{2 ; x , t}^{2} ( 5 , 8 , 25 ) = \frac{1}{0.0 {4}^{2}} \times \{ 0.0 {4}^{2} \cdot {( 2. 96875 - 2.8977 )}^{2} \} = 0.00205 … \qquad ( Formula 23 b )$$

Evaluation value calculator 12 also calculates error variance σ² for the other candidate experimental points except candidate experimental point (X1, X2)=(5, 8) and time t at which the experiment with the experiment number n=11 is performed in the same manner as described above. Then, evaluation value calculator 12 uses error variance σ² calculated for the candidate experimental points for (Formula 1-2) and (Formula 2-2) to calculate the mean and variance of the predicted distribution for each candidate experimental point that is a candidate for the experimental point used in the experiment with the experiment number n=11 for each dimension of the objective characteristic. That is, evaluation value calculator 12 updates predicted distribution data 223. Then, evaluation value calculator 12 calculates the evaluation value based on the EHVI of each candidate experimental point by applying the mean and variance of the predicted distribution indicated by predicted distribution data 223 to (Formula 3) described above. As a result, evaluation value calculator 12 updates evaluation value data 224. As a result, for example, evaluation value data 224 illustrated in FIG. 34 is obtained.

Arithmetic circuit 102 adopts the candidate experimental point of the set of attention levels (X1, X2)=(8, 7) associated with the rank “1” indicated in evaluation value data 224 illustrated in FIG. 34, that is, candidate experimental point (X1, X2)=(8, 7) associated with the maximum evaluation value as the experimental point used for the next experiment. The next experiment is the experiment identified by experiment number n=11. Then, arithmetic circuit 102 writes the set of levels (X1, X2)=(8, 7) in experimental result data 222 illustrated in FIG. 49 in association with time t=25 and the experiment number n=11. When the set of objective characteristic values (Y1, Y2)=(6.146345, 2.84375) that is the experimental result is obtained by the experiment with the experiment number n=11, arithmetic circuit 102 acquires characteristic point data 201 indicating the set of objective characteristic values (Y1, Y2)=(6.146345, 2.84375) as the characteristic point, and writes the set of objective characteristic values (Y1, Y2)=(6.146345, 2.84375) in experimental result data 222. That is, arithmetic circuit 102 writes the set of objective characteristic values (Y1, Y2)=(6.146345, 2.84375) in experimental result data 222 illustrated in FIG. 49 in association with the experiment number n=11, time t=25, and the set of levels (X1, X2)=(8, 7). As a result, experimental result data 222 indicates time t at which each experiment with the experiment number n=1 to 11 was performed, the set of levels (X1, X2) used in these experiments, and the set of objective characteristic values (Y1, Y2) obtained by these experiments.

By repeating the processing as described above, every time experiment number n is incremented, evaluation device 100 writes time t, the set of levels (X1, X2), and the set of objective characteristic values (Y1, Y2) in experimental result data 222 in association with experiment number n. As a result, it is possible to perform an advanced optimization search in consideration of error variance σ² depending on the level space and time.

As described above, in the present exemplary embodiment, error variance σ² that changes depending on the level space and time is estimated, and the experimental condition is evaluated by Bayesian optimization using error variance σ². Therefore, even in an environment where error variance σ² changes, the experimental conditions can be quantitatively evaluated with high accuracy. That is, conventionally, a quantitative determination method for error variance σ² is not shown, and a fixed value such as “1” is generally used for error variance σ². Therefore, error variance σ² is universally handled, and there is a possibility that the actual phenomenon is not fully reflected in error variance σ². However, in the present exemplary embodiment, since a plurality of non-universal error variances σ² different from each other are estimated in the level space and time and used for Bayesian optimization, highly accurate evaluation can be performed. As a result, in the present exemplary embodiment, it is possible to provide evaluation device 100 to which the Bayesian optimization capable of quantitatively responding to a change is applied while estimating error variance σ².

### Summary of Third Exemplary Embodiment

As described above, evaluation device 100 according to the present exemplary embodiment is a device that evaluates a plurality of unknown characteristic points corresponding to a plurality of candidate experimental points by Bayesian optimization based on known characteristic points corresponding to experimented experimental points. Such evaluation device 100 includes a first reception means that acquires experimental result data 222 indicating experimented experimental points and known characteristic points, and a second reception means that acquires, in a case where each of the plurality of unknown characteristic points and known characteristic points is expressed by one or more values of objective characteristics, objective data 212 indicating an optimization objective of each of one or more objective characteristics. The first reception means and the second reception means are included in reception controller 10 in FIG. 4. In addition, evaluation device 100 includes a calculation means that estimates a plurality of error variances σ² that are variances of observation errors of characteristic points and are different from each other, and calculates evaluation values of a plurality of unknown characteristic points based on experimental result data 222, objective data 212, and the plurality of error variances σ², and an output means that outputs the evaluation values. The calculation means and the output means correspond to evaluation value calculator 12 and evaluation value output unit 13 in FIG. 4, respectively. In addition, in a case where evaluation of a plurality of unknown characteristic points corresponding to a plurality of candidate experimental points is repeatedly performed by performing an experiment at each of a plurality of times, the calculation means estimates a plurality of error variances σ² different from each other for the plurality of candidate experimental points and different from each other for the plurality of times.

As a result, in the case where the experiment is repeated at the plurality of times, each of the plurality of candidate experimental points is evaluated by the evaluation value as the experimental condition using the plurality of error variances σ² different from each other for the times. Furthermore, each of the plurality of candidate experimental points is evaluated using a plurality of error variances σ² different from each other. Therefore, it is possible to increase the possibility of bringing the plurality of error variances σ² close to the variance of the observation error according to the actual experiment. That is, it is possible to increase the possibility that appropriate error variance σ² according to the candidate experimental point can be used for each of the plurality of candidate experimental points. Therefore, the experimental conditions can be evaluated with higher accuracy than the case of using the same error variance for a plurality of candidate experimental points. In addition, it is possible to increase the possibility that appropriate error variance σ² according to time can be used for each of a plurality of times. Therefore, the experimental conditions can be evaluated with higher accuracy than the case of using the same error variance for the plurality of times.

In addition, the calculation means in the present exemplary embodiment calculates a predicted distribution for each of a plurality of candidate experimental points by using, at each of a plurality of times, error variance σ² corresponding to the time and each of the plurality of candidate experimental points among a plurality of error variances σ² for the Gaussian process regression, and calculates evaluation values of the plurality of unknown characteristic points by using the calculated predicted distribution.

As a result, since error variance σ² corresponding to the candidate experimental point and time is used for the Gaussian process regression, the accuracy of the predicted distribution at the candidate experimental point and time can be improved. Therefore, the experimental conditions can be evaluated with higher accuracy.

In addition, the calculation means in the present exemplary embodiment acquires a first weight distribution defined depending on a space in which a plurality of candidate experimental points and experimented experimental points are arranged and a second weight distribution defined depending on time. Then, when estimating each of the plurality of error variances σ², the calculation means estimates error variance σ² based on the product of first weight Wx and second weight Wt. First weight Wx is a weight associated with the position of the experimented experimental point in the space among the plurality of weights indicated by the first weight distribution. Second weight Wt is a weight associated with the time at which the experiment using the experimented experimental point was performed among the plurality of weights indicated by the second weight distribution.

As a result, in the first weight distribution, first weight Wx associated with the experimented experimental point can be used as a reference degree for the observation error of the known characteristic point obtained by the experiment using the experimented experimental point. Furthermore, in a second weight distribution, second weight Wt associated with the time at which the experiment was performed can be used as a reference degree for the observation error of the known characteristic point obtained by the experiment. Then, error variance σ² is estimated based on the product of first weight Wx and second weight Wt. Therefore, error variance σ² for the candidate experimental point and the time at which the experiment using the candidate experimental point is performed can be estimated by using only the product of such an observation error. That is, error variance σ² for the candidate experimental point and the time at which the experiment using the candidate experimental point is performed can be estimated using the known characteristic point. As a result, the experimental conditions can be evaluated effectively with high accuracy.

In addition, in the present exemplary embodiment, when each of the experimented experimental point and the plurality of candidate experimental points is expressed by the level of two or more control factors, the calculation means acquires a first weight distribution for the control factor of each of the two or more control factors as a first weight distribution. Then, when estimating each of the plurality of error variances σ², the calculation means estimates error variance σ² using, as first weight Wx, the product of weights associated with positions in a space of the experimented experimental points in first weight distributions of two or more control factors. For example, the product of the weight for the first control factor and the weight for the second control factor is used as first weight Wx.

As a result, in a case where each of the experimented experimental point and the one or more candidate experimental points is expressed by two-dimensional or more control factors, the product of the weights included in the spatial weight distribution corresponding to the control factors is used as first weight Wx to estimate error variance σ². Therefore, even in such a case, the experimental conditions can be evaluated with high accuracy.

In addition, in the present exemplary embodiment, when each of the unknown plurality of characteristic points and the known characteristic point is expressed by two or more objective characteristic values, the calculation means estimates error variance σ² for each of the two or more objective characteristics by using the objective characteristic value of the known characteristic point.

As a result, even when each of the unknown plurality of characteristic points and the known characteristic point is expressed by two or more objective characteristic values, that is, even when each of the unknown plurality of characteristic points and the known characteristic point is expressed by two-dimensional or more objective characteristic values, error variance σ² is estimated for each objective characteristic. Therefore, even in such a case, the experimental conditions can be evaluated with high accuracy.

While evaluation device 100 according to an aspect of the present disclosure has been described above based on the exemplary embodiments, the present disclosure is not limited to the exemplary embodiments. Various modifications made on the above exemplary embodiments by those skilled in the art may be included in the present disclosure, as long as such modifications do not depart from the spirit of the present disclosure.

For example, in the first to third exemplary embodiments, a plurality of non-universal error variances σ² different from each other are used for Gaussian process regression. However, without being limited to the Gaussian process regression, the plurality of error variances σ² may be applied to the Kalman filter. Even in this case, similarly to the first to third exemplary embodiments, error variance σ² may be estimated using the weight distribution depending on the level space, the weight distribution depending on time, the weight distribution depending on the level space and time, and the like.

In the first to third exemplary embodiments, the mean of the predicted distribution before one iteration processing is used as the reference point used for calculation of error variance σ². However, the reference point is not limited to the mean of the predicted distribution, and may be, for example, a mean of objective characteristic values obtained by a plurality of experiments using the same experimental point.

Note that in each exemplary embodiment described above, each constituent element may be implemented by dedicated hardware or by executing a software program suitable for each constituent element. Each constituent element may be implemented by a program executor such as a CPU or a processor reading and executing a software program recorded in a recording medium such as a hard disk or a semiconductor memory. Here, the software that implements the evaluation device and the like of the above-described exemplary embodiments is a program that causes a computer to execute each step of the flowchart illustrated in FIG. 8, for example.

Note that the following cases are also included in the present disclosure.

(1) The at least one device is specifically a computer system including a microprocessor, a read only memory (ROM), a random access memory (RAM), a hard disk unit, a display, a keyboard, a mouse, and the like. The RAM or the hard disk unit stores a computer program. The microprocessor operates in accordance with the computer program, whereby the at least one device achieves its functions. Here, the computer program is configured by combining a plurality of instruction codes indicating commands to the computer in order to achieve a predetermined function.

(2) A part or all of the constituent elements constituting the at least one device may include one system large scale integration (LSI). The system LSI is a super multifunctional LSI manufactured by integrating a plurality of components on one chip, and is specifically a computer system including a microprocessor, a ROM, a RAM, and the like. The RAM stores a computer program. By the microprocessor operating in accordance with the computer program, the system LSI achieves its functions.

(3) Some or all of the constituent elements constituting the at least one device may include an IC card detachable from the device or a single module. The IC card or the module is a computer system including a microprocessor, a ROM, a RAM, and the like. The IC card or the module may include the above-described super multifunctional LSI. The microprocessor operates in accordance with the computer program, whereby the IC card or the module achieves its function. The IC card or the module may have tamper resistance.

(4) The present disclosure may be the methods described above. In addition, the present disclosure may be a computer program causing a computer to implement these methods, or may be a digital signal including a computer program.

Furthermore, the present disclosure may be a computer program or a digital signal recorded in a computer-readable recording medium such as a flexible disk, a hard disk, a compact disc (CD)-ROM, a DVD, a DVD-ROM, a DVD-RAM, a Blu-ray (registered trademark) disc (BD), or a semiconductor memory. In addition, the present disclosure may be a digital signal recorded in these recording media.

Furthermore, the present disclosure may be a computer program or a digital signal transmitted via a telecommunications line, a wireless or wired communication line, a network represented by the Internet, data broadcasting, or the like.

In addition, the program or the digital signal may be recorded on a recording medium and transferred, or the program or the digital signal may be transferred via a network or the like to be implemented by another independent computer system.

### INDUSTRIAL APPLICABILITY

The evaluation device of the present disclosure can be applied not only to industrial product development or manufacturing process development but also to an optimal control device or system in general development work such as material development.

### REFERENCE MARKS IN THE DRAWINGS

10 reception controller
11 candidate experimental point creator
12 evaluation value calculator
13 evaluation value output unit
100 evaluation device
101a input unit
101b communication unit
102 arithmetic circuit
103 memory
104 display
105 storage
200 program
201 characteristic point data
210 setting information
211 control factor data
212 objective data
213 weight distribution data
221 candidate experimental point data
222 experimental result data
223 predicted distribution data
224 evaluation value data
300 first reception image
310 control factor region
311 to 314 input field
320 objective characteristic region
321 to 324 input field
400, 410, 420, 430, 440, 450 second reception image
401, 411, 421, 431, 441, 442, 451, 452 first weight distribution setting region
402, 412, 422, 432, 443, 444 second weight distribution setting region

1. An evaluation device configured to evaluate one or more unknown characteristic points corresponding to one or more candidate experimental points by Bayesian optimization based on known characteristic point corresponding to experimented experimental point, the evaluation device comprising:
a first reception controller configured to acquire experimental result data indicating the experimented experimental point and the known characteristic point;
a second reception controller configured to acquire, in a case where each of the unknown one or more characteristic points and the known characteristic point is expressed by one or more objective characteristic values, objective data indicating an optimization objective of each of the one or more objective characteristics;
a calculator configured to estimate a plurality of error variances that are variances of observation errors of characteristic points and are different from each other, and calculate evaluation values of the one or more unknown characteristic points based on the experimental result data, the objective data, and the plurality of error variances; and
an output unit configured to output the evaluation values.

2. The evaluation device according to claim 1, wherein
the one or more candidate experimental points include a plurality of candidate experimental points,
the calculator estimates the plurality of error variances different from each other for the plurality of candidate experimental points.

3. The evaluation device according to claim 2, wherein
the one or more unknown characteristic points include a plurality of unknown characteristic points,
the calculator calculates a predicted distribution for each of the plurality of candidate experimental points by using error variance corresponding to each of the plurality of candidate experimental points among the plurality of error variances for the Gaussian process regression, and calculates evaluation values of the plurality of unknown characteristic points by using the calculated predicted distribution.

4. The evaluation device according to claim 3,
wherein the calculator
acquires a weight distribution defined depending on a space in which the one or more candidate experimental points and the experimented experimental point are arranged, and
when estimating each of the plurality of error variances, estimates the error variance based on a weight associated with a position of the experimented experimental point in the space among a plurality of weights indicated by the weight distribution.

5. The evaluation device according to claim 4, wherein in a case where each of the experimented experimental point and the one or more candidate experimental points is represented by a level of two or more control factors,
the calculator
acquires a control factor weight distribution for each of the two or more control factors as the weight distribution, and
when estimating each of the plurality of error variances,
estimates the error variance based on a product of weights associated with positions of the experimented experimental point in the space in each of the two or more control factor weight distributions.

6. The evaluation device according to claim 1, wherein in a case where each of the unknown one or more characteristic points and the known characteristic point is expressed by two or more objective characteristic values,
the calculator estimates the error variance for each of the two or more objective characteristics by using the objective characteristic value of the known characteristic point.

7. The evaluation device according to claim 1, wherein
the calculator
estimates the plurality of error variances different from each other for the plurality of times in a case where evaluation of the one or more unknown characteristic points corresponding to the one or more candidate experimental points is repeatedly performed by performing an experiment at each of the plurality of times.

8. The evaluation device according to claim 7, wherein the calculator calculates a predicted distribution for each of the one or more candidate experimental points by using, for the Gaussian process regression, error variance corresponding to the time in each of the plurality of times among the plurality of error variances, and calculates evaluation values of the unknown one or more characteristic points by using the calculated predicted distribution.

9. The evaluation device according to claim 8, wherein the calculator
acquires a weight distribution defined depending on time, and
when estimating each of the plurality of error variances,
estimates the error variance based on a weight associated with a time at which an experiment using the experimented experimental point was performed, among a plurality of weights indicated by the weight distribution.

10. The evaluation device according to claim 9, wherein in a case where each of the experimented experimental point and the one or more candidate experimental points is represented by a level of two or more control factors,
the calculator
acquires a control factor weight distribution for each of the two or more control factors as the weight distribution, and
when estimating each of the plurality of error variances,
estimates the error variance based on a product of weights associated with a time at which an experiment using the experimented experimental point was performed in each of the two or more control factor weight distributions.

11. The evaluation device according to claim 7, wherein in a case where each of the unknown one or more characteristic points and the known characteristic point is expressed by two or more objective characteristic values, the calculator estimates the error variance for each of the two or more objective characteristics by using the objective characteristic value of the known characteristic point.

12. The evaluation device according to claim 1, wherein
the one or more unknown characteristic points include a plurality of unknown characteristic points,
the one or more candidate experimental points include a plurality of candidate experimental points,
the evaluation device configured to evaluate the plurality of unknown characteristic points corresponding to the plurality of candidate experimental points by Bayesian optimization based on known characteristic points corresponding to experimented experimental point, and
the calculator
estimates the plurality of error variances different from each other for the plurality of candidate experimental points and different from each other for a plurality of times in a case where evaluation of the plurality of unknown characteristic points corresponding to the plurality of candidate experimental points is repeatedly performed by performing an experiment at each of the plurality of times.

13. The evaluation device according to claim 12, wherein the calculator calculates a predicted distribution for each of the plurality of candidate experimental points by using, for the Gaussian process regression, error variance corresponding to a time in each of the plurality of times and each of the plurality of candidate experimental points among the plurality of error variances, and calculates evaluation values of the unknown plurality of characteristic points by using the calculated predicted distribution.

14. The evaluation device according to claim 13,
wherein:
the calculator acquires a first weight distribution defined depending on a space in which the plurality of candidate experimental points and the experimented experimental point are arranged and a second weight distribution defined depending on time, and
when estimating each of the plurality of error variances,
estimates the error variance based on a product of a first weight and a second weight;
the first weight is a weight associated with a position of the experimented experimental point in the space among a plurality of weights indicated by the first weight distribution; and
the second weight is a weight associated with a time at which an experiment using the experimented experimental point was performed among a plurality of weights indicated by the second weight distribution.

15. The evaluation device according to claim 14, wherein in a case where each of the experimented experimental point and the plurality of candidate experimental points is represented by a level of two or more control factors,
the calculator
acquires a first weight distribution for a control factor for each of the two or more control factors as the first weight distribution, and
when estimating each of the plurality of error variances,
estimates the error variance using, as the first weight, a product of weights associated with positions of the experimented experimental point in the space in each of the two or more first weight distributions for a control factor.

16. The evaluation device according to claim 12, wherein in a case where each of the unknown plurality of characteristic points and the known characteristic point is expressed by two or more objective characteristic values, the calculator estimates the error variance for each of the two or more objective characteristics by using the objective characteristic value of the known characteristic point.

17. An evaluation method for an evaluation device to evaluate one or more unknown characteristic points corresponding to one or more candidate experimental points by Bayesian optimization based on known characteristic points corresponding to experimented experimental point, the evaluation method comprising:
a first reception step of acquiring experimental result data indicating the experimented experimental point and the known characteristic point;
a second reception step of acquiring, in a case where each of the unknown one or more characteristic points and the known characteristic point is expressed by one or more objective characteristic values, objective data indicating an optimization objective of each of the one or more objective characteristics;
a calculation step of estimating a plurality of error variances that are variances of observation errors of characteristic points and are different from each other, and calculating evaluation values of the one or more unknown characteristic points based on the experimental result data, the objective data, and the plurality of error variances; and
an output step of outputting the evaluation value.

18. A program for causing a computer to evaluate one or more unknown characteristic points corresponding to one or more candidate experimental points by Bayesian optimization based on known characteristic points corresponding to experimented experimental point, the program causing the computer to execute:
a first reception step of acquiring experimental result data indicating the experimented experimental point and the known characteristic point;
a second reception step of acquiring, in a case where each of the unknown one or more characteristic points and the known characteristic point is expressed by one or more objective characteristic values, objective data indicating an optimization objective of each of the one or more objective characteristics;
a calculation step of estimating a plurality of error variances that are variances of observation errors of characteristic points and are different from each other, and calculating evaluation values of the one or more unknown characteristic points based on the experimental result data, the objective data, and the plurality of error variances; and
an output step of outputting the evaluation value.
